(19) United States
(12) Patent Application Publication
(10) Pub. No.: US 2015/0264348 A1
(43) Pub. Date: Sep. 17, 2015

(54) DICTIONARY CODING OF VIDEO CONTENT

(71) Applicant: QUALCOMM Incorporated, San Diego, CA (US)

(72) Inventors: Feng Zou, San Diego, CA (US); Ying Chen, San Diego, CA (US); Chao Pang, San Diego, CA (US); Marta Karczewicz, San Diego, CA (US); Joel Sole Rojals, La Jolla, CA (US); Wei Pu, San Diego, CA (US)

(21) Appl. No.: 14/659,180

(22) Filed: Mar. 16, 2015

Related U.S. Application Data
(60) Provisional application No. 61/954,558, filed on Mar. 17, 2014.
(60) Provisional application No. 62/013,458, filed on Jun. 17, 2014.
(60) Provisional application No. 62/110,396, filed on Jan. 30, 2015.
(60) Provisional application No. 61/990,581, filed on May 8, 2014.
(60) Provisional application No. 62/016,531, filed on Jun. 24, 2014.

(51) Int. Cl. H04N 19/105; H04N 19/139; H04N 19/70; H04N 19/176

(52) U.S. Cl. CPC H04N 19/105; H04N 19/176; H04N 19/139; H04N 19/70

(57) ABSTRACT

According to aspects of this disclosure, a device for decoding video data includes a memory configured to store the video data and a video decoder comprising one or more processor configured to determine that a current block of the video data is to be decoded using a 1D dictionary mode; receive, for a current pixel of the current block, a first syntax element indicating a starting location of reference pixels and a second syntax element identifying a number of reference pixels; based on the first syntax element and the second syntax element, locate a plurality of luma samples corresponding to the reference pixels; based on the first syntax element and the second syntax element, locate a plurality of chroma samples corresponding to the reference pixels; and copy the plurality of luma samples and the plurality of chroma samples to decode the current block.

This application claims the benefit of:
U.S. Provisional Application No. 61/954,558, filed 17 Mar. 2014;
U.S. Provisional Application No. 62/013,458, filed 17 Jun. 2014;
U.S. Provisional Application No. 62/110,396, filed 30 Jan. 2015;
U.S. Provisional Application No. 61/990,581, filed 8 May 2014;
U.S. Provisional Application No. 62/016,531, filed 24 Jun. 2014, the entire content each of which is incorporated herein by reference.

### TECHNICAL FIELD

This disclosure relates to video coding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video compression techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard development, and extensions of such standards. The video devices may transmit, receive, encode, decode, and/or store digital video information more efficiently by implementing such video compression techniques.

Video compression techniques perform spatial (intra-picture) prediction and/or temporal (inter-picture) prediction to reduce or remove redundancy inherent in video sequences. For block-based video coding, a video slice (i.e., a video frame or a portion of a video frame) may be partitioned into video blocks, which may also be referred to as treeblocks, coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to a reference frames.

Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the pixel domain to a transform domain, resulting in residual transform coefficients, which then may be quantized. The quantized transform coefficients, initially arranged in a two-dimensional array, may be scanned in order to produce a one-dimensional vector of transform coefficients, and entropy coding may be applied to achieve even more compression.

### SUMMARY

This disclosure describes techniques for encoding and decoding video content, including screen content which often has different characteristics than natural video content. Some of the techniques of this disclosure relate to what are commonly referred to as “dictionary” coding techniques where strings of already decoded reference pixels are copied to decode pixels of a block being decoded. In dictionary coding, a video encoder signals to a video decoder an offset for locating a starting location of the string of pixels and a run length indicating how many pixels follow the pixel of the starting location. Based on the offset and the run length, the video decoder identifies already decoded pixels and copies those pixels for use in decoding a current block.

In one example, a method of decoding video data includes determining that a current block of video data is to be decoded using a 1D dictionary mode; receiving, for a current pixel of the current block, a first syntax element indicating a starting location of reference pixels and a second syntax element identifying a number of reference pixels; based on the first syntax element and the second syntax element, locating a plurality of luma samples corresponding to the reference pixels; based on the first syntax element and the second syntax element, locating a plurality of chroma samples corresponding to the reference pixels; and copying the plurality of luma samples and the plurality of chroma samples to decode the current block.

In another example, a method of encoding video data includes identifying a matching string of pixel values to copy for a current block, wherein the matching string of pixel values comprises a plurality of luma samples and a corresponding plurality of chroma samples; encoding a first syntax element indicating a starting location of the luma samples and the chroma samples to copy; and encoding a second syntax element identifying a number of the luma samples to copy and a number of the chroma samples to copy.

In another example, a device for decoding video data includes a memory configured to store the video data and a video decoder comprising one or more processor configured to determine that a current block of the video data is to be decoded using a 1D dictionary mode; receive, for a current pixel of the current block, a first syntax element indicating a starting location of reference pixels and a second syntax element identifying a number of reference pixels; based on the first syntax element and the second syntax element, locate a plurality of luma samples corresponding to the reference pixels; based on the first syntax element and the second syntax element, locate a plurality of chroma samples corresponding to the reference pixels; and copy the plurality of luma samples and the plurality of chroma samples to decode the current block.

In another example, a computer-readable storage medium storing instructions that when executed by one or more processors cause the one or more processors to determine that a current block of video data is to be decoded using a 1D dictionary mode; receive, for a current pixel of the current block, a first syntax element indicating a starting location of reference pixels and a second syntax element identifying a number of reference pixels; based on the first syntax element and the second syntax element, locate a plurality of luma samples corresponding to the reference pixels; based on the first syntax element and the second syntax element, locate a plurality of chroma samples corresponding to the reference pixels; and copy the plurality of luma samples and the plurality of chroma samples to decode the current block.

In another example, a device for decoding video data includes means for determining that a current block of video data is to be decoded using a 1D dictionary mode; means for receiving, for a current pixel of the current block, a first syntax element indicating a starting location of reference pixels and a second syntax element identifying a number of reference pixels; means for locating a plurality of luma samples corresponding to the reference pixels based on the first syntax element and the second syntax element; means for locating a plurality of chroma samples corresponding to the reference pixels based on the first syntax element and the second syntax element; and means for copying the plurality of luma samples and the plurality of chroma samples to decode the current block.

### BRIEF DESCRIPTION OF DRAWINGS

FIG. 1 is a block diagram illustrating an example video encoding and decoding system that may utilize the techniques described in this disclosure.

FIG. 2A shows spatial neighboring motion vector (MV) candidates for merge mode.

FIG. 2B shows spatial neighboring MV candidates for advanced motion vector prediction (AMVP) mode.

FIG. 3 is a conceptual diagram illustrating an example predictive block of video data within a current picture for predicting a current block of video data within the current picture according to the techniques of this disclosure.

FIG. 4 shows an example of a transform tree structure within a coding unit (CU).

FIG. 5 shows an example of sample matching in a 1D dictionary.

FIG. 6 is a conceptual diagram illustrating an example of reconstruction-based 1D dictionary coding and two-dimensional (2D) matching mode.

FIG. 7 is a conceptual diagram illustrating an example of palette prediction in palette-based coding.

FIG. 8 is a conceptual diagram illustrating an example of a transition mode in palette-based coding.

FIG. 9A shows reference pixels outside the current CU in 2d reference mode.

FIG. 9B shows reference pixels partially within the current CU in 2d reference mode.

FIG. 9C shows reference pixels and current pixels are overlapped.

FIG. 10 shows an example of pixel matching in a 1D dictionary.

FIG. 11 shows an example of padding through copying.

FIG. 12 is a block diagram illustrating an example video encoder that may implement the techniques described in this disclosure.

FIG. 13 is a block diagram illustrating an example video decoder that may implement the techniques described in this disclosure.

FIG. 14 is a flowchart illustrating an example technique of encoding video data according to techniques of this disclosure.

FIG. 15 is a flowchart illustrating an example technique of decoding video data according to techniques of this disclosure.

FIG. 16 is a flowchart illustrating an example technique of decoding video data according to techniques of this disclosure.

FIG. 17 is a flowchart illustrating an example technique of coding video data according to techniques of this disclosure.

### DETAILED DESCRIPTION

This disclosure describes techniques for encoding and decoding video content, including screen content. Screen content generally refers to computer-generated content, as opposed to natural, camera-acquired video content. In many instances, a picture may include both screen content and natural video content. Screen content typically has different characteristics than natural video content. For example, screen content typically has runs of pixels with identical pixel values followed by abrupt transitions to pixels of different values. The abrupt transition typically occurs at an object edge, such as the border between a letter and a background. Rather than runs of identical pixel values followed by abrupt changes, natural video content tends to include more gradual changes due to shadows and variations in lighting. As a result of the differences in the characteristics of the content, certain coding tools that may be ineffective for natural video content may work well with screen content and vice versa.

One example of a coding tool that may be particularly effective at coding screen content is 1D dictionary coding. As will be explained in greater detail below, for 1D dictionary coding, a video encoder identifies a reference string of already coded pixels that matches pixels in a block that is currently being encoded. The video encoder signals to a video decoder an offset for locating a start of the string and a run length to determine how many pixels follow the starting location. Based on the offset and the run length, the video decoder identifies already decoded pixels and copies those pixels for use in a current block. This disclosure introduces techniques related to 1D dictionary coding that may improve the computational efficiency and coding quality associated with 1D dictionary coding tools.

In this disclosure various techniques may be described with respect to a video decoder. Unless explicitly stated otherwise, however, it should not be assumed that these same techniques cannot also be performed by a video encoder. A video encoder may, for example, perform the same techniques as a video decoder as part of determining how to code video data or may perform the same techniques in a decoding loop of the video encoding process. Likewise, for ease of explanation, some techniques of this disclosure may be described with respect to a video encoder, but unless explicitly stated otherwise, it should not be assumed that such techniques can not also be performed by a video encoder.

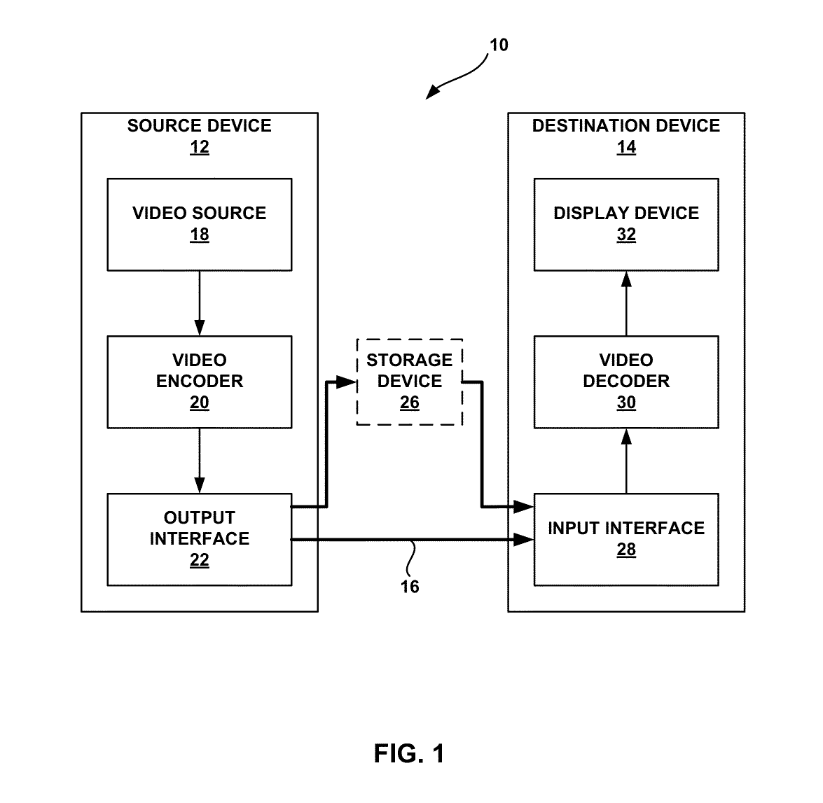

FIG. 1 is a block diagram illustrating an example video encoding and decoding system 10 that may utilize the 1D dictionary techniques described in this disclosure. As shown in FIG. 1, system 10 includes a source device 12 that generates encoded video data to be decoded at a later time by a destination device 14. Source device 12 and destination device 14 may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or the like. In some cases, source device 12 and destination device 14 may be equipped for wireless communication.

Destination device 14 may receive the encoded video data to be decoded via a link 16. Link 16 may comprise any type of medium or device capable of moving the encoded video data from source device 12 to destination device 14. In one example, link 16 may comprise a communication medium to enable source device 12 to transmit encoded video data directly to destination device 14 in real-time. The encoded video data may be modulated according to a communication standard, such as a wireless communication protocol, and transmitted to destination device 14. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 12 to destination device 14.

Alternatively, encoded data may be output from output interface 22 to a storage device 26. Similarly, encoded data may be accessed from storage device 26 by input interface. Storage device 26 may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, storage device 26 may correspond to a file server or another intermediate storage device that may hold the encoded video generated by source device 12. Destination device 14 may access stored video data from storage device 26 via streaming or download. The file server may be any type of server capable of storing encoded video data and transmitting that encoded video data to the destination device 14. Example file servers include a web server (e.g., for a website), an FTP server, network attached storage (NAS) devices, or a local disk drive. Destination device 14 may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from storage device 26 may be a streaming transmission, a download transmission, or a combination of both.

The techniques of this disclosure are not necessarily limited to wireless applications or settings. The techniques may be applied to video coding in support of any of a variety of multimedia applications, such as over-the-air television broadcasts, cable television transmissions, satellite television transmissions, streaming video transmissions, e.g., via the Internet, encoding of digital video for storage on a data storage medium, decoding of digital video stored on a data storage medium, or other applications. In some examples, system 10 may be configured to support one-way or two-way video transmission to support applications such as video streaming, video playback, video broadcasting, and/or video telephony.

In the example of FIG. 1, source device 12 includes a video source 18, video encoder 20 and an output interface 22. In some cases, output interface 22 may include a modulator/demodulator (modem) and/or a transmitter. In source device 12, video source 18 may include a source such as a video capture device, e.g., a video camera, a video archive containing previously captured video, a video feed interface to receive video from a video content provider, and/or a computer graphics system for generating computer graphics data as the source video, or a combination of such sources. As one example, if video source 18 is a video camera, source device 12 and destination device 14 may form so-called camera phones or video phones. However, the techniques described in this disclosure may be applicable to video coding in general, and may be applied to wireless and/or wired applications.

The captured, pre-captured, or computer-generated video may be encoded by video encoder 20. The encoded video data may be transmitted directly to destination device 14 via output interface 22 of source device 12. The encoded video data may also (or alternatively) be stored onto storage device 26 for later access by destination device 14 or other devices, for decoding and/or playback.

Destination device 14 includes an input interface 28, a video decoder 30, and a display device 32. In some cases, input interface 28 may include a receiver and/or a modem. Input interface 28 of destination device 14 receives the encoded video data over link 16. The encoded video data communicated over link 16, or provided on storage device 26, may include a variety of syntax elements generated by video encoder 20 for use by a video decoder, such as video decoder 30, in decoding the video data. Such syntax elements may be included with the encoded video data transmitted on a communication medium, stored on a storage medium, or stored a file server.

Display device 32 may be integrated with, or external to, destination device 14. In some examples, destination device 14 may include an integrated display device and also be configured to interface with an external display device. In other examples, destination device 14 may be a display device. In general, display device 32 displays the decoded video data to a user, and may comprise any of a variety of display devices such as a liquid crystal display (LCD), a plasma display, an organic light emitting diode (OLED) display, or another type of display device.

Video encoder 20 and video decoder 30 may operate according to a video compression standard, such as HEVC. Alternatively, video encoder 20 and video decoder 30 may operate according to other proprietary or industry standards, such as ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also known as ISO/IEC MPEG-4 AVC), including its Scalable Video Coding (SVC) and Multiview Video Coding (MVC) extensions. The techniques of this disclosure, however, are not limited to any particular coding standard. Other examples of video compression standards include MPEG-2 and ITU-T H.263.

As introduced above, the design of a new video coding standard, namely HEVC, has been finalized by the JCT-VC of ITU-T Video Coding Experts Group (VCEG) and ISO/IEC Motion Picture Experts Group (MPEG). The latest HEVC draft specification (Ye-Kui Wang et al. High Efficiency Video Coding (HEVC) Defect Report 2, JCTVC-O1003_v2, Joint Collaborative Team on Video Coding (JCT-VC) of ITU-T SG 16 WP 3 and ISO/IEC JTC 1/SC 29/WG 11, 15th Meeting: Geneva, C H, 23 Oct.-1 Nov. 2013), and referred to as HEVC WD hereinafter, is hereby incorporated by reference in its entirety and is available from http://phenix.int-evry.fr/jct/doc_end_user/documents/15_Geneva/wg11/JCTVC-O1003-v2.zip.

The Range Extensions to HEVC (Flynn et al, High Efficiency Video Coding (HEVC) Range Extensions text specification: Draft 6, JCTVC-P1005_v1, Joint Collaborative Team on Video Coding (JCT-VC) of ITU-T SG 16 WP 3 and ISO/IEC JTC 1/SC 29/WG 11, 16th Meeting: San José, US, 9-17 Jan. 2014), namely HEVC-Rext, is also being developed by the JCT-VC, and is hereby incorporated by reference in its entirety. A recent Working Draft (WD) of Range extensions, referred to as RExt WD6 hereinafter, is available from http://phenix.int-evry.fr/jct/doc_end_user/documents/16_San%20Jose/wg11/JCTVC-P1005-v1.zip.

Although not shown in FIG. 1, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, in some examples, MUX-DEMUX units may conform to the ITU H.223 multiplexer protocol, or other protocols such as the user datagram protocol (UDP).

Video encoder 20 and video decoder 30 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 20 and video decoder 30 may be included in one or more encoders or decoders, either of which may be integrated as part of a combined encoder/decoder (CODEC) in a respective device.

The JCT-VC has recently finalized the development of the HEVC standard. AN HEVC-compliant decoding device includes several additional capabilities relative to previous generation devices (e.g., ITU-T H.264/AVC devise). For example, whereas H.264 provides nine intra-prediction encoding modes, HEVC supports as many as thirty-five intra-prediction encoding modes.

According to HEVC, a video frame or picture may be divided into a sequence of treeblocks or largest coding units (LCU) that include both luma and chroma samples. A treeblock has a similar purpose as a macroblock of the H.264 standard. A slice includes a number of consecutive treeblocks in coding order. A video frame or picture may be partitioned into one or more slices. Each treeblock may be split into coding units (CUs) according to a quadtree. For example, a treeblock, as a root node of the quadtree, may be split into four child nodes, and each child node may in turn be a parent node and be split into another four child nodes. A final, unsplit child node, as a leaf node of the quadtree, comprises a coding node, i.e., a coded video block. Syntax data associated with a coded bitstream may define a maximum number of times a treeblock may be split, and may also define a minimum size of the coding nodes.

A CU includes a coding node and prediction units (PUs) and transform units (TUs) associated with the coding node. A size of the CU corresponds to a size of the coding node and is square in shape. The size of the CU may range from 8×8 pixels up to the size of the treeblock with a maximum of 64×64 pixels or greater. Each CU may contain one or more PUs and one or more TUs. Syntax data associated with a CU may describe, for example, partitioning of the CU into one or more PUs. Partitioning modes may differ between whether the CU is skip or direct mode encoded, intra-prediction mode encoded, inter-prediction mode encoded, or encoded using a different coding tool such as 1D dictionary mode or palette mode. PUs may be partitioned to be non-square in shape. Syntax data associated with a CU may also describe, for example, partitioning of the CU into one or more TUs according to a quadtree. A TU can be square or non-square in shape.

The HEVC standard allows for transformations according to TUs, which may be different for different CUs. The TUs are typically sized based on the size of PUs within a given CU defined for a partitioned LCU, although this may not always be the case. The TUs are typically the same size or smaller than the PUs. In some examples, residual samples corresponding to a CU may be subdivided into smaller units using a quadtree structure known as “residual quad tree” (RQT). The leaf nodes of the RQT may be referred to as transform units (TUs). Pixel difference values associated with the TUs may be transformed to produce transform coefficients, which may be quantized.

In general, a PU includes data related to the prediction process. For example, when the PU is intra-mode encoded, the PU may include data describing an intra-prediction mode for the PU. As another example, when the PU is inter-mode encoded, the PU may include data defining a motion vector for the PU. The data defining the motion vector for a PU may describe, for example, a horizontal component of the motion vector, a vertical component of the motion vector, a resolution for the motion vector (e.g., one-quarter pixel precision or one-eighth pixel precision), a reference picture to which the motion vector points, and/or a reference picture list (e.g., List 0, List 1, or List C) for the motion vector.

In general, a TU is used for the transform and quantization processes. A given CU having one or more PUs may also include one or more transform units (TUs). Following prediction, video encoder 20 may calculate residual values corresponding to the PU. The residual values comprise pixel difference values that may be transformed into transform coefficients, quantized, and scanned using the TUs to produce serialized transform coefficients for entropy coding. This disclosure typically uses the term “video block” to refer to a coding node of a CU. In some specific cases, this disclosure may also use the term “video block” to refer to a treeblock, i.e., LCU, or a CU, which includes a coding node and PUs and TUs.

A video sequence typically includes a series of video frames or pictures. A group of pictures (GOP) generally comprises a series of one or more of the video pictures. A GOP may include syntax data in a header of the GOP, a header of one or more of the pictures, or elsewhere, that describes a number of pictures included in the GOP. Each slice of a picture may include slice syntax data that describes an encoding mode for the respective slice. Video encoder 20 typically operates on video blocks within individual video slices in order to encode the video data. A video block may correspond to a coding node within a CU. The video blocks may have fixed or varying sizes, and may differ in size according to a specified coding standard.

As an example, HEVC supports prediction in various PU sizes. Assuming that the size of a particular CU is 2N×2N, HEVC supports intra-prediction in PU sizes of 2N×2N or N×N, and inter-prediction in symmetric PU sizes of 2N×2N, 2N×N, N×2N, or N×N. HEVC also supports asymmetric partitioning for inter-prediction in PU sizes of 2N×nU, 2N×nD, nL×2N, and nR×2N. In asymmetric partitioning, one direction of a CU is not partitioned, while the other direction is partitioned into 25% and 75%. The portion of the CU corresponding to the 25% partition is indicated by an “n” followed by an indication of “Up”, “Down,” “Left,” or “Right.” Thus, for example, “2N×nU” refers to a 2N×2N CU that is partitioned horizontally with a 2N×0.5N PU on top and a 2N×1.5N PU on bottom.

In this disclosure, “N×N” and “N by N” may be used interchangeably to refer to the pixel dimensions of a video block in terms of vertical and horizontal dimensions, e.g., 16×16 pixels or 16 by 16 pixels. In general, a 16×16 block will have 16 pixels in a vertical direction (y=16) and 16 pixels in a horizontal direction (x=16). Likewise, an N×N block generally has N pixels in a vertical direction and N pixels in a horizontal direction, where N represents a nonnegative integer value. The pixels in a block may be arranged in rows and columns. Moreover, blocks need not necessarily have the same number of pixels in the horizontal direction as in the vertical direction. For example, blocks may comprise N×M pixels, where M is not necessarily equal to N.

Following intra-predictive or inter-predictive coding using the PUs of a CU, video encoder 20 may calculate residual data for the TUs of the CU. In some modes, such as palette and 1D dictionary, the coding of residual data may be skipped. The PUs may comprise pixel data in the spatial domain (also referred to as the pixel domain) and the TUs may comprise coefficients in the transform domain following application of a transform, e.g., a discrete cosine transform (DCT), an integer transform, a wavelet transform, or a conceptually similar transform to residual video data. The residual data may correspond to pixel differences between pixels of the unencoded picture and prediction values corresponding to the PUs. Video encoder 20 may form the TUs including the residual data for the CU, and then transform the TUs to produce transform coefficients for the CU.

Following any transforms to produce transform coefficients, video encoder 20 may perform quantization of the transform coefficients. Quantization generally refers to a process in which transform coefficients are quantized to possibly reduce the amount of data used to represent the coefficients, providing further compression. The quantization process may reduce the bit depth associated with some or all of the coefficients. For example, an n-bit value may be rounded down to an m-bit value during quantization, where n is greater than m.

In some examples, video encoder 20 may utilize a predefined scan order to scan the quantized transform coefficients to produce a serialized vector that can be entropy encoded. In other examples, video encoder 20 may perform an adaptive scan. After scanning the quantized transform coefficients to form a one-dimensional vector, video encoder 20 may entropy encode the one-dimensional vector, e.g., according to context adaptive variable length coding (CAVLC), context adaptive binary arithmetic coding (CABAC), syntax-based context-adaptive binary arithmetic coding (SBAC), Probability Interval Partitioning Entropy (PIPE) coding or another entropy encoding methodology. Video encoder 20 may also entropy encode syntax elements associated with the encoded video data for use by video decoder 30 in decoding the video data.

To perform CABAC, video encoder 20 may assign a context within a context model to a symbol to be transmitted. The context may relate to, for example, whether neighboring values of the symbol are non-zero or not. To perform CAVLC, video encoder 20 may select a variable length code for a symbol to be transmitted. Codewords in VLC may be constructed such that relatively shorter codes correspond to more probable symbols, while longer codes correspond to less probable symbols. In this way, the use of VLC may achieve a bit savings over, for example, using equal-length codewords for each symbol to be transmitted. The probability determination may be based on a context assigned to the symbol.

Investigation of new coding tools for screen-content material such as text and graphics with motion have been explored, and technologies that potentially improve the coding efficiency for screen content have been proposed. As there is evidence that significant improvements in coding efficiency may be obtained by exploiting the characteristics of screen content using novel dedicated coding tools, a Call for Proposals (CfP) was issued with the target of possibly developing future extensions of HEVC that include specific tools for screen content coding. Companies and organizations have been invited to submit proposals in response to this Call. The use cases and requirements of this CfP are described in MPEG document N14174. Video encoder 20 and video decoder 30 represent an example of a video encoder and video decoder, respectively, that may be configured to implement one or more of these new coding tools as well as one or more other coding tools described herein.

Aspects of HEVC will now be introduced in more detail. For each block, a set of motion information can be available. A set of motion information contains motion information for forward and backward prediction directions. Here forward and backward prediction directions are two prediction directions of a bi-directional prediction mode. The terms “forward” and “backward” do not necessarily have a geometric meaning, but instead correspond to reference picture list 0 (RefPicList0) and reference picture list 1 (RefPicList1) of a current picture. When only one reference picture list is available for a picture or slice, only RefPicList0 is available and the motion information of each block of a slice is always forward.

For each prediction direction, the motion information contains a reference index and a motion vector. In some cases, for simplicity, a motion vector itself may be referred in a way that the motion vector is assumed to have an associated reference index. A reference index is used to identify a reference picture in the current reference picture list (RefPicList0 or RefPicList1). A motion vector has a horizontal and a vertical component.

Picture order count (POC) is widely used in video coding standards to identify a display order of a picture. Although there may be some occasions where two pictures within one coded video sequence may have the same POC value, such occasions are rare and typically do not happen within a coded video sequence. When multiple coded video sequences are present in a bitstream, pictures with a same value of POC may be closer to each other in terms of decoding order. POC values of pictures are used, for example, for reference picture list construction, derivation of reference picture set as in HEVC, and motion vector scaling.

In HEVC, CUs have a defined structure that is specified by HEVC. In HEVC, the largest coding unit in a slice is called a coding tree block (CTB). A CTB contains a quad-tree the nodes of which are coding units. The size of a CTB can be ranges from 16×16 to 64×64 in the HEVC main profile (although technically 8×8 CTB sizes can be supported). A coding unit (CU) could be the same size of a CTB although and as small as 8×8. Each coding unit is coded with one mode. When a CU is inter coded, the CU may be further partitioned into two prediction units (PUs) or become just one PU when further partition does not apply. When two PUs are present in one CU, the two PUs can be two half size rectangles or two rectangles with ¼ or ¾ size of the CU.

When the CU is inter coded, one set of motion information is present for each PU. In addition, each PU is coded with a unique inter-prediction mode to derive the set of motion information. In HEVC, the smallest PU sizes are 8×4 and 4×8.

To locate a reference block for a current block, HEVC supports various motion prediction tools. For example, in HEVC, there are two inter prediction modes, named merge (skip is considered as a special case of merge) and advanced motion vector prediction (AMVP) modes respectively for a P. In either AMVP or merge mode, a motion vector (MV) candidate list is maintained for multiple motion vector predictors. The motion vector(s), as well as reference indices in the merge mode, of the current PU are generated by taking one candidate from the MV candidate list.

The MV candidate list contains up to 5 candidates for the merge mode and only two candidates for the AMVP mode. A merge candidate may contain a set of motion information, e.g., motion vectors corresponding to both reference picture lists (list 0 and list 1) and the reference indices. If a merge candidate is identified by a merge index, the reference pictures are used for the prediction of the current blocks, as well as the associated motion vectors are determined. However, under AMVP mode for each potential prediction direction from either list 0 or list 1, a reference index needs to be explicitly signaled, together with an MVP index to the MV candidate list since the AMVP candidate contains only a motion vector. In AMVP mode, the predicted motion vectors can be further refined.

As can be seen above, a merge candidate corresponds to a full set of motion information while an AMVP candidate contains just one motion vector for a specific prediction direction and reference index.

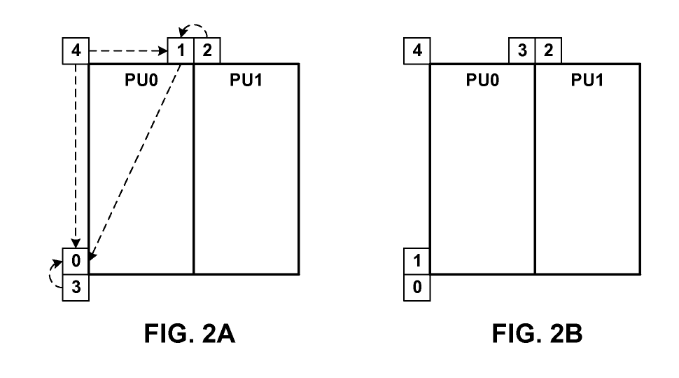

The candidates for both modes are derived similarly from the same spatial and temporal neighboring blocks. Spatial MV candidates are derived from the neighboring blocks shown in FIGS. 2A and 2B, for a specific PU (PU₀), although the methods generating the candidates from the blocks differ for merge and AMVP modes.

In merge mode, up to four spatial MV candidates can be derived with the orders showed in FIG. 2A with numbers, and the order is the following: left (0), above (1), above right (2), below left (3), and above left (4), as shown in FIG. 2A.

In AVMP mode, the neighboring blocks are divided into two groups. A left group includes blocks 0 and 1, and an above group includes blocks 2, 3, and 4, as shown in FIG. 2B. For each group, the potential candidate in a neighboring block referring to the same reference picture as that indicated by the signaled reference index has the highest priority to be chosen to form a final candidate of the group. It is possible that all neighboring blocks do not contain a motion vector pointing to the same reference picture. Therefore, if such a candidate cannot be found, the first available candidate will be scaled to form the final candidate, thus the temporal distance differences can be compensated.

Video encoder 20 and video decoder 30 may derive a motion vector for the luma component of a current PU/CU. Before the motion vector is used for chroma motion compensation, video encoder 20 and video decoder 30 may scale the motion vector based on the chroma sampling format.

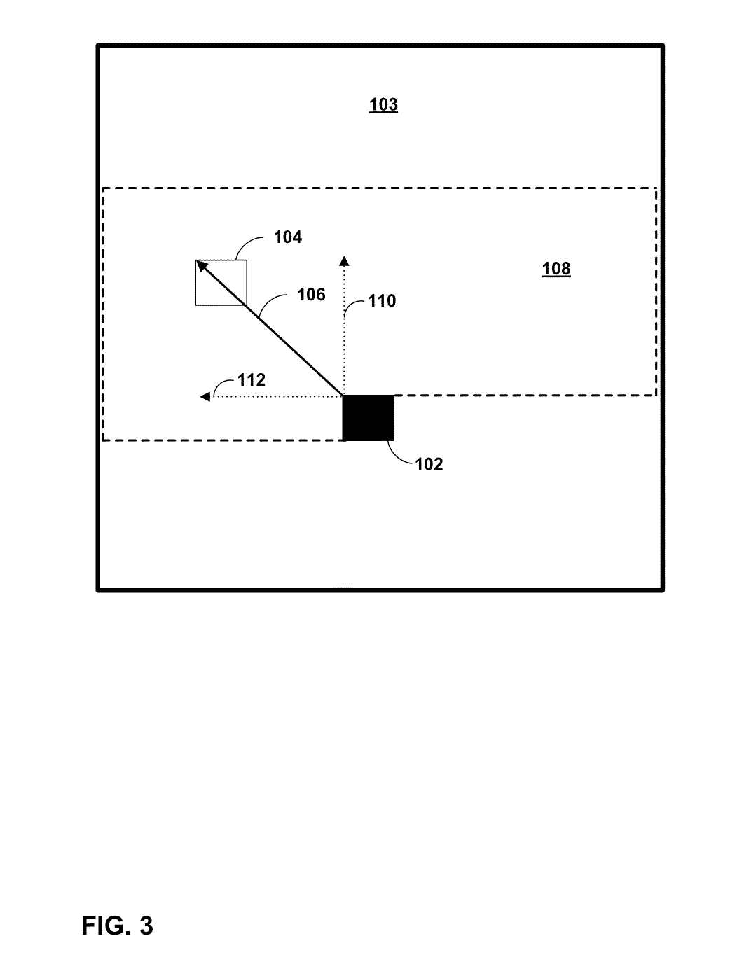

Intra Block-Copy (Intra BC) is a coding mode that has been proposed for inclusion in a range extension to HEVC. An example of Intra BC is shown in FIG. 3, where the current CU/PU is predicted from an already decoded block of the current picture/slice. Note that prediction signal is reconstructed but without in-loop filtering, including de-blocking and Sample Adaptive Offset (SAO).

FIG. 3 is a conceptual diagram illustrating an example technique for predicting a current block of video data 102 within a current picture 103 according to a mode for intra prediction of blocks of video data from predictive blocks of video data within the same picture according to this disclosure, e.g., according to an IntraBC mode in accordance with the techniques of this disclosure. FIG. 3 illustrates a predictive block of video data 104 within current picture 103. A video coder, e.g., video encoder 20 and/or video decoder 30, may use predictive video block 104 to predict current video block 102 according to an IntraBC mode in accordance with the techniques of this disclosure.

Video encoder 20 selects predictive video block 104 for predicting current video block 102 from a set of previously reconstructed blocks of video data. Video encoder 20 reconstructs blocks of video data by inverse quantizing and inverse transforming the video data that is also included in the encoded video bitstream, and summing the resulting residual blocks with the predictive blocks used to predict the reconstructed blocks of video data. In the example of FIG. 3, intended region 108 within picture 103, which may also be referred to as an “intended area” or “raster area,” includes the set of previously reconstructed video blocks. Video encoder 20 may define intended region 108 within picture 103 in variety of ways, as described in greater detail below. Video encoder 20 may select predictive video block 104 to predict current video block 102 from among the video blocks in intended region 108 based on an analysis of the relative efficiency and accuracy of predicting and coding current video block 102 based on various video blocks within intended region 108.

Video encoder 20 determines two-dimensional vector 106 representing the location or displacement of predictive video block 104 relative to current video block 102. Two-dimensional block vector 106 includes horizontal displacement component 112 and vertical displacement component 110, which respectively represent the horizontal and vertical displacement of predictive video block 104 relative to current video block 102. Video encoder 20 may include one or more syntax elements that identify or define two-dimensional block vector 106, e.g., that define horizontal displacement component 112 and vertical displacement component 110, in the encoded video bitstream. Video decoder 30 may decode the one or more syntax elements to determine two-dimensional block vector 106, and use the determined vector to identify predictive video block 104 for current video block 102.

In some examples, the resolution of two-dimensional block vector 106 can be integer pixel, e.g., be constrained to have integer pixel resolution. In such examples, the resolution of horizontal displacement component 112 and vertical displacement component 110 may be integer pixel. In such examples, video encoder 20 and video decoder 30 need not interpolate pixel values of predictive video block 104 to determine the predictor for current video block 102.

In other examples, the resolution of one or both of horizontal displacement component 112 and vertical displacement component 110 can be sub-pixel. For example, one of components 112 and 114 may have integer pixel resolution, while the other has sub-pixel resolution. In some examples, the resolution of both of horizontal displacement component 112 and vertical displacement component 110 can be sub-pixel, but horizontal displacement component 112 and vertical displacement component 110 may have different resolutions.

In some examples, a video coder, e.g., video encoder 20 and/or video decoder 30, adapts the resolution of horizontal displacement component 112 and vertical displacement component 110 based on a specific level, e.g., block-level, slice-level, or picture-level adaptation. For example, video encoder 20 may signal a flag at the slice level, e.g., in a slice header, that indicates whether the resolution of horizontal displacement component 112 and vertical displacement component 110 is integer pixel resolution or is not integer pixel resolution. If the flag indicates that the resolution of horizontal displacement component 112 and vertical displacement component 110 is not integer pixel resolution, video decoder 30 may infer that the resolution is sub-pixel resolution. In some examples, one or more syntax elements, which are not necessarily a flag, may be transmitted for each slice or other unit of video data to indicate the collective or individual resolutions of horizontal displacement components 112 and/or vertical displacement components 110.

Video decoder 30 may be configured to perform block compensation. For the luma component or the chroma components that are coded with Intra BC, video decoder 30 may perform the block compensation with integer block compensation, such that no interpolation is needed. Video decoder 30 may predict and signal the block vector at an integer level.

In the current RExt of HEVC, the block vector predictor is set to (−W, 0) at the beginning of each coded tree block (CTB), where W is the width of the CU. Such a block vector predictor is updated to be the one of the latest coded CU if that is coded with Intra BC mode. If a CU is not coded with Intra BC, the block vector predictor keeps unchanged. After block vector prediction, the block vector difference is encoded using the motion vector difference coding method is HEVC.

The current Intra BC is enabled at both CU and PU level. For PU level intra BC, 2N×N and N/2N PU partition is supported for all the CU sizes. In addition, when the CU is the smallest CU, N×N PU partition is supported.

Video encoder 20 and video decoder 30 may be configured to perform entropy coding. In the current HEVC, context adaptive binary arithmetic coding (CABAC) is used to convert a symbol into a binarized value. This process may be referred to as binarization. Binarization enables efficient binary arithmetic coding via a unique mapping of non-binary syntax elements to a sequence of bits, which are called bins. In HEVC, several binarization methods are used to code syntax elements in the bitstream, such as fixed length binarization, truncated rice binarization and exponential Golomb binarization.

In particular, fixed length binarization may be constructed by using a fixedLength-bit unsigned integer bin string of the syntax element value, where fixedLength=Ceil(Log 2(cMax+1)) and cMax is the maximum possible value. The indexing of bins for the fixed length binarization is such that the binIdx=0 relates to the most significant bit with increasing values of binIdx towards the least significant bit. Fixed length codeword is used for syntax elements coeff_sign_flag and sig_coeff_flag.

Another binarization method is to use truncated rice (TR) codewords. A TR bin string is a concatenation of a prefix bin string and, when present, a suffix bin string. TR codewords may be used to code last_sig_coeff_x_prefix, ref_idx_l0 and ref_idx_l1 as shown in TABLE 1 below. Detailed information could be referred to sub-clause 9.3.3.2 in the HEVC specification.

Assume synVal is the syntax value and cRiceParam is the rice parameter and cMax controls the range for which the syntax value may be truncated with values larger than the range represented externally as a suffix, the derivation of the prefix bin string is as follows:
The prefix value of synVal, prefixVal, is derived as follows:

prefixVal=synVal>>cRiceParam
The prefix of the TR bin string is specified as follows:
   If prefixVal is less than cMax>>cRiceParam, the prefix bin string is a bit string of length prefixVal+1 indexed by binIdx. The bins for binIdx less than prefixVal are equal to 1. The bin with binIdx equal to prefixVal is equal to 0. TABLE 2 illustrates the bin strings of this unary binarization for prefixVal.
   Otherwise, the bin string is a bit string of length cMax>>cRiceParam with all bins being equal to 1.

When cMax is greater than synVal, the suffix of the TR bin string is present and is derived as follows:
The suffix value of synVal, suffixVal, is derived as follows:

suffixVal=synVal−((prefixVal)<<cRiceParam)
The suffix of the TR bin string is specified by the binary representation of suffixVal. NOTE—For the input parameter cRiceParam=0 the TR binarization is exactly a truncated unary binarization and is always invoked with a cMax value equal to the largest possible value of the syntax element being decoded.

In other words, if the synVal is smaller than cMax, then snyVal is represented by a prefix, which is equal to synVal>>cRiceParam and represented by unary binarization (for a value N, with N “1” and one “0”) and a suffix, which is the cRiceParam least significant bits of synVal. If synVal is larger than cMax, the prefix is derived to be a string of “1” with a length of (cMax>>cRiceParam), while the suffix is equal to synVal−(1<<(cMax>>cRiceParam)−1). In the latter case, suffix needs to be further coded with other methods, e.g., Exp-Golomb.

Exponential Golomb (Exp-Golomb) codeword with parameter 1 is used for abs_mvd_minus2 as shown in TABLE 2 below. The Exp-Golomb codeword may have a binarization process depending on the order k. For the k-th order Exp-Golomb, the binarization is done with the following pseudo code. An example of the 1-st order Exp-Golomb code is shown in TABLE 2.

```
absV = Abs( synVal )
stopLoop = 0
do {
    if( absV >= ( 1 << k ) ) {
        put( 1 )
        absV = absV − ( 1 << k)
        k++
    } else {
        put( 0 )
        while( k−− )
            put( ( absV >> k) & 1 )
        stopLoop = 1
    }
} while( !stopLoop )
```

TABLE 1 shows an example of a bin string of the truncated rice binarization with rice parameter 0.

TABLE 1

| | |
|---|---|
| Val | Bin string |

| | | | | | | |
|---|---|---|---|---|---|---|
| 0 | 0 | | | | | |
| 1 | 1 | 0 | | | | |
| 2 | 1 | 1 | 0 | | | |
| 3 | 1 | 1 | 1 | 0 | | |
| 4 | 1 | 1 | 1 | 1 | 0 | |
| 5 | 1 | 1 | 1 | 1 | 1 | 0 |
| . . . | | | | | | |
| binIdx | 0 | 1 | 2 | 3 | 4 | 5 |

TABLE 2 shows an example a bin string of the exponential Golomb binarization with parameter 1.

TABLE 2

| Vale | Bin string | | | | | | |
|---|---|---|---|---|---|---|---|
| 0 | 0 | 0 | | | | | |
| 1 | 0 | 1 | | | | | |
| 2 | 1 | 0 | 0 | 0 | | | |
| 3 | 1 | 0 | 0 | 1 | | | |
| 4 | 1 | 0 | 1 | 0 | | | |
| 5 | 1 | 0 | 1 | 1 | | | |
| 6 | 1 | 1 | 0 | 0 | 0 | 0 | |
| 7 | 1 | 1 | 0 | 0 | 0 | 1 | |
| 8 | 1 | 1 | 0 | 0 | 1 | 0 | |
| 9 | 1 | 1 | 0 | 0 | 1 | 1 | |
| 10 | 1 | 1 | 0 | 1 | 0 | 0 | |
| . . . | | | | | | | |
| binIdx | 0 | 1 | 2 | 3 | 4 | 5 | 6 |

Truncated binary coding is typically used for uniform probability distributions with a finite alphabet. Truncated binary is not implemented in the base HEVC-standard although may be used for future extensions or future standards. Truncated binary may be parameterized by an alphabet with total size of number n. Truncated binary is a slightly more general form of binary encoding when n is not a power of two.

If n is a power of 2 then the coded value for 0≦x<n is the simple binary code for x of length log 2(n). Otherwise, let k=floor(log 2(n)) such that 2k≦n<2k+1 and let u=2k+1−n.

Truncated binary coding assigns the first u symbols codewords of length k and then assigns the remaining n-u symbols the last n-u codewords of length k+1. TABLE 3 below is an example for n=5.

TABLE 3

| Symbol | Bin string | | |
|---|---|---|---|
| 0 | 0 | 0 | |
| 1 | 0 | 1 | |
| 2 | 1 | 0 | |
| 3 | 1 | 1 | 0 |
| 4 | 1 | 1 | 1 |
| binIdx | 0 | 1 | 2 |

Regardless which binarization method is used, each bin can either be processed in the regular context coding mode or bypass mode. The bypass mode is chosen for selected bin in order to allow a speed up of the whole encoding (decoding) process.

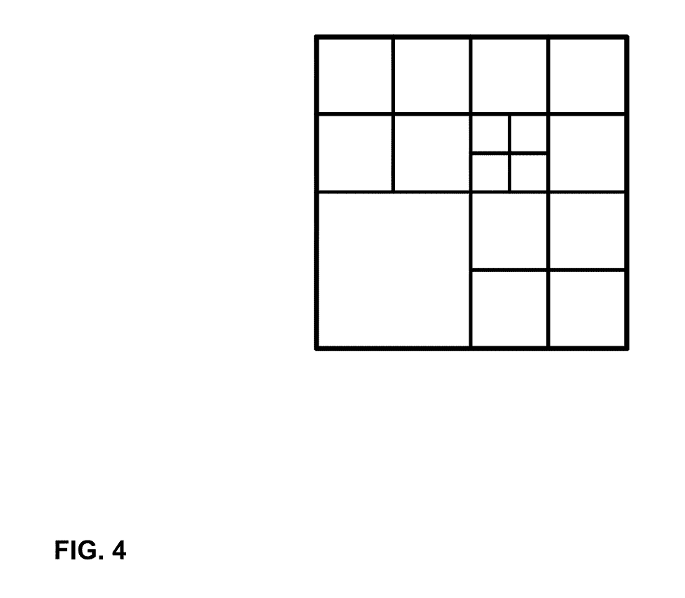

Video encoder 20 and video decoder 30 may be configured to implement residual quad-tree (RQT) and quantization. Each CU corresponds to one transform tree, which is a quad-tree, the leaf of which is a transform unit. The transform unit (TU) is a square region, defined by quadtree partitioning of the CU, which shares the same transform and quantization processes. The quadtree structure of multiple TUs within a CU is illustrated in FIG. 4.

FIG. 4 is an example of a transform tree structure within a CU. In some examples, the TU shape is always square and may take a size from 32×32 down to 4×4 samples. For an inter CU, the TU can be larger than the PU, meaning the TU may contain PU boundaries. However, the TU cannot cross PU boundaries for an intra CU. The syntax element “rqt_root_cbf” specifies whether the transform_tree syntax structure is present or not present for the current coding unit. When the syntax element “rqt_root_cbf” is equal to 0, the transform tree only contains one node, meaning the TU is not further split and the split_transform_flag is equal to 0. A node inside a transform tree, if the node has split_transform_flag equal to 1, is further split into four nodes, and a leaf of the transform tree has split_transform_flag equal to 0.

For simplicity, if a transform unit or transform tree corresponds to a block which does not have a transform, this disclosure may still consider the block as having a transform tree of transform unit, as the hierarchy of the transform itself still exists. Typically a transform skipped block corresponds within a transform unit.

Quantization may be controlled by a quantization parameter (QP) that ranges from 0 to 51. At the decoder, after the inverse transform, the de-quantization applies to derive the final residue signal based on the QP of the current transform unit.

As introduced above, video encoder 20 and video decoder 30 may be configured to implement various screen content coding (SCC) tools. SCC is a technology for some emerging popular applications such as desktop sharing, cloud computing, cloud-mobile computing, and remote desktop. The challenging requirement in SCC is to achieve both ultra-high visually lossless quality and ultra-high compression ratio up to 300:1˜3000:1. In recent years, SCC has attracted increasing attention of researchers from both academia and industry. Typical computer generated content in daily use is often rich in small and sharp bitmap structures such as text, menu, icon, button, slide-bar, and grid. There are usually many similar or identical patterns in a screen picture. A full page of English text consists of only 52 capital and small letters, which all consist of even fewer numbers of basic strokes. Most Asian texts also consist of 5-10 basic strokes.

Block matching used in traditional hybrid coding, like Intra BC, is not always efficient to code similar or identical pattern within a picture. Traditional pattern-matching based algorithms use only 1-D pattern or 2-D pattern of a few fixed sizes. 1D dictionary algorithm is proposed in the paper listed below providing an arbitrary shape matching scheme for screen content coding. In specific, a Coding Unit (CU) is split into multiple pixel sample strings, where sample denotes each color component (Y, U or V) of a pixel. This technique has been proposed in [the JCTVC-L0303] document, T. Lin, K. Zhou, X. Chen, and S. Wang, “Arbitrary Shape Matching for Screen Content Coding,” Picture Coding Symposium (PCS), San Jose, 2013.

When the string in the current CU has a matching string in the previously coded reconstructed area, two syntaxes are entropy coded, one of which is called matching string offset herein, denoting the relative distance between the current string and the reference string, and one of which is called matching string run herein, denotes the matching length. When the string in the current CU does not have the matching string in the previously coded reconstructed area, the original pixel sample is predictively coded. A 1D dictionary algorithm may be designed as an alternative coding mode competing with traditional HEVC coding modes, where an RD criterion is used to select the best mode in terms of minimum rate-distortion (RD) cost for each CU.

The 1D dictionary as proposed in JCTVC-L0303 supports mainly 4:4:4 coding and does not support 4:2:0 or 4:2:2 chroma sampling format.

Aspect of 1D dictionary coding will now be described. Video decoder 30 may be configured to implement a sample process. Each matching string may include just one or two samples of each pixel (containing three samples). That means, the starting of the string does not have to be the first sample of a pixel and the end of the string does not need to be the last sample of a pixel and the length of the run does not need to be a multiplication of three.

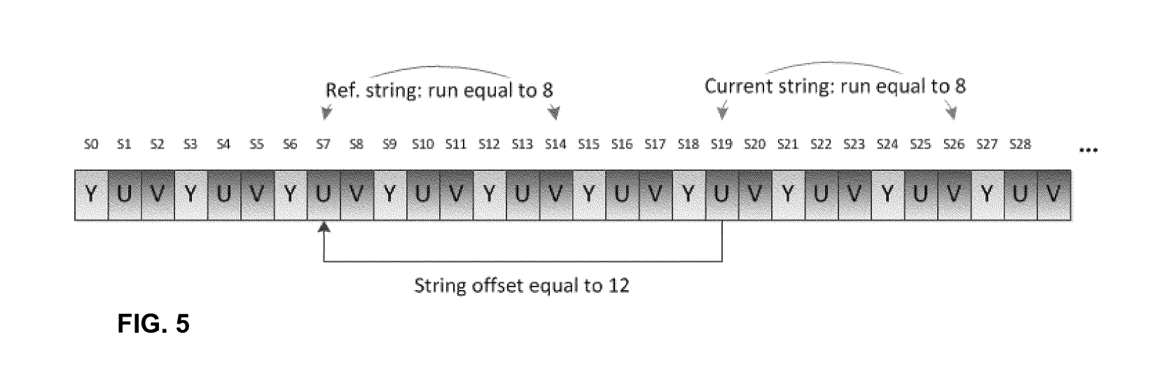

FIG. 5 shows an example of sample matching in a 1D dictionary coding mode. in the example of FIG. 5, an example of the sample process for the matching of a string is shown where the current string (for a U component) starts from sample position S19. In the example of FIG. 5, the string offset is 12, and the string starting from S7 is used to derive the sample values starting from S19. Here the matching string run is equal to 8, therefore, the derivation continues till sample S26 (belonging to V).

It can be seen from the example that a match does not start from Y, and the match may end from any component sample of any pixel. In theory, samples in pixel may be predicted by two string matches. In addition, the reference sample of a current sample can belong to a color component that is different from the one the current sample belongs to.

Video encoder 20 and video decoder 30 may be configured to perform matching string offset prediction and coding. In JCTVC-L0303, the matching string offset between the current string and the reference string is predicted using recently coded 8 matching string offsets.

The offset predictors are maintained and updated to be the last decoded string offsets once a block with 1D dictionary mode is decoded. The predictor set is reset to 0 for any offset predictor when a CU is coded using traditional HEVC mode. If the current matching string offset is equal to one of the offset predictors, matching_string_offset_use_recent_{—}8_flag is set to 1, and matching_string_offset_recent_{—}8_idx is coded to indicate the chosen predictor index. Otherwise, matching_string_offset_use_recent_{—}8_flag is set to 0, and the matching string offset is coded.

Video encoder 20 and video decoder 30 may be configured to perform matching string run prediction coding. In JCTVC-L0303, the techniques of which may be implemented by video encoder 20, the matching string run is encoded as follows:
matching_string_length_minus1 plus 1 indicates the matching string run.
if matching_string_length_minus1 is smaller than 8, a syntax element smaller_than_{—}8_flag is set equal to 1, and three bits fixed length coded matching_string_length_minus1 is coded;
Otherwise, smaller_than_{—}8_flag is set equal to 0, and matching_string_length_minus9 is set equal to matching_string_length_minus1 minus 8;
   if matching_string_length_minus1 is smaller than 16, smaller_than_{—}16_flag is set equal to 1, and three bits fixed length codeword is used to code matching_string_length_minus9;
   Otherwise, smaller_than_{—}16_flag is set equal to 0, and matching_string_length_minus17 is set equal to matching_string_length_minus1 minus 16, and 8 bits fixed length codeword is used to code matching_string_length_minus17

In JCTVC-L0303, the techniques of which may be implemented by video decoder 30, the matching string run is decoded as follows:
Decode smaller_than_{—}8_flag, and the following procedure is applied:
If smaller_than_{—}8_flag is equal to 1, matching_string_length_minus1 is decoded using 3 bit fixed length codeword;
Otherwise, smaller_than_{—}8_flag is equal to 0, smaller_than_{—}16_flag is decoded;
   If smaller_than_{—}16_flag is equal to 1, matching_string_length_minus9 is decoded using 3 bit fixed length codeword, and matching_string_length_minus1 is set equal to matching_string_length_minus9 plus 8;
   Otherwise, smaller_than_{—}16_flag is equal to 0, matching_string_length_minus17 is decoded using 8 bit fixed length codeword, and matching_string_length_minus1 is set equal to matching_string_length_minus17 plus 16;
matching_string_length_minus1 plus 1 indicates the matching string run.

Video encoder 20 and video decoder 30 may be configured to perform lossless matching and lossy matching. In the proposed 1D dictionary in JCTVC-0303, both lossless match and lossy match are supported. In lossless match, the current sample and reference sample are considered as matched if their intensity values are the same. In lossy match, the current sample and the reference sample are considered matched in case the absolute difference in their intensity values is smaller than a predefined value, e.g., 1, 2, 3, 4. For example, as shown in FIGS. 5, S19 and S7 are considered matched if S19=S17 for lossless match; and S19 and S7 are considered matched if |S19−S7|<=Th, where Th is a predefined value.

Video encoder 20 and video decoder 30 may be configured to process samples according to a processing order. In JCTVC-L0303, the samples within one clock are concatenated in a vertical direction. When samples of a first pixel have been processed/traversed, the samples in the next bottom pixel adjacent to the first pixel are processed/traversed. If the first pixel is already the in the block boundary, the next column of pixels may continue.

Still using FIG. 5 as an example, samples S0, S1 and S2 may belong to a pixel with coordination (x,y). After the pixel is processed, the next samples are those in the bottom pixel with coordination (x, y+1).

Video encoder 20 and video decoder 30 may be configured to perform CU padding. In the proposed 1D dictionary in JCTVC-0303, when the CU is on the picture boundary, it is possible that part of the current CU is outside the picture, of which the intensity values are missing. In this case, the values of these missing samples are padded first by setting the intensity values to 0. Then the padded CU is encoded using 1D dictionary.

Existing 1D dictionary coding techniques may suffer from several potential shortcomings. As one example, the processing order of 1D in each CU is vertical scan. However, there are more cases that there is higher horizontal similarity or horizontal repeated patterns in the screen content. As another example, the 1D string matching is applied on pixel samples. In this case, the matching string may include different pixels, a couple of which might not contain the three components in the matching string. This would result in cross pixel sample fetching for comparison (at the encoder) and compensation (at the decoder), which causes additional spectacular calculation and increased memory access.

As yet another example, the unmatched pixel sample are predicted using the previous coded pixel sample of the same channel, and the prediction error is entropy coded. This requires accessing the previous coded pixels and prediction error calculation with prediction error sign and absolute value coded. For the matched string, the syntax matching string offset is coded using exponential-Golomb like code word, which has redundancy in the prefix design given the current pixel location within the picture. The syntax element of matching string run is coded using region-based fixed length codewords, and the run is limited to 272, which may not be efficient when the matching length is over 272.

This disclosure describes techniques related to 1D dictionary coding that may address some of the shortcomings described above. The techniques described herein may, for example, be performed by video encoder 20 and/or video decoder 30. Various techniques for 1D dictionary coding are proposed in this disclosure. The various techniques may be used jointly or separately. Unless explicitly states, it should not be assumed that any of the described techniques are mutually exclusive or incompatible with other described techniques.

Video encoder 20 and video decoder 30 may perform signaling of 1D dictionary information. For example, video encoder 20 may determine such 1D dictionary information indicative of how a block is encoded and include in the bitstream syntax elements indicative of the determined 1D dictionary information. Video decoder 30 may receive the syntax elements, and thus determine the same information determined by video encoder 20 and utilize such information for decoding the encoded block. Examples of such determined 1D dictionary information includes:
a. A flag in a sequence parameter set (SPS), a Picture Parameter Set (PPS) and/or slice header may be present to signal whether 1D dictionary is enabled for pictures referring to the SPS or PPS or a slice.
b. A flag in a coding unit is introduced (optionally as the first syntax element of the coding unit) to indicate the usage of the 1D dictionary coding for the current coding unit.
c. When such a flag is 1, a syntax table for the 1D dictionary is transmitted, for example from a video encoder to a video decoder, as a loop of the following information for each iteration
   i. Indication of whether the current iteration is a sequential of (matching) pixels or an unmatched pixel (escape pixel).
   ii. If the current iteration is a sequential of pixels, the matching string offset indicating from where the sequential of pixels are predicted/copied.
   iii. If the current iteration is a sequential of pixels, a matching string run value: the number of pixels predicted/copied.

Memory access and management techniques are described below:
a. Traversing/processing order of 1D dictionary
   i. For each block, if a current block is coded with 1D dictionary, the each matching string run of the current block may follow the same traversing order which is raster scan order, namely horizontal scan. That is for example, starting from a first pixel in the current block, the run traverses horizontally. If the run is long enough, then the run traverses till the block boundary, and if the run is still longer, then the run goes to the first pixel of the next row in the current block.
   ii. Alternatively, the traversing/processing order may be vertical scan.
   iii. Alternatively, the traversing/processing order of the matching string runs within a block (e.g., CU or CTB) may be signaled by a flag.
b. The reference pixels used for 1D dictionary coding within the current picture maybe those ones that have not be processed with in-loop filter process, including de-blocking and sample adaptive offset (SAO).
c. The current matching string run and the reference matching string run may be synchronized in terms of relative geometric sample/pixel position to the first current pixel and first reference pixel.

Video encoder 20 and video decoder 30 may be configured to synchronize the current matching string run and the reference matching string run. To synchronize the current run and the reference run, when a current matching string run reaches the block boundary and goes to the first position of next row (column) of the current block, video encoder 20 and video decoder 30 also goes to the next row (column) to located its reference matching string run, with the same relative position. Assuming the current position is (x,y) and its reference position is (x′,y′) and the traversing/processing is horizontal and the block size is N×N. If (x+1)% N is equal to 0, the next position in the current matching string run is (x+1−N, y+1), the reference position of the next pixel shall be (x′+1−N,y′+1).

When a current matching string run has not reach the block boundary of the current block, even the reference matching string run reaches a certain block boundary, the reference matching string run does not traverse to the next row/column. Assuming the current position is (x,y) and its reference position is (x′,y′) and the traversing/processing is horizontal and the block size is N×N. If (x+1)% N is not equal to 0, the next position in the current matching string run is (x+1, y), the reference position of the next pixel shall be (x′+1,y′).

The above mentioned mode, as in this section, is denoted as 2d reference mode, for which both reference pixels and the current pixels of the current run form the same shape and can have multiple rows in the picture.

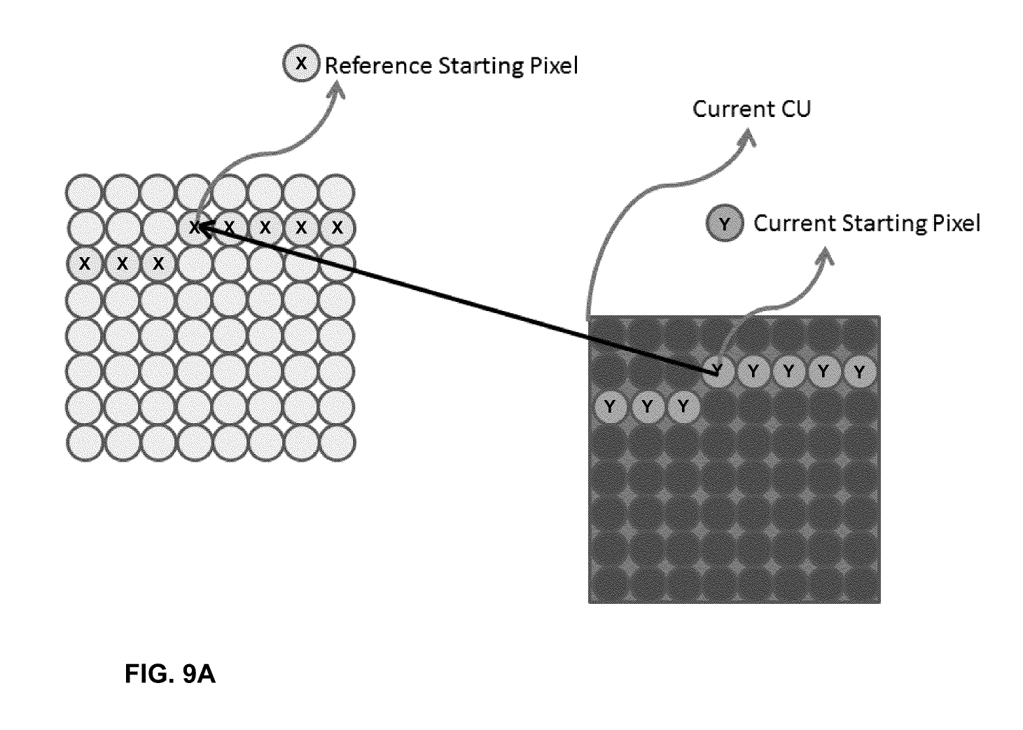

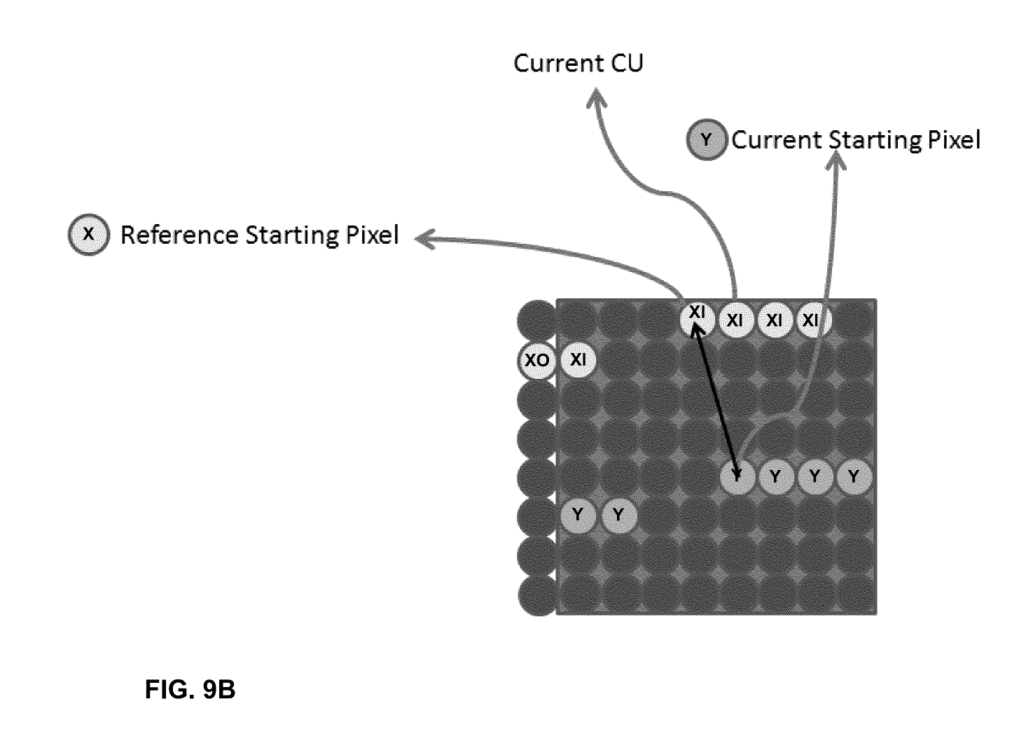

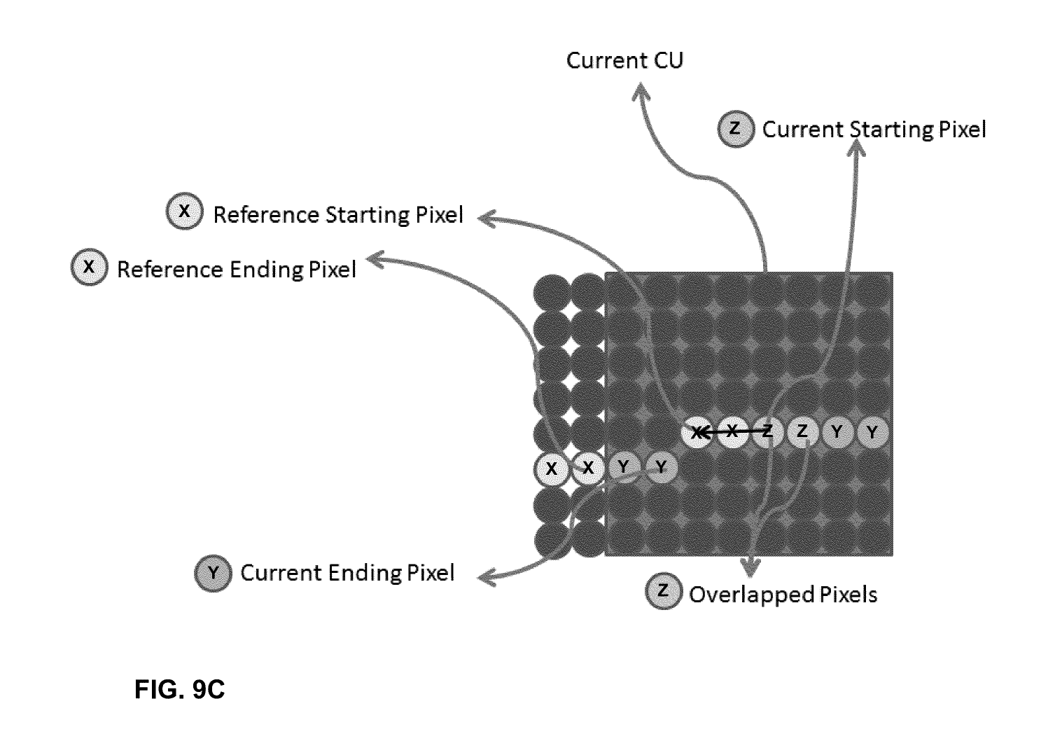

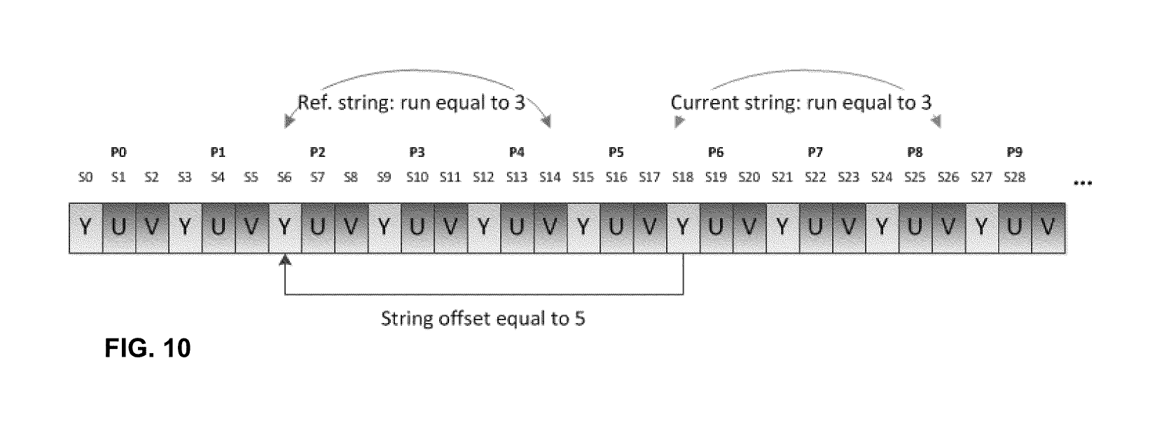

In the 2d reference mode, it is possible that the reference pixels belong to the same CU/PU/block and/or the reference pixels may overlap with the current pixel. So the reference pixels may be located in the following relative areas. FIG. 9A shows an examples where all reference pixels (labeled “x”) are not within the current CU/PU. FIG. 9B shows an example where some reference pixels are within the current CU/PU while some reference pixels are outside the current CU/PU. In the example of FIG. 9B, the reference pixel labeled “XO” is outside the current CU/PU, while the reference pixels labeled “XI” are inside the current CU/PU.

In some example, all reference pixels may be within the current CU/PU. In some examples, the reference pixels and the current pixels of the current run may overlap. FIG. 9C shows an example where the reference pixels and the current pixels of the current run overlap. In the example of FIG. 9C, pixels labeled “X” are reference pixels, and pixels labeled “Y” are pixels being predicted. Pixels labeled “Z” are overlapping pixels that are both pixels being predicted and reference pixels. The overlapping pixels are first predicted, then later used as reference pixels.

Pixel processing of the minimum unit of the 1D dictionary is described below:
a. Full pixel matching and decoding.
   1. The matching string is composed of number of pixels, and the number of pixels is equal or larger than one.
   2. Each pixel contains three samples (components), such as Y, U, V or R, G, B.
   3. The number of pixels that have matched reference pixels is called matching string run, and matching string run is equal or larger than one.
b. The relative position between the current pixel and reference pixel in the 1D domain is called matching string offset, where the 1D domain is composed of pixels in the raster scan order within each CU. Alternatively, the relative position can be represented by 2D displacement vector, (MVx, MVy), where MVx and MVy are the horizontal and vertical components of the displacement vector between the current pixel and reference pixel in the 2D image.
c. Support of 4:2:0 or 4:2:2 coding.
   1. In case the video content format is 4:2:0, the 1D dictionary mode can operate in different channels separately. For example, for Y component, the 1D dictionary mode can be used to find the reference Y samples. And for U component, the 1D dictionary mode can be used to find the reference U samples. And in V component, the 1D dictionary mode can be used to find the reference V samples. And the associated syntax elements matching string offset and run for Y, U and V are coded separately. In other words, the offset and run are different for different channels.
   2. Alternatively, for the video content format 4:2:0, the 1D dictionary mode can operate in Y only and UV jointly. For example, for Y component, the 1D dictionary mode can be used to find the reference Y samples. And for UV components, the 1D dictionary mode can be used to find the reference UV samples concurrently. Thus, one pair of offset and run is coded for Y component, and one pair of offset and run is coded for UV jointly
   3. Alternatively, the 1D dictionary mode can operate with interpolated UV components. For example, bilinear interpolation filter, for example [1, 2, 1] can be used to interpolate the UV samples such that the interpolated samples UV have the same resolution as Y. Alternatively, nearest neighbor filter can also be applied to achieve 420 to 444 conversion. Thus, each pixel has three samples Y, U and V. And the 1D matching is applied to three samples of one pixel concurrently. Thus, only one pair of offset and run is coded for Y, U and V.

Video encoder 20 and video decoder 30 may be configured to predict the matching string offset according to one or more of techniques described below:
a. Predictors from the latest previously different coded matching string offsets may be maintained to identify/predict the current matching string offset. The number of predictors may be 1, 2, 3, 4, 5, 6, or 7 such predictors form an offset predictor list.
b. In one alternative, a previous matching string offset can be used as a predictor for the current matching string offset ONLY if the previous matching string offset belongs to the same CTB or CU of the current matching string.
c. Instead of always using latest previously decoded matching string offsets, offsets of the neighboring matching string runs can be used to be put into the offset predictor list. For example, a matching string run which includes the left pixel adjacent to the first pixel of the current matching string is used and its offset is considered as the left offset predictor. Similarly the offset of the matching string run which includes the above pixel adjacent to the first pixel of the current matching string is considered as the top offset predictor. The left offset predictor and/or the above offset predictor may be inserted into the predictor list (which has a fixed length) and therefore, other predictors from earliest decoded matching string runs may be pruned and other predictors with the same offset values may be pruned.
d. In addition, it is proposed that an index is signaled to the offset predictor list even when the current offset is different from any of the entries in such list. In this case, an offset refinement may be further signaled. This mechanism is called differential offset coding.
   i. Differential offset coding may be adaptively enabled, and indicated by a flag. For example, two flags, namely offset_list_present_flag and diff_code_flag can be present.
      1. If offset_list_present_flag is equal to 1, an index to the offset predictor list is presented and the offset is set to be the entry identified by the index.
      2. Otherwise, if diff_code_flag is equal to 1, an index to the offset predictor list is presented and the differential offset coding is enabled (by sending a difference value) and the offset is set to be the entry identified by the index plus the difference value.
      3. Otherwise (both above flags are 0), the offset is directly signaled without prediction.

Under some scenarios, video encoder 20 and video decoder 30 may reset all offset predictors to be all 0. The offset predictor reset (each offset predictor is set to 0) may be done, for example, in two scenarios. First, the offset predictor reset may only occur after the decoding of each picture/slice/tile starts and before any coding unit is decoded. Secondly, the offset predictor reset may happens either at the beginning of each picture/slice/tile similar as describe above or when a coding unit which is not coded with 1D dictionary mode is decoded.

In addition, the offset predictors in the set may be inserted in a way that the offset predictors are different from each other. Therefore, pruning can be done by comparing the latest coded/derived offset with the ones already present in the set. If the latest coded/derived offset is not the same as any present offset, then the latest coded/derived offset may be inserted as the last one on the coded offset and first in first out mechanism can pop out an early inserted one if the set contains already N number of entries (here N can be e.g., equal to 8). When the latest coded/derived offset is the same as an existing offset, then the latest coded/derived offset is either not inserted or still inserted at the end. If inserted, the other offset that is the same as the latest coded/derived offset may be removed, and the other offsets in the set may be shifted sequentially to fill in the emptied slot. The index to the offset predictor set, however can be arranged in a way that a smaller index corresponds to a later entry in the offset predictor set.

Video encoder 20 and video decoder 30 may be configured to perform entropy coding of the major 1D dictionary syntax elements as follows:
a. When a sample/pixel is coded without a matching string in a coding unit that is coded with 1D dictionary, instead of using differential coding, the sample or each sample of the pixel may be directly coded without prediction. For example, if the bit depth of input sample is of 8 bit precision, the codeword length for each sample is 8 bit. Define such a sample/pixel as escape sample/pixel.
   1. Alternatively, a quantization can be applied to such an escape sample/pixel, and the quantized escape pixel samples are coded using fixed length codeword.
b. When the offset is not predicted but explicitly coded, the offset may be entropy coded using a prefix codeword which is truncated binary and a codeword suffix which is fixed length coded, the length of which is uniquely decided by the prefix.
c. Instead of using a complicated method as in JCTVC-L0303, the matching string run is coded (e.g. encoded or decoded) using truncated rice codeword with rice parameter equal to 4 and the cMax value being defined also by the rice parameter. For example: cMax is equal to 3<<cRiceParam. When the value of the syntax element is larger than or equal to cMax, the suffix is coded using exponential Golomb codeword with the Exp-Golomb order k set equal to cRiceParam+1.
   1. Alternatively, the matching string run can be coded using exponential Golomb code.
   2. Alternatively, the matching string run can be coded with combination of Golomb and exponential Golomb code word. For example, the Golomb code is used for first k symbols and starting from (k+1)-th symbol, the codeword is composed of the concatenation of Golomb code (as prefix) and the exponential Golomb with exponential Golomb parameter t (as suffix).
d. Alternatively, the syntax run can be predicted using recently coded runs in a way similar to matching string offset prediction and coding.

Lossy matching and coding for 1D dictionary. The 1D dictionary can be coded by lossless matching a sequential of pixels at the encoder in a way that certain level of error is allowed. It is proposed that when lossy matching is allowed, the residual may be transmitted. One example is as follows:
a. A residual value may be transmitted for each run (a sequential match of pixels) for each color component.
   i. Alternatively, such a residual may be only available for one or two color components.
   ii. The residual value may be transmitted depending on the predicted or signaled Quantization Parameter (QP) value of the current coding unit. For example, the range of the residual value may be dependent on the QP value.
   iii. A flag may be introduced to indicate if such a residual is transmitted.
b. Alternatively, a residual quad-tree (RQT) as in the current HEVC may be transmitted when lossy coding of 1D dictionary is enabled.
   i. In this case, alternatively or additionally, a residual_skip_flag may be introduced to indicate that no RQT is presented and thus no further residue is available for the whole coding unit.
   ii. In this case, alternatively or additionally, a flag indicating whether the transform may be skipped for the whole coding unit may be present.
c. Alternatively, 1D dictionary can be enabled at TU level.
   i. In this case, when the transform is not skipped and 1D dictionary is enabled for a TU, only the available pixels out of the TU can be used as the prediction of 1D dictionary mode;
   ii. In this case, when the transform is skipped and 1D dictionary is enabled for a TU, both the available pixels out of the TU and the available pixels in the TU can be used as the prediction of 1D dictionary mode;
   iii. Regardless of whether the transform is skipped or not, 1D dictionary may be enabled at TU level only if the CU size is smaller or larger than a predefined size. As an example, 1D dictionary is only enabled to TUs when its corresponding CU is smallest CU. It is also possible that 1D dictionary is only enabled to TUs when its corresponding CU is LCU.

Cross frame 1D matching techniques are described below:
a. The 1D dictionary may be typically built within one frame/slice in a way that before decoding a slice/frame, the pixel reference buffer is cleaned. In other words, in the decoder side, the matching string offset value is contained in a way that starting from the first pixel of a current matching string plus the word offset is still indicating a pixel within the current frame/slice.
b. In addition, pixels within multiple frames may be accumulated together into the pixel reference buffer. Therefore, a matching string may just refer to pixels of a different frame or even pixels, some of which are in the previous frame and some of which are in the current frame.
   i. In this case, besides pixels of the current picture, a pixel reference buffer may only be able to contain pixels of a picture that is within the reference picture set and has an equal or lower temporalId than that of the current picture.
   ii. Alternatively or additionally to the matching string offset and run, a reference index may be signaled.
      1. In one example the syntax element is ref_idx_plus1, wherein ref_idx_plus1 equal to 0 indicates the current picture and ref_idx_plus1−1 indicates a picture in RefPicList0 or RefPicList1, which is e.g., RefPicList0[ref_idx_plus1−1].
      2. In another example, only one unique reference picture is chosen in advance, either by a signaling in slice header or by certain criteria, such as the closest one in display order. Therefore, only a one-bit syntax element is signaled to indicate whether the matching string is predicted from the reference picture or the current picture. Such a predetermination mechanism applies for the case in bullet i).
      3. Alternatively or additionally, when indicating a reference picture being not the current picture is enabled, the offset value may be negative, meaning that the offset corresponds to a pixel that has a co-located position in the current frame which may be coded after the current matching string is coded.
      4. Alternatively or additionally, when indicating a reference picture being not the current picture is enabled, the offset value shall always be positive, meaning that the offset corresponds to a pixel that has a co-located position in the current frame which is already coded.
   iii. Constrained intra prediction (CIP) for 1D dictionary coding may be enabled.
      1. When CIP is enabled, 1D dictionary mode is disabled in P/B slice;
      2. Alternatively, when CIP is enabled, 1D dictionary mode may be enabled in P/B slice but only predicted from pixels in Intra coded blocks.
      3. Alternatively, when CIP is enabled, the reference samples inside any blocks with 1D dictionary mode are considered unavailable in P/B slice for intra prediction and Intra BC;
      4. Alternatively, when CIP is enabled, only the pixels inside the blocks with Intra, Intra BC or 1D dictionary modes can be used as prediction of the blocks with 1D dictionary mode;
      5. Alternatively, when CIP is enabled, the pixels inside the blocks with inter prediction modes are considered unavailable for the prediction of the blocks with 1D dictionary mode and will be substituted with the neighboring available pixels or will be generated using padding with techniques described below.

Video encoder 20 and video decoder 30 may be configured to perform padding for the 1D dictionary coding mode. For the pixels which are unavailable (either out of the tile/slice boundary or not reconstructed) for prediction of blocks with 1D dictionary mode, video decoder 30 can be generate the unavailable pixels through padding methods, and the padded pixels may be considered available for prediction of a matching string run. For the pixels which are unavailable (out of tile/slice boundary) in current CU/TU, video decoder 30 can generate the unavailable pixels through padding methods and can decode the CU/TU with the padded pixels using 1D dictionary. Alternatively, the padding direction/method can be dependent on the traversing/processing order of 1D dictionary.

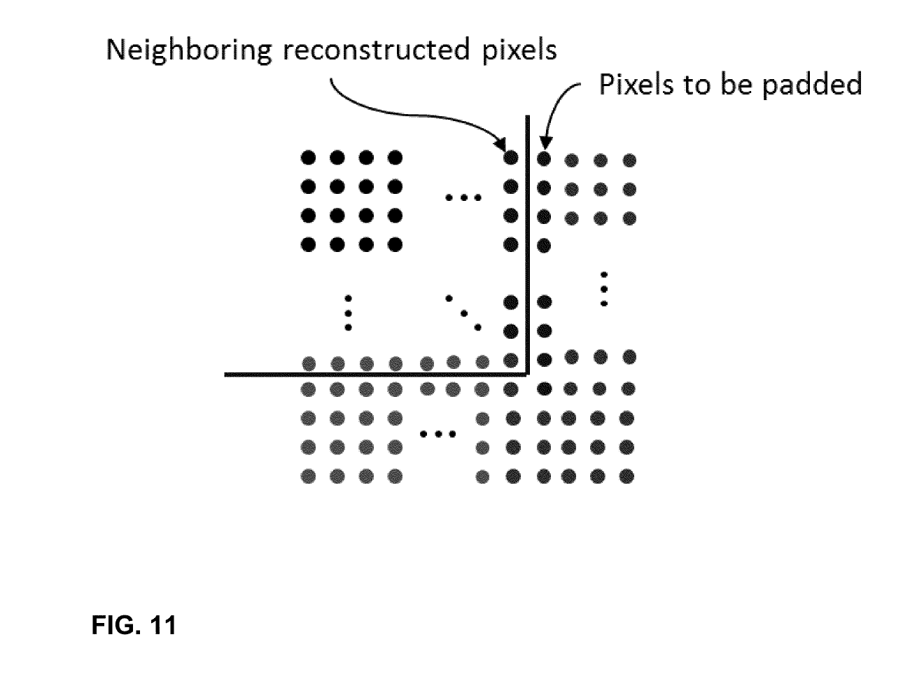

Aspects of picture boundary padding for 1D dictionary will now be described in more detail. Video encoder 20 and video decoder 30 may perform padding for prediction and a current CU/TU. As described in the techniques above, when the pixels in the prediction and current CU/TU are unavailable, the pixels can be padded according to a padding technique. As one example, unavailable pixels may be padded with a predefined fixed value, such as 0, or (2<<(B−1)), where B is the pixel bit depth of a component containing the sample in the pixel. As another example, the unavailable pixels may be padded by horizontally or vertically copying the nearest available reconstructed pixels as shown in FIG. 11, which shows an example of padding through copying. When there is no neighboring reconstructed pixels for the padding, then one of the other techniques described above may be used.

Video encoder 20 and video decoder 30 may perform traversing and/or processing order dependent padding. As described above, the padding direction/method may be dependent on the traversing/processing order of 1D dictionary. When the processing order (string run direction) is horizontal, an unavailable sample/pixel is padded from the closest available sample/pixel of the same row and when the processing order (string run direction) is vertical, an unavailable sample/pixel is padded from the closest available sample/pixel of the same column.

An example range of the matching string offset will now be described. It is proposed to signal the range of matching string offset using high level syntax to help the codec allocate the storage. The maximum range of the matching string offset can be indicated in integer luma sample units, for all pictures in the coded video sequence. Alternatively, a value can be indicated in a more compressed fashion, for example a value n indicates the range of the matching string offset is 2ⁿ, in units of integer luma sample displacement. Alternatively, the high level syntax can indicate the maximum range of the matching string offset, in integer luma sample units, for all pictures in the coded video sequence. A value of n asserts that no value of a matching string offset is larger than n, in units of integer luma sample displacement. Such a value may be present in VUI (Video Usability Information), or other places in sequence parameter set, video parameter set, or an SEI message. Alternatively, such a range may be considered as part of level definition.

Video encoder 20 and video decoder 30 may be configured to implement one or more constraints for matching string offset. In one example, the matching string offset can be constrained for 1D dictionary coding such that the pixels used to predict a matching string in the current CU always below to the current CTB row of the current slice. When inter prediction of 1D dictionary is enabled, the matching string offset can be constrained that pixels used to predict the current CU always below to either the current CTB row of the current slice of the co-located LCU row of the reference picture.

Alternatively, prediction from one or two or more CTB rows above the current CTB row as well as the current CTB row from the current slice may be enabled. In this case, inter prediction of 1D dictionary is only enabled from the co-located LCU row of the reference picture. In one example, only the current CTB row and one above CTB row of the current slice and one CTB row (co-located with the current CTB row) in the reference picture can be used to predict the current matching string during 1D dictionary coding.

Alternatively, N CTB rows in the current slice and M CTB rows of the reference picture may be used. In one example N is equal to M. The N CTB rows start from the current CTB row and may include the consecutive above CTB rows. The M CTB rows start from the CTB row (co-located with the current CTB row) and may include the consecutive above CTB rows in the reference picture. Alternatively, The M CTB rows start from a CTB row below the CTB row co-located with the current CTB row and may include the consecutive above CTB rows in the reference picture.

Based on the above introduced techniques, several additional techniques for 1D dictionary coding will now be described. For memory access and management, it is proposed that the traversing/processing order of 1D dictionary can be horizontal to make the memory access more friendly to implementation. Related to full pixel matching, discussed above, this disclosure proposes to disallow sample-level matching. Instead, the matching is applied in units of pixels, which means each run of the match string may contain one or more full pixels. In the case of 4:4:4 chroma subsampling format, each pixel contains three samples. For multiple matching orders, it has been proposed that the dictionary coding can match the strings in a way that the reference pixels form the same shape as the pixels of the current run. This matching is called 2D matching mode. In addition, it is still possible that the 1D dictionary coding can match the strings in a way that the reference pixels can be a different shape as the pixels of the current run. This matching is called 1D matching mode.

Bin Li et al., “Description of screen content coding technology proposal by Microsoft,” JCTVC-Q0035, Valencia, E S, 27 Mar.-4 Apr. 2014 (JCTVC-Q0035), incorporated by reference herein, also proposed 1D dictionary coding methods. In the example of JCTVC-Q0035, the 1D dictionary mode is enabled for all CUs; and both the horizontal scanning and vertical scanning are supported. Two types of 1D dictionary modes were proposed, the first one needs to maintain a dictionary for prediction, like coding a file using Lempel-Ziv (LZ-78), and the second one uses all the previously reconstructed pixels in the same picture (slice and tile) for prediction.

In the first mode, which is called normal 1D dictionary mode, all the previous coded pixels using 1D dictionary mode are kept in the dictionary (unless the maximum dictionary size is achieved) and may be used for prediction. The basic dictionary size is 1<<18 pixels. When the dictionary reaches 150% of basic dictionary size, the oldest 50% pixels are removed from the dictionary. The removing process is only invoked after encoding/decoding an entire Coding Tree Unit (CTU). In this mode, prediction mode and direct mode are allowed. In prediction mode, an offset (the offset relative to the position of the current pixel in the dictionary) and a matching length are signaled. In direct mode, the pixel value is signaled directly. Additional memory to maintain dictionaries is required at the decoder side. Note that this mode is similar to the 1D matching mode as described in the above subsection.

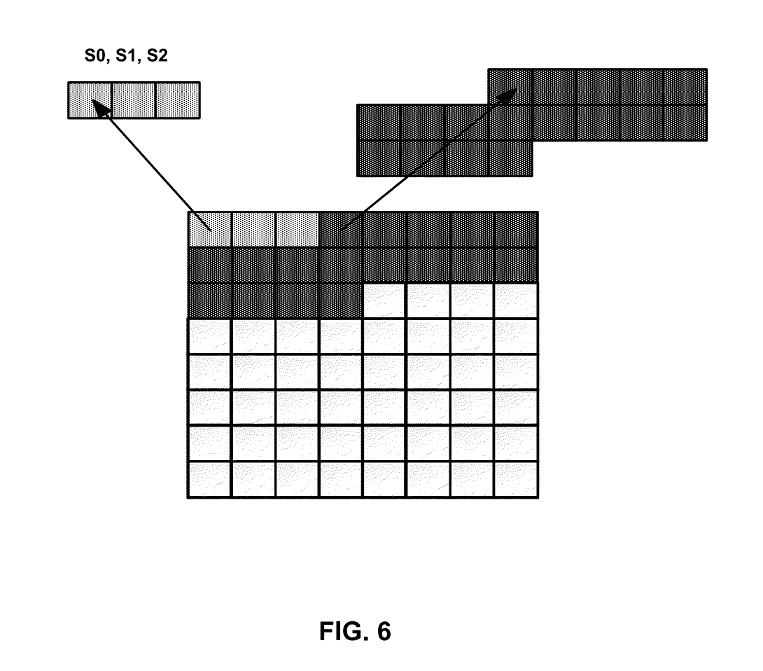

FIG. 6 is a conceptual diagram illustrating an example of reconstruction based 1D dictionary coding and 2D matching mode. In the second mode, which is called reconstruction based 1D dictionary mode, all the previously reconstructed pixels can be used for prediction. Prediction mode and direct mode are also allowed. In prediction mode, two offsets (X offset and Y offset relative to the position of the current pixel in the picture) and a matching length are signaled. In direct mode, the pixel value is also signaled directly. When the current region starts a new row or column, the pixel used for prediction also starts a new row or column, as shown in FIG. 6. The example shown in FIG. 6 is an 8×8 CU using reconstruction based 1D dictionary mode with horizontal scanning First, a matching length of three and two offsets are signaled. And then a matching length of 17 and two offset are signaled. There is no additional memory requirement at the decoder side.

Palette-based coding may be another mode that may be particularly suitable for screen generated content coding. For example, assume a particular area of video data has a relatively small number of colors. A video coder (a video encoder or video decoder) may code a so-called “palette” as a table of colors for representing the video data of the particular area (e.g., a given block). Each pixel may be associated with an entry in the palette that represents the color of the pixel. For example, the video coder may code an index that relates the pixel value to the appropriate value in the palette.

In the example above, a video encoder (such as video encoder 20) may encode a block of video data by determining a palette for the block, locating an entry in the palette to represent the value of each pixel, and encoding the palette with index values for the pixels relating the pixel value to the palette. A video decoder (such as video decoder 30) may obtain, from an encoded bitstream, a palette for a block, as well as index values for the pixels of the block. The video decoder may relate the index values of the pixels to entries of the palette to reconstruct the pixel values of the block. The example above is intended provide a general description of palette-based coding.

Hence, based on the characteristics of screen content video, palette coding may be introduced to improve SCC efficiency firstly proposed in Guo et al., “Palette Mode for Screen Content Coding,” JCTVC-M0323, Incheon, K R, 18-26 Apr. 2013, incorporated by reference herein (JCTVC-M0323). Specifically, palette coding introduces a lookup table, i.e. color palette, to compress repetitive pixel values based on the fact that in SCC, colors within one CU usually concentrate on a few peak values. Given a palette for a specific CU, pixels within the CU are mapped to the palette index. In the second stage, an effective copy from left run length method is proposed to effectively compress the index block's repetitive pattern.

In other examples, e.g., in accordance with Misra et al., “SCE2 Cross Check Report of 2.2,” JCTVC-N0259, Vienna, A T, 25 Jul.-2 Aug. 2013, incorporated by reference herein (JCTVC-N0259), the palette index coding mode is generalized to both copy from left and copy from above with run length coding. Note that no transformation process is invoked for palette coding to avoid blurring sharp edges which has a negative impact on visual quality of screen contents.

Aspects of Palette Derivation will now be discussed. A palette is a data structure which stores (index, pixel value) pairs. The designed palette may be decided at the encoder e.g. by the histogram of the pixel values in the current CU. For example, peak values in the histogram are added into the palette, while low frequency pixel values are not included into the palette.

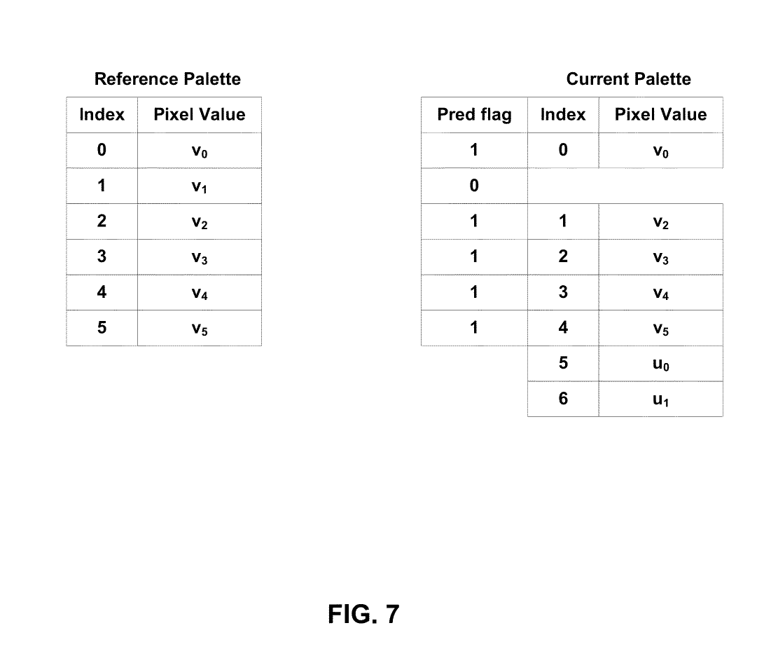

FIG. 7 is a conceptual diagram illustrating an example of palette prediction in palette-based coding. Aspects of palette coding will now be discussed. For SCC, CU blocks within one slice may share many dominant colors. Therefore, video encoder 20 and video decoder 30 may predict a current block's palette using previous palette mode CUs' palettes (in CU decoding order) as reference. Specifically, a 0-1 binary vector is signaled to indicate whether the pixel values in the reference palette is reused by the current palette or not. For purposes of example, in FIG. 7, assume that the reference palette has six items. A vector (1, 0, 1, 1, 1, 1) is signaled with the current palette which indicates that v₀, v₂, v₃, v₄, and v₅ are re-used in the current palette while v₁ is not re-used. If the current palette contains colors which are not predictable from reference palette, the number of unpredicted colors is coded and then these colors are directly signaled. For example, in FIG. 7, u₀ and u₁ are directly signaled into the bitstream.

Video encoder 20 and video decoder 30 may be configured to perform palette based pixel coding. In palette based pixel coding, video encoder 20 and video decoder 30 code the mapped pixels in the CU in a raster scan order using three modes, as follows:
1. “Copy from Left” run mode (CL): In this mode, one palette index is first signaled followed by a non-negative value n−1 indicating the run length, which means that the following n pixels including the current one have the same pixel index as the first signaled one.
2. “Copy from Above” run mode (CA): In this mode, only a non-negative run length value m−1 is transmitted to indicate that for the following m pixels including the current one, palette indexes are the same as their above neighbors, respectively. Note that this mode is different from Copy from Left mode, in the sense that the palette indices could be different within the Copy from Above run mode.
3. “Escape” mode: Escape mode is used to code low frequency pixels which are not mapped into index in palette. Quantized pixels are directed coded into the bitstream. Note that an escape pixel is similar to the pixel coded in 1D dictionary when a string match is not found starting from the current pixel.

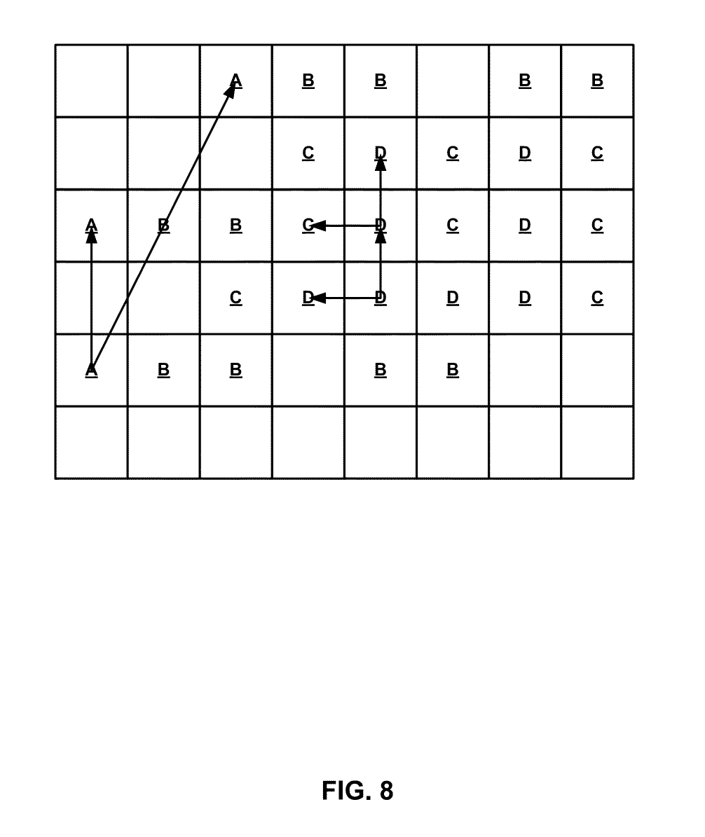

Video encoder 20 and video decoder 30 may be configured to code video data using transition mode in palette coding. FIG. 8 is a conceptual diagram illustrating an example of a transition mode in palette-based coding. In Gisquet et al., “AhG10: Transition copy mode for palette mode,” JCTVC-Q0065, Valencia, E S, 27 Mar.-4 Apr. 2014, incorporated by reference herein (JCTVC-Q0065), a new palette mode, namely transition mode was proposed. When this mode is enabled for the current run, a group of consecutive reference pixel (forming a string) within the same coding unit are used to fill in the pixel values of the current run.

Therefore, the transition mode is similar to 1D dictionary mode, with certain constraints and differences. For example, the string matching always happens within the same CU. The string matching fashion is similar to the 1D match mode of 1D dictionary coding. The offset between the current pixel and the starting position of the reference pixels are purely derived. Assume, for example, the current pixel position is (x, y) and its previous pixel in raster scan order is (x′, y′) with a palette index idx. For each palette index, a latest position (x_{idx}, y_{idx}) is maintained, which indicates where the latest transition (change of palette index) happens. Therefore the offset for the current run is derived as (x′,y′)−(x_{idx}, y_{idx}), in the 2D vector representation, which can be converted to a single offset value if needed. Examples of the transition mode are shown in FIG. 8, where the pixels starting from those indicated by the “B” blocks following the pixels indicated by the “A” blocks form the current string and the reference string.

The existing 1D dictionary coding methods have the following potential problems, especially when supported together with palette coding. As one example, each run of the 1D dictionary may be as short as 1 pixel, therefore a lot times of memory accesses need to be done for a CU, e.g., a 8×8 CU may require 64 times memory access in 1D dictionary coding while only 4 times memory access in Intra BC.

As another example of a potential problem, the transition mode in palette coding is similar to 1D dictionary coding, but the transition mode may have some drawbacks. For example, the transition mode only supports the 1D matching mode and does not support the 2D matching mode. The transition mode only happens within the current CU, hence the prediction of the matched string only happens within one CU and cannot refer to pixels outside the current CU. The offset of the string matching can only be implicitly derived by one single hypothesis. Therefore, the flexibility of 1D dictionary coded jointly with palette modes within one block may be greatly eliminated.

Various aspects on 1D dictionary coding are proposed in this disclosure. Each of the techniques of this disclosure described below may work jointly or separately with the other techniques described below. The proposed techniques can apply to 1D dictionary coding as well as a transition mode in palette coding.

According to one technique of this disclosure, it is proposed that when 1D dictionary coding applies, the minimum length of a string run may be constrained to improve the memory access efficiency caused by 1D dictionary.
a. In one example, the minimum length of run may be no smaller than N, wherein N can be 4, 8, 16 or any number larger than 4.
   i. Alternatively, such a number may be no smaller than N unless that number hits the right boundary of the CU.
b. In another example, when 2D matching mode is used, a string of length N is considered as a valid matching when at least M rows (including the row containing the current pixel) are included in the current 2D matching. Here, M can be any number as long as the matching string covers a number N of pixels which is equal or larger to the number of pixels accessed during normal 4×8 or 8×4 motion compensation. In this example, the current string starts from the beginning of a row within the current CU and the CU width is W, then the minimum M is equal to _{┌}N/W_{┐}. In this case, the number of the string length is constrained depending on the CU width.
   i. In one example, M, which is dependent on the width of the current block (CU) is constrained to be equal to 4, or 8.
   ii. Alternatively, M can any number as long as the matching string covers a number N of pixels which is similar to the number of pixels accessed during 4×4 Intra BC.
c. Alternatively, the minimum length of runs for 1D coded pixel strings is not constrained; instead, the number of 1D coded pixel strings within one block (CU) is constrained to be not larger than a given number of L, namely the maximum number of runs. In one example L is equal to 4, in another example, L is equal to 2. In another example, L is equal to 8. L may be other integer numbers as well.
   i. Alternatively or additionally, for a CU with a size larger than 8×8 (assuming the CU is 8*d×8*d, where d is a scale factor), the number of 1D coded pixel strings within such a CU may be no more than d*d*L.
   ii. Alternatively, a run may be considered to be composed of K sub-runs, if the run runs through reference pixels belonging to multiple K lines. In this case, the number of 1D coded sub-runs is constrained to be not larger than a given number of J. In one example J is equal to 4, in another example, J is equal to 2. In another example, J is equal to 8. J may be other integer numbers as well.
d. Alternatively, the above listed constraints may be applied only when the matching string offset value is larger than a given positive integer G. The value of G may depend on the hardware architecture. For example, if each cache line contains X bytes, then G could be equal to X/3 or a fraction or multiple of this value. The value of G may also depend on the on-chip memory size.
e. Alternatively or additionally, when the above run constraint is applied, the matching length is signaled using matching length minus N, where N is the minimum length of run (mentioned in Bullet 1). Specifically, if the matching length is L and the minimum length N constraint is applied, the matching length information is coded using (L−N), for L>=N, wherein the value of (L−N) is binarized and coded using in a way similar to the method of coding normal runs in 1D dictionary.
f. The run constraint may be signaled in high level syntax for instance, picture parameter set, sequence parameter set, slice header, an SEI message.
g. Alternatively, regardless of the run constraint, the matching length is coded directly, instead of using matching length minus N. And the run constraint may or may not be signaled in different levels, for instance, picture level, slice level, tile or CU level, or indicated in SEI messages.

Video encoder 20 and video decoder 30 may enable 1D dictionary coding for a current CU which is coded with palette modes. In other words, when a CU is coded with palette modes, one or more runs may be coded with 1D dictionary. For example, in a palette coded CU, there can be four different modes, “Escape” mode, “Copy from Left” mode, “Copy from Above” mode and “1D dictionary” mode.
a. In one alternative, the above constraint (as in bullet 1) on the lengths of the string matches can apply in a way that for areas that 1D dictionary coding is not suitable, other palette modes (excluding transition mode) apply. Alternatively, since the other palette modes may not require memory access to pixels outside the current CU, for the whole CU, the total number of times of memory access to the reference area (of the current picture, slice or tile) can be limited. In some examples, the above constraint may not need to be required to apply to typical palette modes, such as “Escape” mode, “Copy from Left” mode, and “Copy from Above” mode, although such constraints may apply to the transition mode. In other examples, the above constraints may be applied to different modes or combinations of modes.
b. In another alternative, when 1D dictionary is combined with palette coding within one CU, both the 1D matching mode and the 2D matching mode may be supported.
c. In another alternative, when 1D dictionary is combined with the palette coding that enables transition mode, the transition mode can be extended in a way similar to 1D dictionary coding with the support of 2D matching mode.
d. In another alternative, the constraint on the memory access (as in bullet 1) can be achieved by limiting the number of times the “1D dictionary” mode is enabled per CU, e.g., less than N times. When the mode has been used N times, then the signaling or flag for that mode is not sent anymore for the CU, and inferred to be disabled/0.

Alternatively, the constraints for the minimum length of runs are different for different reference types/ranges. An example is provided here. When the 1D dictionary mode is predicted from reference within one CU, the constraint is controlled by an integer number of N_{cu}. When the 1D dictionary mode is predicted from reference within one CU, the constraint is controlled by an integer number of N_{cu}. Otherwise, when the 1D dictionary mode is predicted from reference current reconstructed CTU, the constraint is controlled by an integer number of N_{ctu}. Otherwise, when the 1D dictionary mode is predicted from reference within left CTU, the constraint is controlled by an integer number of N_{ctu-1}. Otherwise, when the 1D dictionary mode is predicted from reference of other regions, the constraint is controlled by an integer number of N_{f}, Different or same values can be provided for N_{cu}, N_{ctu}, N_{ctu-1}, N_{ref} and N_{f}, with the following constraint: N_{cu}<=N_{ctu}<=N_{ctu-1}<=N_{ref}<=N_{f}. For example N_{cu} can be equal to 4, N_{ctu} can be equal to 8, N_{ctu-1} can be equal to 16 and N_{ref} can be equal to 32 and N_{f} can be equal to 32.
a. Alternatively or additionally, when a run is predicted from ONLY the above neighboring row, no constraint applies. Therefore, for example, when N_{ctu} is equal to 8 and there are several runs with lengths of 1, 2 or 3, but all predicted from the above rows of the row containing the starting current pixel, these run are considered as legal.
   i. When the current pixel belongs to the first row of the current CT, the above neighboring row may be considered as the above row that contains all pixels that are available for HEVC Intra prediction mode.
b. Alternatively or additionally, when a run is predicted from ONLY the above neighboring row or already coded pixels of the current row, no constraint applies.
c. Alternatively or additionally, such an above neighboring row must belong to the current CU.

Alternatively, the constraints for the maximum number of runs are different for different reference types/ranges. An example is provided here. When the 1D dictionary mode is predicted from reference within one CU, the constraint is controlled by an integer number of L_{cu}. Otherwise, when the 1D dictionary mode is predicted from reference current reconstructed CTU, the constraint is controlled by an integer number of L_{ctu}. Otherwise, when the 1D dictionary mode is predicted from reference within left CTU, the constraint is controlled by an integer number of L_{ctu-1}. Otherwise, when the 1D dictionary mode is predicted from reference of other regions, the constraint is controlled by an integer number of L_{f}, Different or same values can be provided for N_{cu}, N_{ctu}, N_{ctu-1}, N_{ref} and N_{f}, with the following constraint: L_{cu}>=L_{ctu}>=L_{ctu-1}>=L_{f}. For example L_{cu} can be equal to 16, L_{ctu} can be equal to 8, L_{ctu-1} can be equal to 8 and L_{f} can be equal to 2.
a. The above numbers for each reference type/range are exclusive. For example, when only 1D dictionary with one CTU is allowed, and L_{ctu} is equal to 4 and L_{cu} is equal to 16, a CU with 19 1D dictionary coded strings is considered as legal, if 16 of them are referenced within one CU and the other 3 are referenced outside the CU but within the CTU.
b. Note that one or more reference types/ranges may be merged to form a one new reference type/range. The left CTU and the current CTU can be considered as a same range of “limited CTU” and a new constraint value of L_{1-ctu} may apply, so that maximum number of runs within the “limited CTU” but outside the current CU shall not be larger than L_{1-ctu}.
c. Alternatively or additionally, when a run is predicted from ONLY the above neighboring row, no constraint applies. In other words, such runs are not counted e.g., for the number of runs within the CU (L_{cu}). For example, when L_{cu} is equal to 16 and no other constraints apply, the current CU has 28 runs, wherein 17 of them are from their above neighboring rows and 11 of them are at least predicted from other pixels of the CU, such a CU is considered to be coded as legal and obey the constraints provided here.
d. Alternatively or additionally, when a run is predicted from ONLY the above neighboring row or already coded pixels of the current row, no constraint applies.

The reference area of 1D dictionary coding can be the same as the reference area of Intra BC. In one alternative, the reference area of 1D dictionary coding can be smaller than and within the reference area of Intra BC. In one alternative, the reference area of 1D dictionary coding can include the left CTU and the already coded pixels of the current CTU. Additionally or alternatively, one ore move of the above constraints may apply.

Derivation of the offset of the 1D dictionary coding can be made more flexible when 1D dictionary coding is jointly coded with palette modes.
a. In one alternative, multiple neighboring pixels may be used to create candidate offsets (2D vectors or 1D values). The neighboring palette indices may be used to derive multiple candidate offsets for 1D dictionary string matching.
   i. Such neighboring pixels may include the above neighboring pixel and/or the left neighboring pixel of the current pixel.
   ii. Such neighboring pixels may include the left neighboring pixel and/or the pixels consecutive to the left neighboring pixel.
   iii. Such neighboring pixels may include the above neighboring pixel and/or the pixels consecutive to the above neighboring pixel.
   iv. Such neighboring pixels may include the left neighboring pixels and/or above neighboring pixels.
   v. Such neighboring pixels may include the above neighboring pixel and/or the left neighboring and/or the top-left pixel of the current pixel
b. Alternatively or additionally, previously coded 1D dictionary offsets are used to create the candidate offsets that are used to code a current offset value.
c. Alternatively, in palette mode, more than one previously coded pixel position can be stored for each palette index to form a position list, with advanced management of the list for each palette index. Here, the offset can be derived by indexing to a list of the positions. For example, when constructing a list of each palette index, a mechanism can be used to select whether a pixel position needs to be inserted into the list and which relative positions in the list. In addition a pixel position already in the list can be removed or moved to another places of the list.
   i. Alternatively, a list of pixel positions may be jointly decided by a palette index and another parameter, e.g., run mode (‘Copy from Above’ or ‘Copy from Left’ or others). For example, a list of pixel positions are created based on the same palette index using the same Copy from Left mode. In this example, each list is decided by a combined key ‘Index’-and-‘Run Mode’. As another example, the list may be index by a combination of index and whether there is any ‘escape’ pixel around the index.
   ii. Alternatively, a list of pixel positions may be jointly decided by multiple index and multiple other parameters.
d. Alternatively, other coded palette modes' information, e.g., whether a pixel is “Copy from Left” or “Copy from Above” are used to create default offset values, especially when the search range is limited to a small range, such as the left and current CTUs.
e. Alternatively, one or more of the abovementioned types of candidates as well as other types of candidates may be used together to provide a list of offset predictor candidates. Offset predictor candidates (vectors or values) may be pruned to avoid inserting duplicated candidates. After such a list is created, offset prediction and coding can be done by methods as describe in IDF 144027. That means, at least the offset can be explicitly signaled when no candidate offset is equal to the offset of the current string match. The offset may also be predictively coded using the list as reference.
f. Alternatively, the offset predictor candidates are reset at the beginning of each picture or slice or tile or at the beginning of each CTU line.

When 1D dictionary coding and palette coding are enabled together within one CU, harmonized signaling of palette modes and 1D dictionary mode(s) apply.
a. One syntax element (e.g. a flag) is used to signal whether the current pixel is escape pixel or not. If the current pixel is an escape pixel, the quantized escape pixels are coded in the bitstream; otherwise, one syntax element is used to signal one of the following three modes: Copy from Above, Copy from Left, and 1D dictionary modes.
   i. The 1D dictionary mode can be a fixed 1D matching or 2D matching.
   ii. Alternatively or additionally, there are cases that only two modes are available depending on the pixel location and neighboring pixel modes. For instance, when the left neighboring pixel uses Copy from Above, the current pixel mode can only be Copy from Left and 1D dictionary mode. In this case, a flag is used to indicate these two possible modes.
   iii. Alternatively or additionally, as another example, when the current pixel is in the first row of the current CU, the only possible modes are Copy from Left and 1D dictionary modes. And thus a flag is used to indicate these two modes
b. Alternatively, one syntax element is used to signal the following four modes: Copy from Above, Copy from Left, 1D matching and escape modes. A fixed length codeword or variable length codeword is proposed to be used to signal the mode choice. For example, in the case that there are only three modes, a truncated unary codeword is proposed to further reduce the overhead costs.
c. Alternatively, one syntax element is used to signal the following three cases: normal palette modes, normal 1D dictionary modes, or escape mode. When such a syntax element (with three values) indicates no escape mode, only a 1-bit flag is used to signal a detailed mode. Such a flag predModeFlag being equal to 0/1 indicates “Copy from Left” for palette coding and “1D matching” for 1D dictionary and such a flag being equal to 1/0 indicates “Copy from Above” for palette coding and “2D matching” for 1D dictionary. Note that here the predModeFlag applies to both palette coding and 1D dictionary coding, and thus may share the same context models even though applying to different modes: palette or 1D dictionary. The rationale is that the area coded with “2D matching” for 1D dictionary may have closer characteristics to the area coded with “Copy from Above” and the area coded with “1D matching” for 1D dictionary may have closer characteristics to the area coded with “Copy from Left”.

Examples of syntax for implementing some of the techniques descried above will now be described in more detail. Video encoder 20 represents an example of a video encoder configured to generate the syntax described below, and video decoder 30 represents an example of video decoder configured to parse such syntax

TABLE 4 below shows an example of SPS syntax.

TABLE 4

Descriptor

seq_parameter_set_rbsp( ) {

| | |
|---|---|
| sps_video_parameter_set_id | u(4) |
| sps_max_sub_layers_minus1 | u(3) |
| sps_temporal_id_nesting_flag | u(1) |
| profile_tier_level( sps_max_sub_layers_minus1 ) | |
| sps_seq_parameter_set_id | ue(v) |
| chroma_format_idc | ue(v) |
| if( chroma_format_idc = = 3 ) | |

| | |
|---|---|
| separate_colour_plane_flag | u(1) |

| | |
|---|---|
| pic_width_in_luma_samples | ue(v) |
| pic_height_in_luma_samples | ue(v) |
| conformance_window_flag | u(1) |
| if( conformance_window_flag ) { | |

| | |
|---|---|
| conf_win_left_offset | ue(v) |
| conf_win_right_offset | ue(v) |
| conf_win_top_offset | ue(v) |
| conf_win_bottom_offset | ue(v) |

| | |
|---|---|
| } | |
| bit_depth_luma_minus8 | ue(v) |
| bit_depth_chroma_minus8 | ue(v) |
| log2_max_pic_order_cnt_lsb_minus4 | ue(v) |
| sps_sub_layer_ordering_info_present_flag | u(1) |
| for( i = ( sps_sub_layer_ordering_info_present_flag ? 0 : sps_max_sub_layers_minus1 ); | |

i <= sps_max_sub_layers_minus1; i++ ) {

| | |
|---|---|
| sps_max_dec_pic_buffering_minus1[ i ] | ue(v) |
| sps_max_num_reorder_pics[ i ] | ue(v) |
| sps_max_latency_increase_plus1[ i ] | ue(v) |

| | |
|---|---|
| } | |
| log2_min_luma_coding_block_size_minus3 | ue(v) |
| log2_diff_max_min_luma_coding_block_size | ue(v) |
| log2_min_transform_block_size_minus2 | ue(v) |
| log2_diff_max_min_transform_block_size | ue(v) |
| max_transform_hierarchy_depth_inter | ue(v) |
| max_transform_hierarchy_depth_intra | ue(v) |
| scaling_list_enabled_flag | u(1) |
| if( scaling_list_enabled_flag ) { | |

| | |
|---|---|
| sps_scaling_list_data_present_flag | u(1) |
| if( sps_scaling_list_data_present_flag ) | |

scaling_list_data( )

| | |
|---|---|
| } | |
| amp_enabled_flag | u(1) |
| sample_adaptive_offset_enabled_flag | u(1) |
| pcm_enabled_flag | u(1) |
| if( pcm_enabled_flag ) { | |

| | |
|---|---|
| pcm_sample_bit_depth_luma_minus1 | u(4) |
| pcm_sample_bit_depth_chroma_minus1 | u(4) |
| log2_min_pcm_luma_coding_block_size_minus3 | ue(v) |
| log2_diff_max_min_pcm_luma_coding_block_size | ue(v) |
| pcm_loop_filter_disabled_flag | u(1) |

| | |
|---|---|
| } | |
| num_short_term_ref_pic_sets | ue(v) |
| for( i = 0; i < num_short_term_ref_pic_sets; i++) | |

short_term_ref_pic_set( i )

| | |
|---|---|
| long_term_ref_pics_present_flag | u(1) |
| if( long_term_ref_pics_present_flag ) { | |

| | |
|---|---|
| num_long_term_ref_pics_sps | ue(v) |
| for( i = 0; i < num_long_term_ref_pics_sps; i++ ) { | |

| | |
|---|---|
| lt_ref_pic_poc_lsb_sps[ i ] | u(v) |
| used_by_curr_pic_lt_sps_flag[ i ] | u(1) |

}

| | |
|---|---|
| } | |
| sps_temporal_mvp_enabled_flag | u(1) |
| strong_intra_smoothing_enabled_flag | u(1) |
| vui_parameters_present_flag | u(1) |
| if( vui_parameters_present_flag ) | |

vui_parameters( )

| | |
|---|---|
| sps_extension_present_flag | u(1) |
| if( sps_extension_present_flag ) { | |

for( i = 0; i < 1; i++)

| | |
|---|---|
| sps_extension_flag[ i ] | u(1) |

| | |
|---|---|
| sps_extension_7bits | u(7) |
| if( sps_extension_flag[ 0 ] ) { | |

| | |
|---|---|
| transform_skip_rotation_enabled_flag | u(1) |
| transform_skip_context_enabled_flag | u(1) |
| intra_block_copy_enabled_flag | u(1) |
| implicit_rdpcm_enabled_flag | u(1) |
| explicit_rdpcm_enabled_flag | u(1) |
| extended_precision_processing_flag | u(1) |
| intra_smoothing_disabled_flag | u(1) |
| high_precision_offsets_enabled_flag | u(1) |
| fast_rice_adaptation_enabled_flag | u(1) |
| cabac_bypass_alignment_enabled_flag | u(1) |
| dictionary_{—}1d_{—}enable_{—}flag | u(1) |

}
if( sps_extension_7bits )

| | |
|---|---|
| while( more_rbsp_data( ) ) | |
| sps_extension_data_flag | u(1) |

}
rbsp_trailing_bits( )

}

TABLE 5 below shows an example of coding unit syntax.

TABLE 5

Descriptor

coding_unit( x0, y0, log2CbSize ) {

if( dictionary_{—}1d_{—}enable_{—}flag )

| | |
|---|---|
| dictionary_{—}coded_{—}flag | av(v) |

if( dictionary_{—}coded_{—}flag ){

dictonary_{—}syntax_{—}table( )
}

else{

if( transquant_bypass_enabled_flag )

| | |
|---|---|
| cu_transquant_bypass_flag | ae(v) |

if( slice_type != I )

| | |
|---|---|
| cu_skip_flag[ x0 ][ y0 ] | ae(v) |

nCbS = ( 1 << log2CbSize )
if( cu_skip_flag[ x0 ][ y0 ])

prediction_unit( x0, y0, nCbS, nCbS )

else {

if( intra_block_copy_enabled_flag )

| | |
|---|---|
| intra_bc_flag[ x0 ][ y0 ] | ae(v) |

if( slice_type != I && !intra_bc_flag[ x0 ][ y0 ] )

| | |
|---|---|
| pred_mode_flag | ae(v) |

if( CuPredMode[ x0 ][ y0 ] != MODE_INTRA ∥ intra_bc_flag[ x0 ][ y0 ] ∥
log2CbSize = = MinCbLog2SizeY )

| | |
|---|---|
| part_mode | ae(v) |

if( CuPredMode[ x0 ][ y0 ] = = MODE_INTRA ) {

if(PartMode = = PART_2Nx2N && pcm_enabled_flag &&

| | |
|---|---|
| !intra_bc_flag[ x0 ][ y0 ] && | |
| log2CbSize >= Log2MinIpcmCbSizeY && | |
| log2CbSize <= Log2MaxIpcmCbSizeY ) | |
| pcm_flag[ x0 ][ y0 ] | ae(v) |

if( pcm_flag[ x0 ][ y0 ] ) {

while ( !byte_aligned( ) )

| | |
|---|---|
| pcm_alignment_zero_bit | f(1) |

pcm_sample( x0, y0, log2CbSize )

} else if( intra_bc_flag[ x0 ][ y0 ] ) {

mvd_coding( x0, y0, 2)
if( PartMode = = PART_2NxN )

mvd_coding( x0, y0 + ( nCbS / 2 ), 2)

else if( PartMode = = PART_Nx2N )

mvd_coding( x0 + ( nCbS / 2 ), y0, 2)

else if( PartMode = = PART_NxN ) {

mvd_coding( x0 + ( nCbS / 2 ), y0, 2)
mvd_coding( x0, y0 + ( nCbS / 2 ), 2)
mvd_coding( x0 + ( nCbS / 2 ), y0 + ( nCbS / 2 ), 2)

}

} else {

pbOffset = ( PartMode = = PART_NxN ) ? ( nCbS / 2 ) : nCbS
for( j = 0; j < nCbS; j = j + pbOffset )

for( i = 0; i < nCbS; i = i + pbOffset )

| | |
|---|---|
| prev_intra_luma_pred_flag[ x0 + i ][ y0 + j ] | ae(v) |

for( j = 0; j < nCbS; j = j + pbOffset )

for( i = 0; i < nCbS; i = i + pbOffset )

if( prev_intra_luma_pred_flag[ x0 + i ][ y0 + j ] )

| | |
|---|---|
| mpm_idx[ x0 + i ][ y0 + j ] | ae(v) |

Else

| | |
|---|---|
| rem_intra_luma_pred_mode[ x0 + i ][ y0 + j ] | ae(v) |

if( ChromaArrayType = = 3 )

for( j = 0; j < nCbS; j = j + pbOffset )

for( i = 0; i < nCbS; i = i + pbOffset )

| | |
|---|---|
| intra_chroma_pred_mode[ x0 + i ][ y0 + j ] | ae(v) |

else if( ChromaArrayType != 0 )

| | |
|---|---|
| intra_chroma_pred_mode[ x0 ][ y0 ] | ae(v) |

}

} else {

if( PartMode = = PART_2Nx2N )

prediction_unit( x0, y0, nCbS, nCbS )

else if( PartMode = = PART_2NxN ) {

prediction_unit( x0, y0, nCbS, nCbS / 2 )
prediction_unit( x0, y0 + ( nCbS / 2 ), nCbS, nCbS / 2 )

} else if( PartMode = = PART_Nx2N ) {

prediction_unit( x0, y0, nCbS / 2, nCbS )
prediction_unit( x0 + ( nCbS / 2 ), y0, nCbS / 2, nCbS )

} else if( PartMode = = PART_2NxnU ) {

prediction_unit( x0, y0, nCbS, nCbS / 4 )
prediction_unit( x0, y0 + ( nCbS / 4 ), nCbS, nCbS * 3 / 4 )

} else if( PartMode = = PART_2NxnD ) {

prediction_unit( x0, y0, nCbS, nCbS * 3 / 4 )
prediction_unit( x0, y0 + ( nCbS * 3 / 4 ), nCbS, nCbS / 4 )

} else if( PartMode = = PART_nLx2N ) {

prediction_unit( x0, y0, nCbS / 4, nCbS )
prediction_unit( x0 + ( nCbS / 4 ), y0, nCbS * 3 / 4, nCbS )

} else if( PartMode = = PART_nRx2N ) {

prediction_unit( x0, y0, nCbS * 3 / 4, nCbS )
prediction_unit( x0 + ( nCbS * 3 / 4 ), y0, nCbS / 4, nCbS )

} else { /* PART_NxN */

prediction_unit( x0, y0, nCbS / 2, nCbS / 2 )
prediction_unit( x0 + ( nCbS / 2 ), y0, nCbS / 2, nCbS / 2 )
prediction_unit( x0, y0 + ( nCbS / 2 ), nCbS / 2, nCbS / 2 )
prediction_unit( x0 + ( nCbS / 2 ), y0 + ( nCbS / 2 ), nCbS / 2, nCbS / 2 )

}

}
if(!pcm_flag[ x0 ][ y0 ] ) {

if( CuPredMode[ x0 ][ y0 ] != MODE_INTRA &&

| | |
|---|---|
| !( PartMode = = PART_2Nx2N && merge_flag[ x0 ][ y0 ] ) ∥ | |
| ( CuPredMode[ x0 ][ y0 ] = = MODE_INTRA && intra_bc_flag[ x0 ][ y0 ] ) ) | |
| rqt_root_cbf | ae(v) |

if( rqt_root_cbf ) {

MaxTrafoDepth = ( CuPredMode[ x0 ][ y0 ] = = MODE_INTRA ?

( max_transform_hierarchy_depth_intra +

IntraSplitFlag ) :

max_transform_hierarchy_depth_inter )

transform_tree( x0, y0, x0, y0, log2CbSize, 0, 0 )

}

}

}

}

}

Alternatively, the dictionary_coded_flag can be introduced in other places, e.g., after the cu_skip_flag, to potentially provide a bit higher efficient e.g., in case skip mode is statistically more frequently chosen than the 1D dictionary mode. An example of this alternative syntax is shown below in TABLE 6.

TABLE 6

Descriptor

coding_unit( x0, y0, log2CbSize ) {

if( transquant_bypass_enabled_flag )

| | |
|---|---|
| cu_transquant_bypass_flag | ae(v) |

if( slice_type != I )

| | |
|---|---|
| cu_skip_flag[ x0 ][ y0 ] | ae(v) |

nCbS = ( 1 << log2CbSize )
if( cu_skip_flag[ x0 ][ y0 ] )

prediction_unit( x0, y0, nCbS, nCbS )

else {

if( dictionary_{—}1d_{—}enable_{—}flag )

| | |
|---|---|
| dictionary_{—}coded_{—}flag | av(v) |

if( dictionary_{—}coded_{—}flag){

dictonary_{—}syntax_{—}table( )

}
else{

if( intra_block_copy_enabled_flag )

| | |
|---|---|
| intra_bc_flag[ x0 ][ y0 ] | ae(v) |

if( slice type != I && !intra_bc_flag[ x0 ][ y0 ] )

| | |
|---|---|
| pred_mode_flag | ae(v) |

if( CuPredMode[ x0 ][ y0 ] != MODE_INTRA ∥ intra_bc_flag[ x0 ][ y0 ] ∥

| | |
|---|---|
| log2CbSize = = MinCbLog2SizeY ) | |
| part_mode | ae(v) |

if( CuPredMode[ x0 ][ y0 ] = = MODE_INTRA ) {

if( PartMode = = PART_2Nx2N && pcm_enabled_flag &&

| | |
|---|---|
| !intra_bc_flag[ x0 ][ y0 ] && | |
| log2CbSize >= Log2MinIpcmCbSizeY && | |
| log2CbSize <= Log2MaxIpcmCbSizeY ) | |
| pcm_flag[ x0 ][ y0 ] | ae(v) |

if( pcm_flag[ x0 ][ y0 ] ) {

while ( !byte_aligned( ) )

| | |
|---|---|
| pcm_alignment_zero_bit | f(1) |

pcm_sample( x0, y0, log2CbSize )

} else if( intra_bc_flag[ x0 ][ y0 ] ) {

mvd_coding( x0, y0, 2)

if( PartMode = = PART_2NxN)

mvd_coding( x0, y0 + ( nCbS / 2 ), 2)

else if( PartMode = = PART_Nx2N )

mvd_coding( x0 + ( nCbS / 2 ), y0, 2)

else if( PartMode = = PART_NxN ) {

mvd_coding( x0 + ( nCbS / 2 ), y0, 2)
mvd_coding( x0, y0 + ( nCbS / 2 ), 2)
mvd_coding( x0 + ( nCbS / 2 ), y0 + ( nCbS / 2 ), 2)

}

} else {

pbOffset = ( PartMode = = PART_NxN ) ? ( nCbS / 2 ) : nCbS
for( j = 0; j < nCbS; j = j + pbOffset )

for( i = 0; i < nCbS; i = i + pbOffset )

| | |
|---|---|
| prev_intra_luma_pred_flag[ x0 + i ][ y0 + j ] | ae(v) |

for( j = 0; j < nCbS; j = j + pbOffset )

for( i = 0; i < nCbS; i = i + pbOffset )

if( prev_intra_luma_pred_flag[ x0 + i ][ y0 + j ] )

| | |
|---|---|
| mpm_idx[ x0 + i ][ y0 + j ] | ae(v) |

else

| | |
|---|---|
| rem_intra_luma_pred_mode[ x0 + i ][ y0 + j ] | ae(v) |

if( ChromaArrayType = = 3 )

for( j = 0; j < nCbS; j = j + pbOffset )

for( i = 0; i < nCbS; i = i + pbOffset )

| | |
|---|---|
| intra_chroma_pred_mode[ x0 + i ][ y0 + j ] | ae(v) |

else if( ChromaArrayType != 0 )

| | |
|---|---|
| intra_chroma_pred_mode[ x0 ][ y0 ] | ae(v) |

}

} else {

if( PartMode = = PART_2Nx2N )

prediction_unit( x0, y0, nCbS, nCbS )

else if( PartMode = = PART_2NxN ) {

prediction_unit( x0, y0, nCbS, nCbS / 2 )
prediction_unit( x0, y0 + ( nCbS / 2 ), nCbS, nCbS / 2 )

} else if( PartMode = = PART_Nx2N ) {

prediction_unit( x0, y0, nCbS / 2, nCbS )
prediction_unit( x0 + ( nCbS / 2 ), y0, nCbS / 2, nCbS )

} else if( PartMode = = PART_2NxnU ) {

prediction_unit( x0, y0, nCbS, nCbS / 4 )
prediction_unit( x0, y0 + ( nCbS / 4 ), nCbS, nCbS * 3 / 4 )

} else if( PartMode = = PART_2NxnD ) {

prediction_unit( x0, y0, nCbS, nCbS * 3 / 4 )
prediction_unit( x0, y0 + ( nCbS * 3 / 4 ), nCbS, nCbS / 4 )

} else if( PartMode = = PART_nLx2N ) {

prediction_unit( x0, y0, nCbS / 4, nCbS )
prediction_unit( x0 + ( nCbS / 4 ), y0, nCbS * 3 / 4, nCbS )

} else if( PartMode = = PART_nRx2N ) {

prediction_unit( x0, y0, nCbS * 3 / 4, nCbS )
prediction_unit( x0 + ( nCbS * 3 / 4 ), y0, nCbS / 4, nCbS )

} else { /* PART_NxN */

prediction_unit( x0, y0, nCbS / 2, nCbS / 2 )
prediction_unit( x0 + ( nCbS / 2 ), y0, nCbS / 2, nCbS / 2 )
prediction_unit( x0, y0 + ( nCbS / 2 ), nCbS / 2, nCbS / 2 )
prediction_unit( x0 + ( nCbS / 2 ), y0 + ( nCbS / 2 ), nCbS / 2, nCbS / 2 )

}

}
if( !pcm_flag[ x0 ][ y0 ] ) {

if( CuPredMode[ x0 ][ y0 ] != MODE_INTRA &&

| | |
|---|---|
| !( PartMode = = PART_2Nx2N && merge_flag[ x0 ][ y0 ] ) ∥ | |
| ( CuPredMode[ x0 ][ y0 ] = = MODE_INTRA && intra_bc_flag[ x0 ][ y0 ] ) ) | |
| rqt_root_cbf | ae(v) |

if( rqt_root_cbf ) {

MaxTrafoDepth = ( CuPredMode[ x0 ][ y0 ] = = MODE_INTRA ?

( max_transform_hierarchy_depth_intra + IntraSplitFlag ) :
max_transform_hierarchy_depth_inter )

transform_tree( x0, y0, x0, y0, log2CbSize, 0, 0 )

}

}

}

}

}

The semantics introduced above will now be described in more detail. In the SPS semantics, the syntax element “dictionary_{—}1d_enable_flag” equal to 1 specifies that dictionary coding may be invoked for coding units of the coded video sequence. “dictionary_{—}1d_enable_flag” equal to 0 specifies that dictionary coding is not invoked for any coding units of the coded video sequence. When not present, the value of dictionary_{—}1d_enable_flag is inferred to be equal to 0. Alternatively, such a flag is put in picture parameter set. Alternatively, an additional flag controlling 1D dictionary coding is put in picture parameter set when dictionary_{—}1d_enable_flag is equal to 1. Alternatively, a slice level flag may be introduced to disable or enable 1D dictionary coding. Alternatively, dictionary_{—}1d_enable_flag is equal to 1 only when lossless coding is enforced for the coded video sequence. In one example, when transquant_bypass_enabled_flag is equal to 0 for any coding unit, dictionary_{—}1d_enable_flag shall be set equal to 0.

In the coding unit semantics, the syntax element, “dictionary_coded_flag” equal to 1 specifies that dictionary coding is used for the coding unit and all the any other syntax element for the current coding is not present. “dictionary_coded_flag” equal to 0 specifies that dictionary coding is not used for the coding unit. When not present, the value of dictionary_coded_flag is inferred to be equal to 0.

In one alternative, dictionary_coded_flag is only equal to 1 when the coding unit size is the same as the coding tree block size. That is: dictionary_coded_flag shall be equal to 0 when CtbLog 2SizeY is larger than log 2CbSize.

In another alternative, however, dictionary_coded_flag is present only if coding unit size is the same as the coding tree block size, as illustrated below in TABLE 7.

TABLE 7

Descriptor

coding_unit( x0, y0, log2CbSize ) {

if( dictionary_{—}1d_{—}enable_{—}flag && log2CbSize = =
CtbLog2SizeY)

| | |
|---|---|
| dictionary_{—}coded_{—}flag | av(v) |

if( dictionary_{—}coded_{—}flag )

dictionary_{—}syntax_{—}table( )

else {
...
}

}

In the coding tree unit semantics the syntax element “dictionary_coded_flag” may alternatively be applied at largest coding unit as shown below in TABLE 8.

TABLE 8

Descriptor

coding_tree_unit( ) {

xCtb = ( CtbAddrInRs % PicWidthInCtbsY ) <<
CtbLog2SizeY
yCtb = ( CtbAddrInRs / PicWidthInCtbsY ) <<
CtbLog2SizeY
if( slice_sao_luma_flag ∥ slice_sao_chroma_flag )

sao( xCtb >> CtbLog2SizeY, yCtb >>
CtbLog2SizeY )

if( dictionary_{—}1d_{—}enable_{—}flag )

| | |
|---|---|
| dictionary_coded_flag | ae(v) |

if( dictionary_{—}coded_{—}flag ){

dictionary_{—}syntax( )

} else {

coding_quadtree( xCtb, yCtb, CtbLog2SizeY, 0 )

}

}

Pixel processing of the minimum unit of the 1D dictionary will now be described. The matching criterion may be applied to pixels with three samples (components) concurrently. For example, in lossless match, three samples from one pixel may be compared with those from the reference pixel respectively. If all three of the samples of the current pixel are equal to those from the reference pixel respectively, then the current pixel is equal to the reference pixel, and thus, the matching string run is increased by one. Otherwise, the current pixel does not have a reference pixel, and the three samples of the current pixel is entropy coded with fixed length codeword.

Alternatively in lossy match, a certain error may be allowed when comparing the samples of the current pixel and those of the reference pixel. When all of the three samples of the current pixel are within a certain error threshold compared with the three samples of the reference pixel, the current pixel may be regarded as matching with the reference pixel, and thus the matching string run is increased by one accordingly. Otherwise, the current pixel does not have a reference pixel, and the three samples of the current pixel is entropy coded with fixed length codeword.

FIG. 7 shows an example of pixel matching in 1D dictionary. In the example of FIG. 7, the current pixel is P6 (starting with S18) and the string offset is 4, indicating P2 (starting with S6) is the reference pixel. In this figure, the run is 4, indicating 4 full pixels will be derived using the reference pixels in this string match. Note that in this case, the values used to signal the offset and run are smaller (reduced roughly by a factor of 3) compared to the example as shown in FIG. 5.

TABLE 9 below shows an example of 1D dictionary block table syntax.

TABLE 9
dictionary_syntax_table( ) {

for( decPixelCnt=0; decPixelCnt < (1<<(2* log2CbSize); ) {

| | |
|---|---|
| matching_string_flag | ae(v) |
| if(matching_string_flag = = 1) { | |

| | |
|---|---|
| matching_string_offset_use_recent_8_flag | ae(v) |
| if(matching_string_distance_use_recent_8_flag) | |

| | |
|---|---|
| matching_string_offset_recent_8_idx | ae(v) |

else

| | |
|---|---|
| matching_string_offset_minus1 | ae(v) |

| | |
|---|---|
| matching_string_length_minus1 | ae(v) |
| decPixelCnt += | |
| (matching_string_length_minus1 + 1) | |

}
else {

| | |
|---|---|
| unmatchable_sample_value_component0 | ae(v) |
| unmatchable_sample_value_component1 | ae(v) |
| unmatchable_sample_value_component2 | ae(v) |
| decPixelCnt ++ | |

}

}

}

The 1D dictionary block table semantics of TABLE 9 are as follows:
matching_string_flag equal to 1 indicates that the current pixel starts a matching string. matching_string_flag equal to 0 indicates the current does not start a matching string and its values are explicitly present.
matching_string_offset_use_recent_{—}8_flag equal to 1 indicates the current matching string offset is equal to one of the eight previously decoded matching string offsets and the string offset is specified by matching_string_offset_recent_{—}8_idx. matching_string_offset_use_recent_{—}8_flag equal to 0 indicates the current matching string offset is explicitly present by syntax matching_string_offset_minus1.
matching_string_offset_recent_{—}8_idx specifies the index to the eight previously coded matching string offsets. When not present, the value of matching_string_offset_recent_{—}8_idx is inferred to be equal to 0. matching_string_offset_minus1 plus 1 specifies the matching string offset between the current string and the reference string. When not present, the value of matching_string_offset_minus1 is inferred to be equal to 0.
matching_string_length_minus1 plus 1 specifies the matching string run (the number of pixels that the current string match the reference string). When not present, the value of matching_string_length_minus1 is inferred to be equal to 0.
unmatchable_sample_value_component0 is specifies the value of the 0-th sample of the current pixel.
unmatchable_sample_value_component1 is equal to pixel value of the 1-th sample the current pixel.
unmatchable_sample_value_component2 is equal to pixel value of 2-th sample of the current pixel.

Entropy coding of the major 1D dictionary syntax elements will now be discussed in more detail. If the current block uses 1D dictionary mode, the following syntax may be applied.
a. If the current pixel does not find a matching reference pixel, a matching flag is set to 0 to indicate no matching for the current pixel, called escape pixel and the three samples of the escape pixel is coded using fixed length codeword.
   1. If the input sample is of 8 bit precision, the codeword length for each sample is 8 bits.
   2. Alternatively, a quantization with quantization step QStep can be applied to escape pixels, and the quantized escape pixel samples are coded using fixed length codeword. And the quantized samples is within the range of [0, Ceil(2̂8/QStep)]. And k bit fixed length codeword is used to represent the quantized value, where 2̂k is equal or larger than Ceil(2̂8/QStep).
b. If the current pixel has a matching reference pixel, the matching flag is set to 1. And the following two syntaxes are coded in the bitstream.
1. The relative position between the current pixel and the reference pixel, namely matching string offset, is predictive coded using recently coded 8 offsets. And the follow procedure is applied
   i. If the current offset is equal to one the previously coded 8 offsets, the offset prediction flag is set to 1, and 3 bit fixed length codeword is used to indicate the index in the 8 offsets.
   ii. Otherwise, the current offset is not equal to any of the previously coded 8 offsets, the offset prediction flag is set to 0, and the following procedure is applied to code the offset.
      1. The offset codeword is composed of a prefix and a suffix.
      2. The offset is first converted to a number posSlot

```
  if (pos < 128)
  posSlot = m_pbFastPos[pos];
  else {
  i = 6 + ((kNumLogBits − 1) & (0 − ((((1 << (kNumLogBits + 6)) −
1) − pos) >> 31)));
  posSlot = m_pbFastPos[pos >> i] + (i * 2);
      }
```

And mpbFastPos is calculated as

```
c = 2;
kNumLogBits = 11;
m_pbFastPos[0] = 0;
m_pbFastPos[1] = 1;
for (slotFast = 2; slotFast < kNumLogBits*2; slotFast++){
    k = (1 << ((slotFast >> 1) − 1));
    for (j = 0; j < k; j++, c++)
    m_pbFastPos[c] = (UChar)slotFast;
}
```

3. A maximum posSlotMax may be calculated using the last position within the current CU.
4. Given posSlot and posSloetMax, a truncated binary code is used to code offset value.
5. The suffix is composed of fixed length codeword. And the suffix value posReduced and the number of bits footerBits are calculated as follows

```
if (posSlot >= 4){
    footerBits = ((posSlot >> 1) − 1);
    base = ((2 | (posSlot & 1)) << footerBits);
    posReduced = offset − base;
    }
```

2. Alternatively, the codeword of predictor index may be fixed length code or unary code, or truncated unary code. The codeword of offset or offset prediction error may be Golomb rice code, exponential Golomb code, combination of Golomb and exponential Golomb code word.
3. The matching string run of the 1D string is coded using Golomb-rice codeword with rice parameter equal to 4. Alternatively, the syntax run can be coded using exponential Golomb code, combination of Golomb and exponential Golomb code word. Alternatively, the syntax run can be predicted coded using recently coded runs with a run prediction flag and index coded if the current run is equal to one of the recently coded runs, or with a run prediction flag and run value coded using Golomb-rice codeword. All bins of the codeword can be context coded. Alternatively, only one to N (with N equal to 1, 2, 3, 4, 5, etc.) bins of the codeword are context coded and the remaining bins, if any, are bypass coded.

If the current block is coded using 1D dictionary but operates in a 2D matching mode, such as shown in 6A, 6B and/or 6C, a motion vector and a matching string length are coded for each matching string. In one or more examples, 2D matching mode may refer to the same thing as 2D reference mode at least with respect to FIGS. 6A-6C, described herein. However, from the specific context in the disclosure, it may not be necessary for 2D matching mode to necessarily always refer to the same thing as 2D reference mode. 2D matching mode referring to the same thing as 2D reference mode is provided merely as an example to assist with understanding, and should not be considered a required limitation.

The relative position between the starting pixel of the current string and the reference pixel can be represented by a 2D motion vector (mvX, mvY). The motion vector can be predicted using previously coded different motion vectors within/cross the CU. Alternatively, the motion vector can be coded explicitly. The motion vector can be coded explicitly using “greater than 0” flag, “greater than 1” flag, and Golomb family codeword (for example, EG5). The “greater than 0” flag and “greater than 1” flags may be context coded. Alternatively, the coding may depends on the motion vector component. As one example, for an X-component, the “greater than 0” flag may be coded using a bypass code bin. Otherwise, for the y-component, the “greater than 0” flag may be coded using a context coded bin. Similar dependencies may also be applied to “greater than 1” flags.

The motion vector can be predicted using previously coded different motion vectors. More specifically, a list of motion vector predictor candidates may be initialized with certain default values for each CU. Note that the list of motion vectors can also be initialized at different levels, such picture, slice, CTU as well. If the current motion vector is the same as one of the motion vector predictors, a motion_vector_predictor flag is signaled in the bitstream to indicate a motion vector predictor is used, followed by an index to signal the corresponding index from the candidate list. The index can be binarized using fixed length codeword, or truncated unary codeword. As an example, two motion vector predictors are used for each CU, and initialized as (0, 1) and (1, 0). A one bit flag may be used to signal which predictor the CU uses. Otherwise, the current motion vector can be coded explicitly using the binarization described above. Alternatively, the current motion vector can be predicted using one of the predictors, and then, an index and motion vector difference may be coded in the bitstream. The index and motion vector difference can use the binarization methods described above.

The motion vector predictors may or may not be updated. If the updating mechanism is not applied, the motion vector predictors are fixed. If the updating mechanism is applied, the updating mechanism only updates when the current motion vector is not equal to any of the existing motion vectors and the current motion vector is arranged in the first place of the list. Correspondingly, one motion vector predictor is removed from the list. If the current motion vector is equal to one of the motion vector predictors, the current motion vector and the motion vector in the first place of the list are swapped. The updating mechanism can be applied in CU level, CTU level, or slice, or picture level as well. And the updating mechanism can be signaled in an slice level, PPS, SPS level.

The matching string length can be coded using a Golomb family codeword, or combination of flag and Golomb family codeword, or a concatenation of Golomb family codeword, or any combinations of these. For instance, a combination of “greater than 0” flag and Exponential Golomb code with parameter 0 (EG0) can be used to code matching_string_length_minus1. The following is an example of the binarization of matching_string_length_minus1.

TABLE 10 below shows the binarization of matching_string_length_minus1: greater than 0 flag and EG0

TABLE 10

| Symbol | Greater than 0 flag | Prefix of EG0 | Suffix of EG0 |
|---|---|---|---|
| 0 | 0 | — | — |
| 1 | 1 | 0 | — |
| 2 | 1 | 10 | 0 |
| 3 | 1 | 10 | 1 |
| 4 | 1 | 110 | 00 |
| 5 | 1 | 110 | 01 |

Alternatively, a combination of greater than 0 flag and other Exponential Golomb code can also be used to code matching_string_length_minus1. For example, a combination of greater than 0 flag and EG1 can be used to code matching_string_length_minus1.

The bins of the binarization can be all bypass coded to increase the CABAC entropy throughput. Alternatively, several bins can be context coded to increase the coding performance. For example, greater than 0 flag is context coded, and several bins from prefix of EG are also context coded. To reduce the number of contexts, it is proposed to constrain the total number of context coded bins, for example, 1 context coded bin for “greater than 0” flag, and up to 4 context coded bins for prefix of EG codeword, and some of the bins can share the same context. For instance, g_ucDictLen[5]={0, 1, 2, 3, 3} can be used to signify the context assignment for each context coded bin, “greater than 0” flag uses context 0; first bin (if available) in Prefix of EG uses context 1; second bin (if available) uses context 2; third bin (if available) and fourth bin (if available) share the same context 3. Alternatively, g_ucDictLen[5]={0, 1, 1, 2, 2} can be applied for context assignment. Note that the context assignment can be designed in other ways where several bins can share the same context, and up to K different contexts if the number of context coded bin are K, where K=1, 2, 3, 4, 5, . . . .

Aspects of implementing some of the techniques described in this disclosure will now be discussed in more detail. One example of the proposed 1D dictionary coding scheme is provided below. This example includes mainly a decoder design described with working draft text based on the HEVC-Rext, JCTVC-P1005.

Syntax changes within the existing syntax table are shown in italics. In particular, the use of italics to show syntax changes is used in the description above and the description below.

TABLE 11 below shows an example of Sequence Parameter Set (SPS) Syntax.

TABLE 11

Descriptor

seq_parameter_set_rbsp( ) {

| | |
|---|---|
| sps_video_parameter_set_id | u(4) |
| sps_max_sub_layers_minus1 | u(3) |
| sps_temporal_id_nesting_flag | u(1) |
| profile_tier_level( sps_max_sub_layers_minus1 ) | |
| sps_seq_parameter_set_id | ue(v) |
| chroma_format_idc | ue(v) |
| if( chroma_format_idc = = 3 ) | |

| | |
|---|---|
| separate_colour_plane_flag | u(1) |

| | |
|---|---|
| pic_width_in_luma_samples | ue(v) |
| pic_height_in_luma_samples | ue(v) |
| conformance_window_flag | u(1) |
| if( conformance_window_flag ) { | |

| | |
|---|---|
| conf_win_left_offset | ue(v) |
| conf_win_right_offset | ue(v) |
| conf_win_top_offset | ue(v) |
| conf_win_bottom_offset | ue(v) |

| | |
|---|---|
| } | |
| bit_depth_luma_minus8 | ue(v) |
| bit_depth_chroma_minus8 | ue(v) |
| log2_max_pic_order_cnt_lsb_minus4 | ue(v) |
| sps_sub_layer_ordering_info_present_flag | u(1) |
| for( i = ( sps_sub_layer_ordering_info_present_flag ? 0 : sps_max_sub_layers_minus1 ); | |

i <= sps_max_sub_layers_minus1; i++ ) {

| | |
|---|---|
| sps_max_dec_pic_buffering_minus1[ i ] | ue(v) |
| sps_max_num_reorder_pics[ i ] | ue(v) |
| sps_max_latency_increase_plus1[ i ] | ue(v) |

| | |
|---|---|
| } | |
| log2_min_luma_coding_block_size_minus3 | ue(v) |
| log2_diff_max_min_luma_coding_block_size | ue(v) |
| log2_min_transform_block_size_minus2 | ue(v) |
| log2_diff_max_min_transform_block_size | ue(v) |
| max_transform_hierarchy_depth_inter | ue(v) |
| max_transform_hierarchy_depth_intra | ue(v) |
| scaling_list_enabled_flag | u(1) |
| if( scaling_list_enabled_flag ) { | |

| | |
|---|---|
| sps_scaling_list_data_present_flag | u(1) |
| if( sps_scaling_list_data_present_flag ) | |

scaling_list_data( )

| | |
|---|---|
| } | |
| amp_enabled_flag | u(1) |
| sample_adaptive_offset_enabled_flag | u(1) |
| pcm_enabled_flag | u(1) |
| if( pcm_enabled_flag ) { | |

| | |
|---|---|
| pcm_sample_bit_depth_luma_minus1 | u(4) |
| pcm_sample_bit_depth_chroma_minus1 | u(4) |
| log2_min_pcm_luma_coding_block_size_minus3 | ue(v) |
| log2_diff_max_min_pcm_luma_coding_block_size | ue(v) |
| pcm_loop_filter_disabled_flag | u(1) |

| | |
|---|---|
| } | |
| num_short_term_ref_pic_sets | ue(v) |
| for( i = 0; i < num_short_term_ref_pic_sets; i++) | |

short_term_ref_pic_set( i )

| | |
|---|---|
| long_term_ref_pics_present_flag | u(1) |
| if( long_term_ref_pics_present_flag ) { | |

| | |
|---|---|
| num_long_term_ref_pics_sps | ue(v) |
| for( i = 0; i < num_long_term_ref_pics_sps; i++ ) { | |

| | |
|---|---|
| lt_ref_pic_poc_lsb_sps[ i ] | u(v) |
| used_by_curr_pic_lt_sps_flag[ i ] | u(1) |

}

| | |
|---|---|
| } | |
| sps_temporal_mvp_enabled_flag | u(1) |
| strong_intra_smoothing_enabled_flag | u(1) |
| vui_parameters_present_flag | u(1) |
| if( vui_parameters_present_flag ) | |

vui_parameters( )

| | |
|---|---|
| sps_extension_present_flag | u(1) |
| if( sps_extension_present_flag ) { | |

for( i = 0; i < 1; i++ )

| | |
|---|---|
| sps_extension_flag[ i ] | u(1) |

| | |
|---|---|
| sps_extension_7bits | u(7) |
| if( sps_extension_flag[ 0 ] ) { | |

| | |
|---|---|
| transform_skip_rotation_enabled_flag | u(1) |
| transform_skip_context_enabled_flag | u(1) |
| intra_block_copy_enabled_flag | u(1) |
| implicit_rdpcm_enabled_flag | u(1) |
| explicit_rdpcm_enabled_flag | u(1) |
| extended_precision_processing_flag | u(1) |
| intra_smoothing_disabled_flag | u(1) |
| high_precision_offsets_enabled_flag | u(1) |
| fast_rice_adaptation_enabled_flag | u(1) |
| cabac_bypass_alignment_enabled_flag | u(1) |
| dictionary_{—}1d_{—}enable_{—}flag | u(1) |

}
if( sps_extension_7bits )

while( more_rbsp_data( ) )

| | |
|---|---|
| sps_extension_data_flag | u(1) |

}
rbsp_trailing_bits( )

}

TABLE 12 below shows an example of coding unit (CU) syntax.

TABLE 12

Descriptor

coding_unit( x0, y0, log2CbSize ) {

if ( dictionary_{—}1d_{—}enable_{—}flag)

| | |
|---|---|
| dictionary_{—}coded_{—}flag | av(v) |

if( dictionary_{—}coded_{—}flag ) {

dictonary_{—}syntax_{—}table( )
}

else{

if( transquant_bypass_enabled_flag )

| | |
|---|---|
| cu_transquant_bypass_flag | ae(v) |

if( slice_type != I )

| | |
|---|---|
| cu_skip_flag[ x0 ][ y0 ] | ae(v) |

nCbS = ( 1 << log2CbSize )
if( cu_skip_flag[ x0 ][ y0 ] )

prediction_unit( x0, y0, nCbS, nCbS )

else {

if( intra_block_copy_enabled_flag )

| | |
|---|---|
| intra_bc_flag[ x0 ][ y0 ] | ae(v) |

if( slice_type != I && !intra_bc_flag[ x0 ][ y0 ] )

| | |
|---|---|
| pred_mode_flag | ae(v) |

if( CuPredMode[ x0 ][ y0 ] != MODE_INTRA ∥ intra_bc_flag[ x0 ][ y0 ] ∥
log2CbSize = = MinCbLog2SizeY )

| | |
|---|---|
| part_mode | ae(v) |

if( CuPredMode[ x0 ][ y0 ] = = MODE_INTRA ) {

if(PartMode = = PART_2Nx2N && pcm_enabled_flag &&

| | |
|---|---|
| !intra_bc_flag[ x0 ][ y0 ] && | |
| log2CbSize >= Log2MinIpcmCbSizeY && | |
| log2CbSize <= Log2MaxIpcmCbSizeY ) | |
| pcm_flag[ x0 ][ y0 ] | ae(v) |

if( pcm_flag[ x0 ][ y0 ] ) {

while( !byte_aligned( ) )

| | |
|---|---|
| pcm_alignment_zero_bit | f(1) |

pcm_sample( x0, y0, log2CbSize )

} else if( intra_bc_flag[ x0 ][ y0 ] ) {

mvd_coding( x0, y0, 2)
if( PartMode = = PART_2NxN )

mvd_coding( x0, y0 + ( nCbS / 2 ), 2)

else if( PartMode = = PART_Nx2N )

mvd_coding( x0 + ( nCbS / 2 ), y0, 2)

else if( PartMode = = PART_NxN ) {

mvd_coding( x0 + ( nCbS / 2 ), y0, 2)
mvd_coding( x0, y0 + ( nCbS / 2 ), 2)
mvd_coding( x0 + ( nCbS / 2 ), y0 + ( nCbS / 2 ), 2)

}

} else {

pbOffset = ( PartMode = = PART_NxN ) ? ( nCbS / 2 ) : nCbS
for( j = 0; j < nCbS; j = j + pbOffset )

for( i = 0; i < nCbS; i = i + pbOffset )

| | |
|---|---|
| prev_intra_luma_pred_flag[ x0 + i ][ y0 + j ] | ae(v) |

for( j = 0; j < nCbS; j = j + pbOffset )

for( i = 0; i < nCbS; i = i + pbOffset )

if( prev_intra_luma_pred_flag[ x0 + i ][ y0 + j ] )

| | |
|---|---|
| mpm_idx[ x0 + i ][ y0 + j ] | ae(v) |

Else

| | |
|---|---|
| rem_intra_luma_pred_mode[ x0 + i ][ y0 + j ] | ae(v) |

if( ChromaArrayType = = 3 )

for( j = 0; j < nCbS; j = j + pbOffset )

for( i = 0; i < nCbS; i = i + pbOffset )

| | |
|---|---|
| intra_chroma_pred_mode[ x0 + i ][ y0 + j ] | ae(v) |

else if( ChromaArrayType != 0 )

| | |
|---|---|
| intra_chroma_pred_mode[ x0 ][ y0 ] | ae(v) |

}

} else {

if( PartMode = = PART_2Nx2N )

prediction_unit( x0, y0, nCbS, nCbS )

else if( PartMode = = PART_2NxN ) {

prediction_unit( x0, y0, nCbS, nCbS / 2 )
prediction_unit( x0, y0 + ( nCbS / 2 ), nCbS, nCbS / 2 )

} else if( PartMode = = PART_Nx2N ) {

prediction_unit( x0, y0, nCbS / 2, nCbS )
prediction_unit( x0 + ( nCbS / 2 ), y0, nCbS / 2, nCbS )

} else if( PartMode = = PART_2NxnU ) {

prediction_unit( x0, y0, nCbS, nCbS / 4 )
prediction_unit( x0, y0 + ( nCbS / 4 ), nCbS, nCbS * 3 / 4 )

} else if( PartMode = = PART_2NxnD ) {

prediction_unit( x0, y0, nCbS, nCbS * 3 / 4 )
prediction_unit( x0, y0 + ( nCbS * 3 / 4 ), nCbS, nCbS / 4 )

} else if( PartMode = = PART_nLx2N ) {

prediction_unit( x0, y0, nCbS / 4, nCbS )
prediction_unit( x0 + ( nCbS / 4 ), y0, nCbS * 3 / 4, nCbS )

} else if( PartMode = = PART_nRx2N ) {

prediction_unit( x0, y0, nCbS * 3 / 4, nCbS )
prediction_unit( x0 + ( nCbS * 3 / 4 ), y0, nCbS / 4, nCbS )

} else { /* PART_NxN */

prediction_unit( x0, y0, nCbS / 2, nCbS / 2 )
prediction_unit( x0 + ( nCbS / 2 ), y0, nCbS / 2, nCbS / 2 )
prediction_unit( x0, y0 + ( nCbS / 2 ), nCbS / 2, nCbS / 2 )
prediction_unit( x0 + ( nCbS / 2 ), y0 + ( nCbS / 2 ), nCbS / 2, nCbS / 2 )

}

}
if( !pcm_flag[ x0 ][ y0 ] ) {

if( CuPredMode[ x0 ][ y0 ] != MODE_INTRA &&

| | |
|---|---|
| !( PartMode = = PART_2Nx2N && merge_flag[ x0 ][ y0 ] ) ∥ | |
| ( CuPredMode[ x0 ][ y0 ] = = MODE_INTRA && intra_bc_flag[ x0 ][ y0 ] ) ) | |
| rqt_root_cbf | ae(v) |

if( rqt_root_cbf ) {

MaxTrafoDepth = ( CuPredMode[ x0 ][ y0 ] = = MODE_INTRA ?

( max_transform_hierarchy_depth_intra +

IntraSplitFlag ) :

max_transform_hierarchy_depth_inter )

transform_tree( x0, y0, x0, y0, log2CbSize, 0, 0 )

}

}

}

}

}

TABLE 13 below shows 1D dictionary block syntax.

TABLE 13
dictionary_syntax_table( ) {

for( decPixelCnt=0; decPixelCnt < (1<<(2* log2CbSize); ) {

| | |
|---|---|
| matching_string_flag | ae(v) |
| if(matching_string_flag = = 1) { | |

| | |
|---|---|
| matching_string_offset_use_recent_8_flag | ae(v) |
| if(matching_string_distance_use_recent_8_flag) | |

| | |
|---|---|
| matching_string_offset_recent_8_idx | ae(v) |

else

| | |
|---|---|
| matching_string_offset_minus1 | ae(v) |

| | |
|---|---|
| matching_string_length_minus1 | ae(v) |
| decPixelCnt += | |
| (matching_string_length_minus1 + 1) | |

}
else {

| | |
|---|---|
| unmatchable_sample_value_component0 | ae(v) |
| unmatchable_sample_value_component1 | ae(v) |
| unmatchable_sample_value_component2 | ae(v) |
| decPixelCnt ++ | |

}

}

}

Aspects of the semantics introduced above will now be described in more detail. In the SPS semantics are as follows, the syntax element “dictionary_{—}1d_enable_flag” equal to 1 specifies that dictionary coding may be invoked for coding units of the coded video sequence. “dictionary_{—}1d_enable_flag” equal to 0 specifies that dictionary coding is not invoked for any coding units of the coded video sequence. When not present, the value of dictionary_{—}1d_enable_flag is inferred to be equal to 0.

In the CU semantics, the syntax element “dictionary_coded_flag” equal to 1 specifies that dictionary coding is used for the coding unit and all the any other syntax element for the current coding is not present. “dictionary_coded_flag” equal to 0 specifies that dictionary coding is not used for the coding unit. When not present, the value of “dictionary_coded_flag” is inferred to be equal to 0. The syntax element “dictionary_coded_flag” shall be set equal to 0 when log 2CbSize is smaller than CtbLog 2SizeY.

The above used 1D dictionary block table semantics may be defined as below:
matching_string_flag equal to 1 indicates that the current pixel starts a matching string. matching_string_flag equal to 0 indicates the current does not start a matching string and its values are explicitly present.
matching_string_offset_use_recent_{—}8_flag equal to 1 indicates the current matching string offset is equal to one of the eight previously decoded matching string offsets and the string offset is specified by matching_string_offset_recent_{—}8_idx. matching_string_offset_use_recent_{—}8_flag equal to 0 indicates the current matching string offset is explicitly present by syntax matching_string_offset_minus1.
matching_string_offset_recent_{—}8_idx specifies the index to the eight previously coded matching string offsets. When not present, the value of matching_string_offset_recent_{—}8_idx is inferred to be equal to 0.
matching_string_offset_minus1 plus 1 specifies the matching string offset between the current string and the reference string. When not present, the value of matching_string_offset_minus1 is inferred to be equal to 0.
matching_string_length_minus1 plus 1 specifies the matching string run (the number of pixels that the current string match the reference string). When not present, the value of matching_string_length_minus1 is inferred to be equal to 0.
unmatchable_sample_value_component0 is specifies the value of the 0-th sample of the current pixel.
unmatchable_sample_value_component1 is equal to pixel value of the 1-th sample the current pixel.
unmatchable_sample_value_component2 is equal to pixel value of 2-th sample of the current pixel.

Aspects of the parsing and decoding processes will now be described in more detail. This section provides parsing and decoding process for an escape pixel, escPix[i], with i ranging from 0 to 2, inclusive, or a string offset strOffset, with strRun. Let recent8offset[i], with i from 0 through 7, inclusive, to be the string offset predictor.

This initialization process for the offset preditor list will now be described. This process is invoked after the slice header is parsed or a coding unit with dictionary_coded_flag equal to 0 is decoded. Set recent8offset[i] to 0 for i from 0 through 7, inclusive.

The prefix parameter posSlot calculation for matching_string_offset_minus1 will now be described. An input to this process is a parameter matching_string_offset_minus1. An output of this process is the group index parameter posSlot. The following procedure is applied to obtain posSlot:

```
        kNumLogBits = 11;
        if (pos < 128)
            posSlot = m_pbFastPos[pos];
        else {
            i = 6 + ((kNumLogBits − 1) & (0 − (((((UInt)1 <<
(kNumLogBits + 6)) − 1) − pos) >> 31)));
            posSlot = m_pbFastPos[pos >> i] + (i * 2);
        }
```

m_pbFastPos is calculated as follows:

```
c = 2;
kNumLogBits = 11;
m_pbFastPos[0] = 0;m_pbFastPos[1] = 1;
for (slotFast = 2; slotFast < kNumLogBits*2; slotFast++){
  k = (1 << ((slotFast >> 1) − 1));
  for (j = 0; j < k; j++, c++)
  m_pbFastPos[c] = (UChar)slotFast; }
}
```

TABLE 9-32
Syntax elements and associated binarizations

| | | Binarization | |
|---|---|---|---|
| Syntax structure | Syntax element | Process | Input parameters |
| dictionary_syntax_table( ) | matching string flag | FL | cMax = 1 |
| | matching_string_offset_use_recent_8_flag | FL | cMax = 1 |
| | matching_string_offset_recent_8_idx | FL | cMax = 7 |
| | matching_string_offset_minus1 | 5.1.1.1 | cMax = 2, cRiceParam = 0 |
| | matching_string_length_minus1 | 5.1.1.2 | cMax = 4, cRiceParam = 4 |
| | unmatchable_sample_value_component0 | FL | cMax = (1 << ( bitDepthY) − 1 |
| | unmatchable_sample_value_component1 | FL | cMax = (1 << ( bitDepthC ) − 1 |
| | unmatchable_sample_value_component2 | FL | cMax = (1 << ( bitDepthC) − 1 |

A binarization process for matching_string_offset_minus1 will now be described. Input to this process are a request for a binarization for the syntax element matching_string_offset_minus1. An output of this process is the binarization of the syntax element. The binarization of the syntax element matching_string_offset_minus1 is a concatenation of a prefix bin string and (when present) a suffix bin string. For the derivation of the prefix bin string, the following applies:
The prefix value of matching_string_offset_minus1, prefixVal, is derived as follows:
   A parameter matching_string_offset_max_minus1 is set equal to absolute position in the 1D dictionary scanning order;
   A parameter posSlot is calculated by invoking the subclause described above with matching_string_offset_minus1 as input;
   A parameter posSlotMax is calculated by invoking subclause described above with the last position matching_string_offset_max_minus1 in the current CU;
   prefixVal is calculated by invoking subclause described above with posSlot and maximum possible value posSlotMax as inputs.
The suffix value of matching_string_offset_minus1, suffixVal, is derived as follows:
If posSlot is equal or larger than 4, the following procedure is applied
   A parameter suffix length sufLength is set equal to ((posSlot>>1)−1);
   max=2̂sufLength−1;
   A parameter posReduced is set equal to (matching_string_offset_minus1−((2|(posSlot & 1))<<sufLength));
   FL codeword binarization is invoked with max and posReduced as the symbol to code

A truncated binary process will now be described. Inputs to this process is a symbol s and the total size of number n. An output of this process is the binarization of symbol s. The following procedure is applied. If n is a power of 2, then the coded value for 0≦x<n is the simple binary code for x of length log 2(n). Otherwise, let k=floor(log 2(n)) such that 2k≦n<2k+1 and let u=2k+1−n. Truncated binary encoding assigns the first u symbols codewords of length k and then assigns the remaining n-u symbols the last n-u codewords of length k+1.

A binarization process for matching_string_length_minus1 will now be described. Inputs to this process are a request for a binarization for the syntax element matching_string_length_minus1 and cRiceParam. An output of this process is the binarization of the syntax element. The variable cMax is derived from cRiceParam as:

cMax=1<<cRiceParam

The binarization of the syntax element matching_string_length_minus1 is a concatenation of a prefix bin string and (when present) a suffix bin string. For the derivation of the prefix bin string, the following applies:
The prefix value of matching_string_length_minus1, prefixVal, is derived as follows:

prefixVal=Min(cMax,matching_string_length_minus1)
The prefix bin string is specified by invoking the TR binarization process as specified in subclause 9.3.3.2 for prefixVal with the variables cMax and cRiceParam as inputs.

When the prefix bin string is equal to the bit string of length 4 with all bits equal to 1, the suffix bin string is present and is derived as follows:
The suffix value of matching_string_length_minus1, suffixVal, is derived as follows:

suffixVal=matching_string_length_minus1−cMax
The suffix bin string is specified by invoking the EGk binarization process as specified in subclause 9.3.3.3 for suffixVal with the Exp-Golomb order k set equal to cRiceParam+1.

A derivation process for syntax elements of a 1D dictionary coded block will now be described. This sub-clause is invoked when dictionary_{—}1d_enable_flag is equal to 1.

The following apply:

```
  for( decPixelCnt = 0 ; i < 1<<(2* log2CbSize); ) {
      if( matching_string_flag ) {
        if(matching_string_offset_use_recent_8_flag)
          strOffset =
recent8offsets[matching_string_offset_recent_8_idx]+1
        else {
          strOffset = matching_string_offset_minus1 + 1
          for (i=7; i>0;i−−)
            recent8offset[i] = recent8offset[i−1]
          recent8offsets[0] = matching_string_offset_minus1
        }
        matchingStringRun = matching_string_length_minus1 + 1,
        decPixelCnt+= matchingStringRun;
      }
      else {
        for ( i =0; i< 3; i++)
          escPix[ i ] is set equal to
unmatchable_sample_value_componentX, with X equal to i
        decPixelCnt++
      }
  }
```

At the encoder (e.g. video encoder 20), hash value for each pixel may be calculated as a simple concatenation of the most significant bits (MSBs), equally distributed to three samples. The number of the bits (nBitHash) for a hash value may be defined as part of the configuration. The number of the MSBs of each sample of the i-th (i is from 0 through 2) component is derived as follows: (nBitHash+2−i)/3. It may be possible to concatenate the three components and calculate the hash value with a 16-bit CRC by a bit polynomial of 0xA02B.

After a match is identified between a current pixel and a reference pixel, the string run starts till a pixel match cannot be identified to get a consecutive number of matched pixels. There can be collisions corresponding to reference pixels with the same hash value. In such a case, a longer string run is performed between collisions and chosen at the encoder.

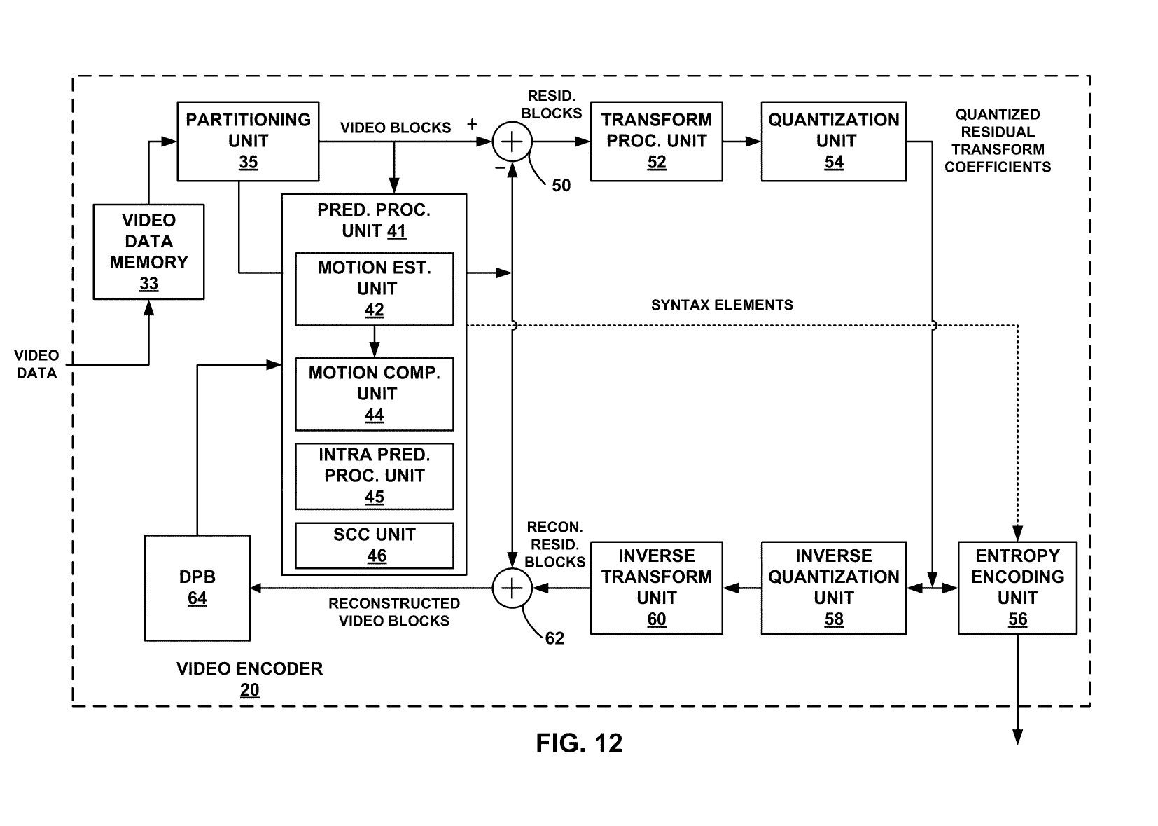

FIG. 12 is a block diagram illustrating an example video encoder 20 that may implement the techniques described in this disclosure. Video encoder 20 may perform intra- and inter-coding of video blocks within video slices. Intra-coding relies on spatial prediction to reduce or remove spatial redundancy in video within a given video frame or picture. Inter-coding relies on temporal prediction to reduce or remove temporal redundancy in video within adjacent frames or pictures of a video sequence. Intra-mode (I mode) may refer to any of several spatial based compression modes. Inter-modes, such as uni-directional prediction (P mode) or bi-prediction (B mode), may refer to any of several temporal-based compression modes.

In the example of FIG. 12, video encoder 20 includes video data memory 33, a partitioning unit 35, prediction processing unit 41, decoded picture buffer (DPB) 64, summer 50, transform processing unit 52, quantization unit 54, and entropy encoding unit 56. Prediction processing unit 41 includes motion estimation unit 42, motion compensation unit 44, and intra prediction processing unit 45, and screen content coding (SCC) unit 46. For video block reconstruction, video encoder 20 also includes inverse quantization unit 58, inverse transform unit 60, and summer 62. A deblocking filter (not shown in FIG. 12) may also be included to filter block boundaries to remove blockiness artifacts from reconstructed video. If desired, the deblocking filter would typically filter the output of summer 62. Additional loop filters (in loop or post loop) may also be used in addition to the deblocking filter.

Video data memory 33 may store video data to be encoded by the components of video encoder 20. The video data stored in video data memory 33 may be obtained, for example, from video source 18. DPB 64 may be a reference picture memory that stores reference video data for use in encoding video data by video encoder 20, e.g., in intra- or inter-coding modes. Video data memory 33 and DPB 64 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 33 and DPB 64 may be provided by the same memory device or separate memory devices. In various examples, video data memory 33 may be on-chip with other components of video encoder 20, or off-chip relative to those components.

As shown in FIG. 12, video encoder 20 receives video data, and partitioning unit 35 partitions the data into video blocks. This partitioning may also include partitioning into slices, tiles, or other larger units, as wells as video block partitioning, e.g., according to a quadtree structure of LCUs and CUs. Video encoder 20 generally illustrates the components that encode video blocks within a video slice to be encoded. The slice may be divided into multiple video blocks (and possibly into sets of video blocks referred to as tiles). Prediction processing unit 41 may select one of a plurality of possible coding modes, such as one of a plurality of intra coding modes or one of a plurality of inter coding modes, for the current video block based on error results (e.g., coding rate and the level of distortion). Prediction processing unit 41 may provide the resulting intra- or inter-coded block to summer 50 to generate residual block data and to summer 62 to reconstruct the encoded block for use as a reference picture.

Intra prediction processing unit 45 within prediction processing unit 41 may perform intra-predictive coding of the current video block relative to one or more neighboring blocks in the same frame or slice as the current block to be coded to provide spatial compression. Motion estimation unit 42 and motion compensation unit 44 within prediction processing unit 41 perform inter-predictive coding of the current video block relative to one or more predictive blocks in one or more reference pictures to provide temporal compression.

Motion estimation unit 42 may be configured to determine the inter-prediction mode for a video slice according to a predetermined pattern for a video sequence. The predetermined pattern may designate video slices in the sequence as P slices or B slices. Motion estimation unit 42 and motion compensation unit 44 may be highly integrated, but are illustrated separately for conceptual purposes. Motion estimation, performed by motion estimation unit 42, is the process of generating motion vectors, which estimate motion for video blocks. A motion vector, for example, may indicate the displacement of a PU of a video block within a current video frame or picture relative to a predictive block within a reference picture.

A predictive block is a block that is found to closely match the PU of the video block to be coded in terms of pixel difference, which may be determined by sum of absolute difference (SAD), sum of square difference (SSD), or other difference metrics. In some examples, video encoder 20 may calculate values for sub-integer pixel positions of reference pictures stored in DPB 64. For example, video encoder 20 may interpolate values of one-quarter pixel positions, one-eighth pixel positions, or other fractional pixel positions of the reference picture. Therefore, motion estimation unit 42 may perform a motion search relative to the full pixel positions and fractional pixel positions and output a motion vector with fractional pixel precision.

Motion estimation unit 42 calculates a motion vector for a PU of a video block in an inter-coded slice by comparing the position of the PU to the position of a predictive block of a reference picture. The reference picture may be selected from a first reference picture list (List 0) or a second reference picture list (List 1), each of which identify one or more reference pictures stored in DPB 64. Motion estimation unit 42 sends the calculated motion vector to entropy encoding unit 56 and motion compensation unit 44.

Motion compensation, performed by motion compensation unit 44, may involve fetching or generating the predictive block based on the motion vector determined by motion estimation, possibly performing interpolations to sub-pixel precision. Upon receiving the motion vector for the PU of the current video block, motion compensation unit 44 may locate the predictive block to which the motion vector points in one of the reference picture lists. Video encoder 20 forms a residual video block by subtracting pixel values of the predictive block from the pixel values of the current video block being coded, forming pixel difference values. The pixel difference values form residual data for the block, and may include both luma and chroma difference components. Summer 50 represents the component or components that perform this subtraction operation. Motion compensation unit 44 may also generate syntax elements associated with the video blocks and the video slice for use by video decoder 30 in decoding the video blocks of the video slice.

Prediction processing unit 41 generates a predictive block via one of motion estimation performed by motion estimation unit 42 and motion compensation unit 44, intra prediction performed by intra prediction processing unit 45, or a screen content coding technique performed by SCC unit 46. Examples, screen content coding techniques include 1D dictionary coding, intra block copy, palette mode coding, and various other techniques described in this disclosure.

After prediction processing unit 41 generates the predictive block for the current video block, video encoder 20 forms a residual video block by subtracting the predictive block from the current video block. As noted above, not all predictive modes utilize residual coding. The residual video data in the residual block may be included in one or more TUs and applied to transform processing unit 52. Transform processing unit 52 transforms the residual video data into residual transform coefficients using a transform, such as a discrete cosine transform (DCT) or a conceptually similar transform. Transform processing unit 52 may convert the residual video data from a pixel domain to a transform domain, such as a frequency domain.

Transform processing unit 52 may send the resulting transform coefficients to quantization unit 54. Quantization unit 54 quantizes the transform coefficients to further reduce bit rate. The quantization process may reduce the bit depth associated with some or all of the coefficients. The degree of quantization may be modified by adjusting a quantization parameter. In some examples, quantization unit 54 may then perform a scan of the matrix including the quantized transform coefficients. Alternatively, entropy encoding unit 56 may perform the scan.

Following quantization, entropy encoding unit 56 entropy encodes the quantized transform coefficients. For example, entropy encoding unit 56 may perform context adaptive variable length coding (CAVLC), context adaptive binary arithmetic coding (CABAC), syntax-based context-adaptive binary arithmetic coding (SBAC), probability interval partitioning entropy (PIPE) coding or another entropy encoding methodology or technique. Following the entropy encoding by entropy encoding unit 56, the encoded bitstream may be transmitted to video decoder 30, or archived for later transmission or retrieval by video decoder 30. Entropy encoding unit 56 may also entropy encode the motion vectors and the other syntax elements for the current video slice being coded.

Inverse quantization unit 58 and inverse transform unit 60 apply inverse quantization and inverse transformation, respectively, to reconstruct the residual block in the pixel domain for later use as a reference block of a reference picture. Motion compensation unit 44 may calculate a reference block by adding the residual block to a predictive block of one of the reference pictures within one of the reference picture lists. Motion compensation unit 44 may also apply one or more interpolation filters to the reconstructed residual block to calculate sub-integer pixel values for use in motion estimation. Summer 62 adds the reconstructed residual block to the motion compensated prediction block produced by motion compensation unit 44 to produce a reference block for storage in DPB 64. The reference block may be used by motion estimation unit 42 and motion compensation unit 44 as a reference block to inter-predict a block in a subsequent video frame or picture.

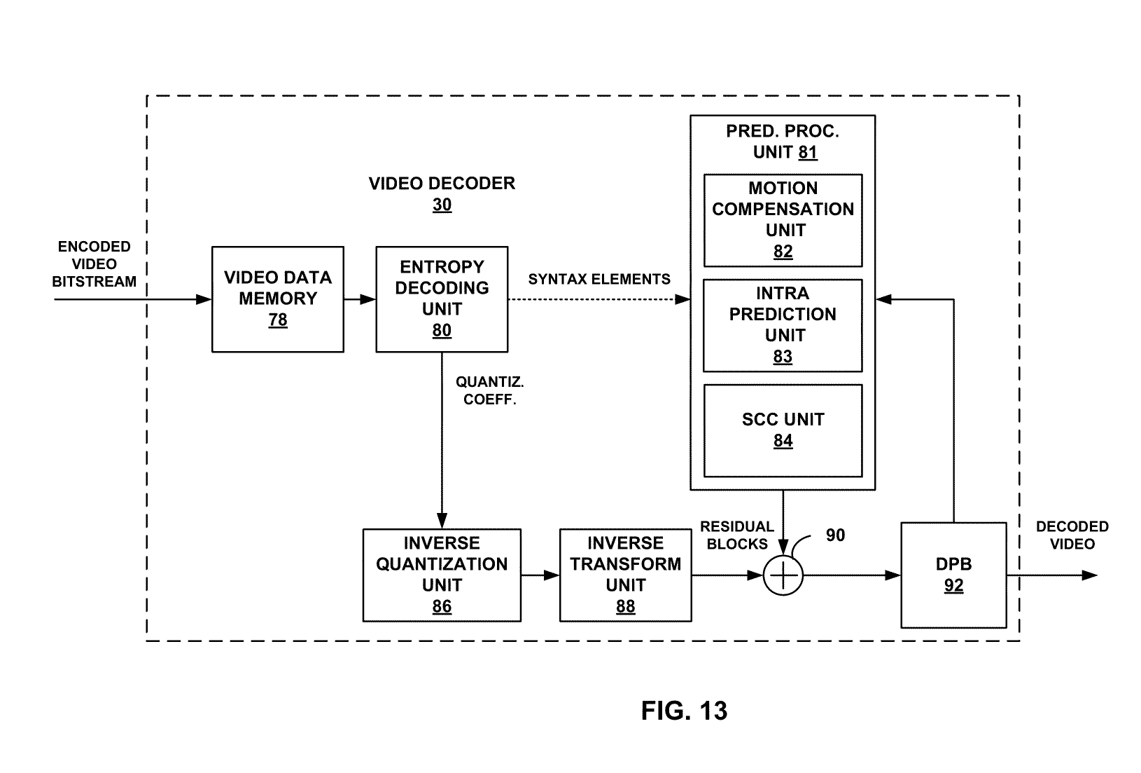

FIG. 13 is a block diagram illustrating an example video decoder 30 that may implement the techniques described in this disclosure. In the example of FIG. 13, video decoder 30 includes video data memory 78, an entropy decoding unit 80, prediction processing unit 81 (also referred to as a prediction processing unit), inverse quantization unit 86, inverse transformation unit 88, summer 90, and decoded picture buffer (DPB) 92. Prediction processing unit 81 includes motion compensation unit 82, intra prediction unit 83, and SCC unit 84. Video decoder 30 may, in some examples, perform a decoding pass generally reciprocal to the encoding pass described with respect to video encoder 20 from FIG. 12.

During the decoding process, video decoder 30 receives an encoded video bitstream that represents video blocks of an encoded video slice and associated syntax elements from video encoder 20 or from an intermediary between video encoder 20 and video decoder 30. Video decoder 30 stores the received video data in video data memory 78. Video data memory 78 may store video data, such as an encoded video bitstream, to be decoded by the components of video decoder 30. The video data stored in video data memory 78 may be obtained, for example, from computer-readable medium 16, e.g., from a local video source, such as a camera, via wired or wireless network communication of video data, or by accessing physical data storage media. Video data memory 78 may form a coded picture buffer (CPB) that stores encoded video data from an encoded video bitstream. DPB 92 may be a reference picture memory that stores reference video data for use in decoding video data by video decoder 30, e.g., in intra- or inter-coding modes. Video data memory 78 and DPB 92 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 78 and DPB 92 may be provided by the same memory device or separate memory devices. In various examples, video data memory 78 may be on-chip with other components of video decoder 30, or off-chip relative to those components.

Entropy decoding unit 80 of video decoder 30 entropy decodes the bitstream to generate quantized coefficients, motion vectors, and other syntax elements. Entropy decoding unit 80 forwards the motion vectors and other syntax elements to prediction processing unit 81. Video decoder 30 may receive the syntax elements at the video slice level and/or the video block level.

When the video slice is coded as an intra-coded (I) slice, intra prediction unit 83 of prediction processing unit 81 may generate prediction data for a video block of the current video slice based on a signaled intra prediction mode and data from previously decoded blocks of the current frame or picture. When the video frame is coded as an inter-coded (i.e., B or slice), motion compensation unit 82 of prediction processing unit 81 produces predictive blocks for a video block of the current video slice based on the motion vectors and other syntax elements received from entropy decoding unit 80. The predictive blocks may be produced from one of the reference pictures within one of the reference picture lists. Video decoder 30 may construct the reference frame lists, List 0 and List 1, using default construction techniques based on reference pictures stored in DPB 92.

Motion compensation unit 82 determines prediction information for a video block of the current video slice by parsing the motion vectors and other syntax elements, and uses the prediction information to produce the predictive blocks for the current video block being decoded. For example, motion compensation unit 82 uses some of the received syntax elements to determine a prediction mode (e.g., intra- or inter-prediction) used to code the video blocks of the video slice, an inter-prediction slice type (e.g., B slice or P slice), construction information for one or more of the reference picture lists for the slice, motion vectors for each inter-encoded video block of the slice, inter-prediction status for each inter-coded video block of the slice, and other information to decode the video blocks in the current video slice.

Motion compensation unit 82 may also perform interpolation based on interpolation filters. Motion compensation unit 82 may use interpolation filters as used by video encoder 20 during encoding of the video blocks to calculate interpolated values for sub-integer pixels of reference blocks. In this case, motion compensation unit 82 may determine the interpolation filters used by video encoder 20 from the received syntax elements and use the interpolation filters to produce predictive blocks.

Inverse quantization unit 86 inverse quantizes, i.e., de-quantizes, the quantized transform coefficients provided in the bitstream and decoded by entropy decoding unit 80. The inverse quantization process may include use of a quantization parameter calculated by video encoder 20 for each video block in the video slice to determine a degree of quantization and, likewise, a degree of inverse quantization to apply. Inverse transform unit 88 applies an inverse transform, e.g., an inverse DCT, an inverse integer transform, or a conceptually similar inverse transform process, to the transform coefficients in order to produce residual blocks in the pixel domain.

Prediction processing unit 81 generates a predictive block via one of motion compensation performed by motion compensation unit 82, intra prediction performed by intra prediction unit 83, or a screen content coding technique performed by SCC unit 84. Examples, screen content coding techniques include 1D dictionary coding, intra block copy, palette mode coding, and various other techniques described in this disclosure.

After prediction processing unit 81 generates the predictive block for the current video block based on the motion vectors and other syntax elements, video decoder 30 forms a decoded video block by summing the residual blocks from inverse transform unit 88 with the corresponding predictive blocks generated by motion compensation unit 82. Summer 90 represents the component or components that perform this summation operation. If desired, a deblocking filter may also be applied to filter the decoded blocks in order to remove blockiness artifacts. Other loop filters (either in the coding loop or after the coding loop) may also be used to smooth pixel transitions, or otherwise improve the video quality. The decoded video blocks in a given frame or picture are then stored in DPB 92, which stores reference pictures used for subsequent motion compensation. DPB 92 also stores decoded video for later presentation on a display device, such as display device 32 of FIG. 1.

Video decoder 30 represents an examples of a video decoder configured to determine that a current block of video data is to be decoded using a 1D dictionary mode. Video decoder 30 may, for example, receive, for a current pixel of the current block, a first syntax element indicating a starting location of reference pixels and a second syntax element identifying a number of reference pixels and, based on the first syntax element and the second syntax element, locate a plurality of luma samples corresponding to the reference pixels, and based on the first syntax element and the second syntax element, locating a plurality of chroma samples corresponding to the reference pixels. Video decoder 30 may copy the plurality of luma samples and the plurality of chroma samples to decode the current block.

Video decoder 30 may receive the first and second syntax elements for a luma sample of the current pixel, and based on the first syntax element and the second syntax element for the luma sample, locate two plurality of chroma samples and copy the two plurality of chroma samples to decode the current block.

The video data may be video data with a 4:4:4 chroma sub-sampling format. Video decoder 30 may receive second video data that includes video data with a 4:2:2 chroma sub-sampling format video data or video data with a 4:2:0 chroma sub-sampling format. For a current pixel of a current block of the second video data, video decoder 30 may receive a first set of syntax elements indicating a starting location of reference pixels and identifying a number of reference pixels for a luma component of the current block and receive a second set of syntax elements indicating a starting location of reference pixels and identifying a number of reference pixels for a chroma component of the current block.

The first syntax element may signal a two-dimensional displacement vector pointing to the starting location of the reference pixel. A first component of the displacement vector may be binarized with a first greater than 0 flag, a first greater than 1 flag, and a first exponential Golomb code, and a second component of the displacement vector may be binarized with a second greater than 0 flag, a second greater than 1 flag, and a second exponential Golomb code. The first syntax element may signal an indication of a relative position between the current pixel of the current block and the starting location of the reference pixels. A value of the second syntax element may be binarized with a greater than 0 flag and an exponential Golomb code.

The encoded video data may be video data with a 4:2:2 chroma sub-sampling format video data or video data with a 4:2:0 chroma sub-sampling format, and video decoder 30 may be configured to perform one or more of (1) scaling the a value determined based on the first syntax element indicating the starting location of the reference pixels and scaling the number of reference pixels (2) interpolating chroma samples.

At least one of the reference pixels may be in the current block. The reference pixels may include the current pixel.

For the 1D dictionary coding mode, video decoder 30 may determine a minimum value for the number of reference pixels. Video decoder 30 may, for example, determine the minimum value for the number of reference pixels by receiving in the video data a syntax element identifying the minimum value. A value of the second syntax element may correspond to the number of reference pixels minus the minimum value for the number of pixel values to copy.

Based on a location of the current pixel and the number of reference pixels identified by the second syntax element, video decoder 30 may identify a last pixel in a row of the current block, and for the last pixel in the first row of the current block, copy a luma value of a first corresponding reference pixel. For a first pixel in a next row of the current block, video decoder 30 may copy a luma value of a second corresponding reference pixel. A two-dimensional displacement between the last pixel in the row and the first pixel of the next row may be equal to a two-dimensional displacement between the first corresponding reference pixel and the second corresponding reference pixel. In other words, the reference pixels may have the same shape as the current pixels being predicted.

Video decoder 30 may locate the plurality of luma samples by locating the starting location of the reference pixels and copying the plurality of luma samples by determining a luma value corresponding to the current pixel to be equal to a luma value corresponding to the starting location of the reference pixels. Video decoder 30 may copy the plurality of luma samples by determining a luma value of a pixel following the current pixel in a scan order to be equal to a luma value of a reference pixel following the starting location of the reference pixels, where the pixel following the current pixel follows the current pixel by a same number of the samples as the reference pixel following the starting location follows the starting location of the reference pixels.

For the current block of video data, video decoder 30 may determine a maximum range value that identifies a maximum distance in luma samples between the first pixel and the starting location of pixel values to copy.

In accordance with the techniques described above, video decoder 30 may be configured to receive, in the video data, a flag that if 1D dictionary coding is enabled or disabled, and in response to the flag indicating 1D dictionary coding is enabled, video decoder 30 may performing 1D dictionary coding. The flag may, for example, be received in one of an SPS, a PPS, a slice header, a coding unit header, or an SEI message. In response to the flag indicating 1D dictionary coding is enabled, video decoder 30 may receive a second flag that indicates if a coding unit is coded using 1D dictionary coding.

Video decoder 30 may receive (and video encoder 20 may transmit) a syntax table for the 1D dictionary as a loop. Each iteration of the loop comprises one or more of the following information: (1) an indication of whether the current iteration is a sequence (i.e. matching) of pixels or an unmatched pixel (escape pixel), (2) if the current iteration is a sequence of pixels, the matching string offset indicating from where the sequence of pixels are predicted/copied; and (3) if the current iteration is a sequence of pixels, a matching string run value indicating the number of pixels predicted/copied.

In accordance with the techniques described above, video decoder 30 may perform 1D dictionary coding using a 2d reference mode. For a current block coded with 1D dictionary coding, video decoder 30 may detect a matching string run of the current block using a traversing order. Video decoder 30 may, for example, start from a first pixel in the current block and traverse the run horizontally until a block boundary is reached. In response to reaching the block boundary, video decoder 30 may move to a first pixel of a next row in the current block. The traversing order may, for example, be a raster scan order, a horizontal scan order, a vertical scan order, or any other such order. Video decoder 30 may determine, based on signaled information, the traversing order.

The reference pixels used for 1D dictionary coding within the current picture may include pixels that have not been processed with an in-loop filter. A current matching string run and the reference matching string run may be synchronized in terms of relative geometric sample/pixel position to the first current pixel and first reference pixel. For a sample/pixel coded without a matching string in a coding unit that is coded with 1D dictionary, video decoder 30 may directly code each sample of the pixel without prediction.

Video decoder 30 may code the video data in a lossy 1D dictionary mode and determine residual data for one or more runs of a color component for the video data. Video decoder 30 may, for example, receive signaling indicating if the residual data is present. The residual data may, for example, include an RQT.

Video decoder 30 may, for example, enable 1D dictionary coding at a TU-level. In response to a transform not being skipped and 1D dictionary coding being enabled for a transform unit (TU), performing prediction using available pixels of the TU. In response to a transform being skipped and 1D dictionary coding being enabled for a TU, video decoder 30 may perform prediction using both available pixels out of the TU and available pixels in the TU. Video decoder 30 may enable 1D dictionary coding at a TU level only in response to a CU size being smaller or larger than a predefined size. Video decoder 30 may receiving signaling of a range of matching string offset using high level syntax enable a codec to allocate storage. A maximum range of the matching string offset may be indicated in integer luma sample units, for all pictures in the coded video sequence.

Video decoder 30 may select a palette coding mode for the video data from one of a plurality of palette coding modes, wherein the plurality of palette coding modes includes a dictionary coding mode; and decode the video data using the selected palette coding mode. The plurality of palette coding modes may include an escape mode, a copy from left mode, a copy from above mode, and the dictionary mode.

When a dictionary coding mode and a palette coding mode are enabled for a block of video data, video decoder 30 may receive signaling indicating that the dictionary coding mode and the palette coding mode use a shared set of syntax elements.

Video decoder 30 may determine a first reference area associated with a dictionary coding mode and determine a second reference area associated with an intra-block copying mode based on the first reference area. Video decoder 30 may determine the second reference area by setting the second reference area equal to the first reference area. Video decoder 30 may determine the second reference area comprises setting the second reference area to include a different area than the first reference area.

Video decoder 30 may decode a bitstream that comprises an encoded representation of the video data. As part of the decoding, video decoder 30 may store, in a memory, decoded samples of a current picture of the video data. Video decoder 30 may decode a current block of the current picture, with the bitstream being subject to a constraint that prevents the bitstream from indicating that a run of sample values in the current block matches a run of the decoded samples stored in the memory when the run of sample values in the current block has a length less than a minimum allowable run length.

Video decoder 30 may obtain, from the bitstream, a syntax element indicating a run length value for the run, where the run length value for the run is equal to the length of the run minus the minimum allowable run length. Video decoder 30 may obtain, from the bitstream, a syntax element indicating a run length value for the run, where the run length value for the run is equal to the length of the run. Video decoder 30 may obtain, from the bitstream, data indicating the minimum allowable run length. Video decoder 30 may obtain the data indicating the minimum allowable run length by obtaining, from a High-Level Syntax structure of the bitstream, the data indicating the minimum allowable run length. The High-Level Syntax structure may be one of: a picture parameter set, a sequence parameter set, a slice header, or a Supplemental Enhancement Information (SEI) message. Video decoder 30 may obtaining the data indicating the minimum allowable run length by obtaining the data indicating the minimum allowable run length at a picture level, a slice level, a tile level, a coding unit level, or in a Supplemental Enhancement Information (SEI) message.

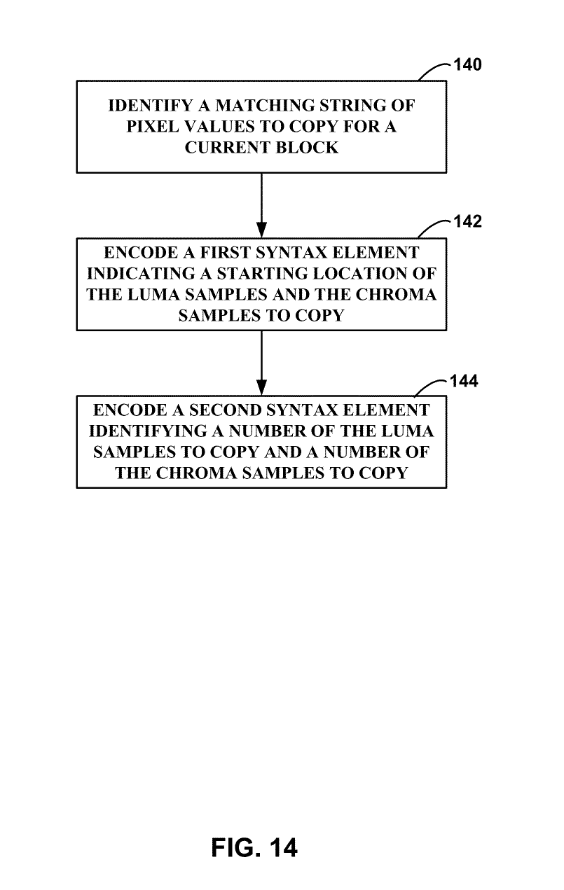

FIG. 14 is a flowchart illustrating an example technique of encoding video data. For purposes of illustration, the example of FIG. 14 is described with respect to video encoder 20. In the example of FIG. 14, video encoder 20 identifies a matching string of pixel values to copy for a current block, wherein the matching string of pixel values include a plurality of luma samples and a corresponding plurality of chroma samples (140). Video encoder 20 encodes a first syntax element indicating a starting location of the luma samples and the chroma samples to copy (142). Video encoder 20 encodes a second syntax element identifying a number of the luma samples to copy and a number of the chroma samples to copy (144). In some examples, such as when the current block has a 4:4:4 chroma sub-sampling format, the plurality of luma samples may include an equal number of samples as the corresponding plurality of chroma samples. In other examples, such as when the current block has a 4:2:2 or 4:2:0 chroma sub-sampling format, the plurality of luma samples may include more (e.g. twice or four-times more) samples as the corresponding plurality of chroma samples.

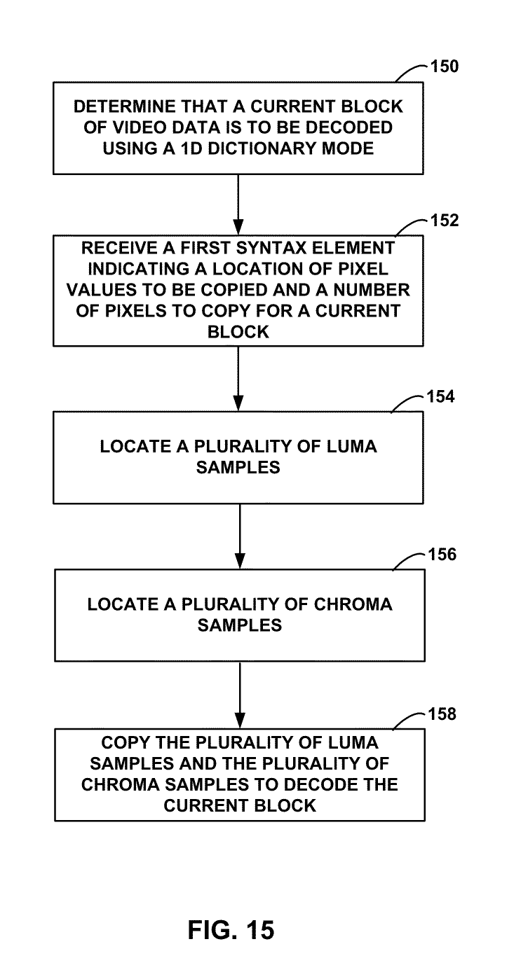

FIG. 15 is a flowchart illustrating an example technique of decoding video data. For purposes of illustration, the example of FIG. 15 is described with respect to video decoder 30. In the example of FIG. 15, video decoder 30 determines that a current block of video data is to be decoded using a 1D dictionary mode (150). Video decoder 30 receives, in a bitstream of encoded video data, a first syntax element indicating a location of pixel values to be copied and a number of pixels to copy for a current block (152). Based on the first syntax element and the second syntax element, video decoder 30 locates a plurality of luma samples (154) and locates a plurality of chroma samples (156). Video decoder 30 copies the plurality of luma samples and the plurality of chroma samples to decode the current block (158). Video decoder 30 reconstructs the current block using the plurality of luma samples and the plurality of chroma samples.

In the example of FIG. 15, video decoder 30 may, based on the first syntax element and the second syntax element, locate a second plurality of chroma samples and copy the second plurality of chroma samples to decode the current block. The first and second plurality of chroma samples may, for example, be C_{R} and C_{B} samples. The first syntax element may, for example, be a two-dimensional displacement vector, and offset value, or some other type of syntax element used for locating the samples to be copied. The first syntax element may, for example, identify a relative position between a current pixel of the current block and a reference pixel.

In instances where the encoded video data includes 4:4:4 chroma sub-sampled video data, video decoder 30 may locate the plurality of samples using the same 2D displacement vector or offset used to locate the luma samples. In instances where the encoded video data includes 4:2:2 or 4:2:0 chroma sub-sampled video data, video decoder 30 may scale the 2D displacement vector or offset appropriately. For example, for 4:2:2 video data, video decoder 30 may scale an x-component of a 2D displacement vector identified from the first syntax element, or for 4:2:0 video data, video decoder 30 may scale both an x-component and a y-component of a 2D displacement vector identified by the first syntax element. Video decoder 30 may similarly scale a run length identified by the second syntax element. In some instances, video decoder 30 may interpolate chroma samples such that the chroma block includes the same number of samples as the corresponding luma block.

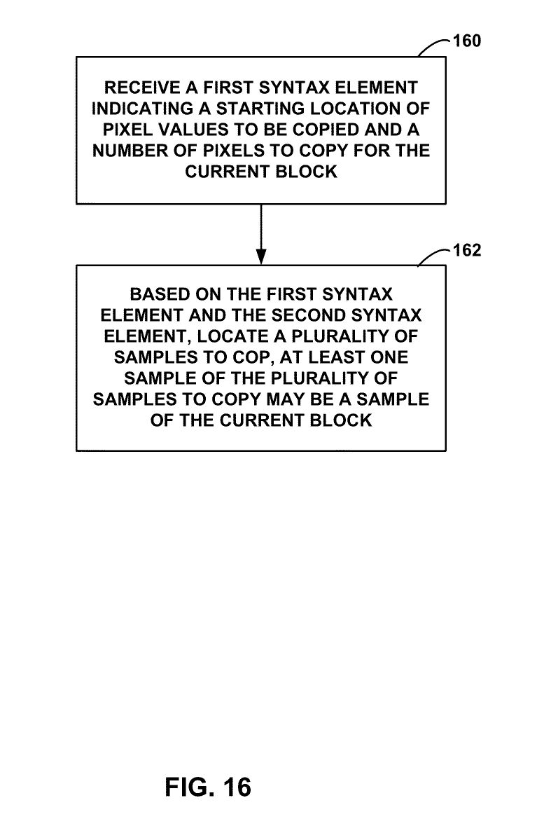

FIG. 16 is a flowchart illustrating an example technique of decoding video data. For purposes of illustration, the example of FIG. 16 is described with respect to video decoder 30. The techniques of FIG. 16 may be performed either in conjunction with the techniques of FIG. 15 or may be performed independently. In the example of FIG. 16, video decoder 30 receives, in a bitstream of encoded video data for a current pixel of a current block, a first syntax element indicating a starting location of pixel values to be copied and a number of pixels to copy for the current block (160). Based on the first syntax element and the second syntax element, video decoder 30 locates a plurality of samples to copy (162). As shown in the examples of FIGS. 9B and 9C described above, at least one sample of the plurality of samples to copy may be a sample of the current block. In some instances, all samples of the plurality of samples to copy may be samples of the current block. As shown in the examples of FIGS. 9B and 9C described above, the location of the first sample value to be copied may be a location in the first block. As shown in the example FIG. 9C described above, the plurality of samples to copy may include the current pixel. When copying pixels of the current block as shown in the examples of FIGS. 9B and 9C, video decoder 30 may copy reconstructed pixels that have not yet been de-block filtered. The pixel values referenced in the description of FIG. 16 may include luma and/or chroma samples.

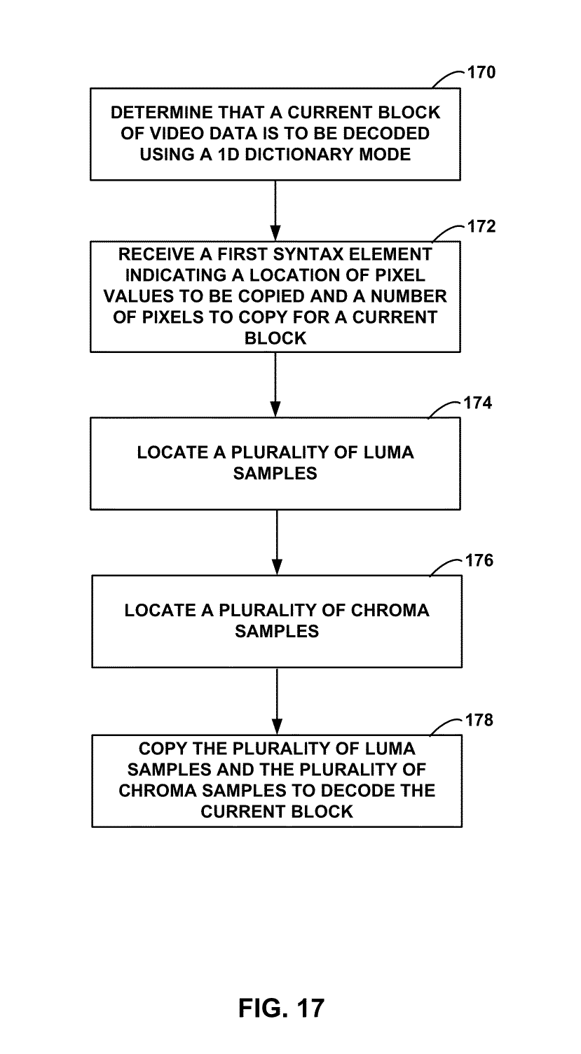

FIG. 17 is a flowchart illustrating an example technique of decoding video data. For purposes of illustration, the example of FIG. 17 is described with respect to a generic video coder, which may correspond to either video encoder 20 or video decoder 30. The techniques of FIG. 17 may be performed either in conjunction with the techniques of FIG. 15 and/or FIG. 16 or may be performed independently. The video coder may determine that video data is to be coded using 1D dictionary coding (170). The video coder may apply a minimum run length constraint on the 1D dictionary coding (172). The video coder may code the video data using the minimum run length constraint, such that a run in the 1D dictionary coding is greater than a predetermined threshold (174). The video coder may apply the minimum run length constraint by applying a plurality of minimum run length constraints based on a reference type or reference range of the 1D dictionary coding.

When the video coder corresponds to video encoder 20, video encoder 20 may apply the minimum run length constraint comprises by not using 1D dictionary coding to encode a run of samples when a length of the run is less than a minimum allowable run length, and when the length of the run is not less than the minimum allowable run length, signal, in a coded representation of the video data, a run length value for the run that is equal to the length of the run minus the minimum allowable run length. Video encoder 20 may apply the minimum run length constraint by not using 1D dictionary coding to encode a run of samples when a length of the run is less than a minimum allowable run length, and signal, in a coded representation of the video data, a run length value for the run that is equal to the length of the run.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of decoding video data, the method comprising:
determining that a current block of video data is to be decoded using a 1D dictionary mode;
receiving, for a current pixel of the current block, a first syntax element indicating a starting location of reference pixels and a second syntax element identifying a number of reference pixels;
based on the first syntax element and the second syntax element, locating a plurality of luma samples corresponding to the reference pixels;
based on the first syntax element and the second syntax element, locating a plurality of chroma samples corresponding to the reference pixels; and
copying the plurality of luma samples and the plurality of chroma samples to decode the current block.

2. The method of claim 1, wherein the first syntax element comprises a two-dimensional displacement vector pointing to the starting location of the reference pixel.

3. The method of claim 2, wherein a first component of the displacement vector is binarized with a first greater than 0 flag, a first greater than 1 flag, and a first exponential Golomb code, and wherein a second component of the displacement vector is binarized with a second greater than 0 flag, a second greater than 1 flag, and a second exponential Golomb code.

4. The method of claim 1, wherein a value of the second syntax element is binarized with a greater than 0 flag and an exponential Golomb code.

5. The method of claim 1, wherein the first syntax element comprises an indication of a relative position between the current pixel of the current block and the starting location of the reference pixels.

6. The method of claim 1, wherein at least one of the reference pixels is in the current block.

7. The method of claim 1, wherein the reference pixels comprises the current pixel.

8. The method of claim 1, wherein the encoded video data comprises video data with a 4:2:2 chroma sub-sampling format video data or video data with a 4:2:0 chroma sub-sampling format, and wherein the method further comprises one or more of (1) scaling the a value determined based on the first syntax element indicating the starting location of the reference pixels and scaling the number of reference pixels (2) interpolating chroma samples.

9. The method of claim 1, further comprising:
receiving the first and second syntax elements for a luma sample of the current pixel;
based on the first syntax element and the second syntax element for the luma sample, locating two plurality of chroma samples; and
copying the two plurality of chroma samples to decode the current block.

10. The method of claim 1, wherein the video data comprises video data with a 4:4:4 chroma sub-sampling format, the method further comprising:
receiving second video data, wherein the second video data comprises video data with a 4:2:2 chroma sub-sampling format video data or video data with a 4:2:0 chroma sub-sampling format;
for a current pixel of a current block of the second video data, receiving a first set of syntax elements indicating a starting location of reference pixels and identifying a number of reference pixels for a luma component of the current block and receiving a second set of syntax elements indicating a starting location of reference pixels and identifying a number of reference pixels for a chroma component of the current block.

11. The method of claim 1, further comprising, for the 1D dictionary coding mode, determining a minimum value for the number of reference pixels.

12. The method of claim 11, wherein determining the minimum value for the number of reference pixels comprises receiving in the video data a syntax element identifying the minimum value.

13. The method of claim 11, wherein a value of the second syntax element corresponds to the number of reference pixels minus the minimum value for the number of reference pixels.

14. The method of claim 1, further comprising:
based on a location of the current pixel and the number of reference pixels identified by the second syntax element, identifying a last pixel in a row of the current block;
for the last pixel in the first row of the current block, copying a luma value of a first corresponding reference pixel;
for a first pixel in a next row of the current block, copying a luma value of a second corresponding reference pixel, wherein a two-dimensional displacement between the last pixel in the row and the first pixel of the next row is equal to a two-dimensional displacement between the first corresponding reference pixel and the second corresponding reference pixel.

15. The method of claim 1, further comprising:
for the current block of video data, determining a maximum range value, wherein the maximum range value identifies a maximum distance in luma samples between the first pixel and the starting location the reference pixels.

16. A method of encoding video data, the method comprising:
identifying a matching string of pixel values to copy for a current block, wherein the matching string of pixel values comprises a plurality of luma samples and a corresponding plurality of chroma samples;
encoding a first syntax element indicating a starting location of the luma samples and the chroma samples to copy; and
encoding a second syntax element identifying a number of the luma samples to copy and a number of the chroma samples to copy.

17. The method of claim 16, wherein the first syntax element comprises a two-dimensional displacement vector pointing to the starting location of the reference pixel.

18. The method of claim 17, wherein encoding the first syntax element comprises binarizing a first component of the displacement vector with a first greater than 0 flag, a first greater than 1 flag, and a first exponential Golomb code and binarizing a second component of the displacement vector with a second greater than 0 flag, a second greater than 1 flag, and a second exponential Golomb code.

19. The method of claim 17, wherein encoding the second syntax element comprises binarizing a value of the second syntax element with a greater than 0 flag and an exponential Golomb code.

20. A device for decoding video data, the device comprising:
a memory configured to store the video data;
a video decoder comprising one or more processor configured to:
determine that a current block of the video data is to be decoded using a 1D dictionary mode;
receive, for a current pixel of the current block, a first syntax element indicating a starting location of reference pixels and a second syntax element identifying a number of reference pixels;
based on the first syntax element and the second syntax element, locate a plurality of luma samples corresponding to the reference pixels;
based on the first syntax element and the second syntax element, locate a plurality of chroma samples corresponding to the reference pixels; and
copy the plurality of luma samples and the plurality of chroma samples to decode the current block.

21. The device of claim 20, wherein the video data comprises video data with a 4:4:4 chroma sub-sampling format, the method further comprising:
receiving second video data, wherein the second video data comprises video data with a 4:2:2 chroma sub-sampling format video data or video data with a 4:2:0 chroma sub-sampling format;
for a current pixel of a current block of the second video data, receiving a first set of syntax elements indicating a starting location of reference pixels and identifying a number of reference pixels for a luma component of the current block and receiving a second set of syntax elements indicating a starting location of reference pixels and identifying a number of reference pixels for a chroma component of the current block.

22. The device of claim 20, wherein the first syntax element comprises a two-dimensional displacement vector pointing to the starting location of the reference pixel.

23. The device of claim 22, wherein a first component of the displacement vector is binarized with a first greater than 0 flag, a first greater than 1 flag, and a first exponential Golomb code, and wherein a second component of the displacement vector is binarized with a second greater than 0 flag, a second greater than 1 flag, and a second exponential Golomb code, and wherein a value of the second syntax element is binarized with a greater than 0 flag and an exponential Golomb code.

24. The device of claim 20, wherein the encoded video data comprises video data with a 4:2:2 chroma sub-sampling format video data or video data with a 4:2:0 chroma sub-sampling format, and wherein the method further comprises one or more of (1) scaling the a value determined based on the first syntax element indicating the starting location of the reference pixels and scaling the number of reference pixels (2) interpolating chroma samples.

25. The device of claim 20, wherein at least one of the reference pixels is in the current block.

26. The device of claim 20, wherein the reference pixels comprise the current pixel.

27. The device of claim 20, further comprising:
receiving in the video data a syntax element identifying a minimum value for the number of reference pixels, wherein a value of the second syntax element corresponds to the number of reference pixels minus the minimum value for the number of reference pixels.

28. The device of claim 20, further comprising:
based on a location of the current pixel and the number of reference pixels identified by the second syntax element, identifying a last pixel in a row of the current block;
for the last pixel in the first row of the current block, copying a luma value of a first corresponding reference pixel;
for a first pixel in a next row of the current block, copying a luma value of a second corresponding reference pixel, wherein a two-dimensional displacement between the last pixel in the row and the first pixel of the next row is equal to a two-dimensional displacement between the first corresponding reference pixel and the second corresponding reference pixel.

29. The device of claim 20, further comprising:
for the current block of video data, determining a maximum range value, wherein the maximum range value identifies a maximum distance in luma samples between the first pixel and the starting location of pixel values to copy.

30. A computer-readable storage medium storing instructions that when executed by one or more processors cause the one or more processors to:
determine that a current block of video data is to be decoded using a 1D dictionary mode;
receive, for a current pixel of the current block, a first syntax element indicating a starting location of reference pixels and a second syntax element identifying a number of reference pixels;
based on the first syntax element and the second syntax element, locate a plurality of luma samples corresponding to the reference pixels;
based on the first syntax element and the second syntax element, locate a plurality of chroma samples corresponding to the reference pixels; and
copy the plurality of luma samples and the plurality of chroma samples to decode the current block.
